(19) United States
(12) Patent Application Publication
(10) Pub. No.: US 2026/0187930 A1
(43) Pub. Date: Jul. 2, 2026

(54) PROCESS AND SYSTEM FOR DETERMINING AND MITIGATING THREATS TO EXISTING CRITICAL ASSETS

(71) Applicant: Power Engineers, Incorporated, Meridian, ID (US)

(72) Inventors: Jason William Pfaff, Moscow, ID (US); Christopher T. Ott, Prineville, OR (US); Charles Mark Koenig, Lewiston, ID (US); Cody Allan Fitch, Boise, ID (US); Angela Monique Thomas, Boise, ID (US); Aaron A. Ames, Featherville, ID (US)

(73) Assignee: Power Engineers, Incorporated, Meridian, ID (US)

(21) Appl. No.: 19/094,610

(22) Filed: Mar. 28, 2025

Related U.S. Application Data
(60) Provisional application No. 63/740,861, filed on Dec. 31, 2024.

(51) Int. Cl. G06T 17/20; A63F 13/52

(52) U.S. Cl. CPC G06T 17/20; A63F 13/52

(57) ABSTRACT

Processes and systems for identifying and mitigating threats to existing critical assets leverage interactive 3D modeling systems, such as gaming engines, to generate customized interactive 3D critical asset site models that provide interactive visual displays of multiple potential threats, multiple potential mitigation measures, and the effectiveness of the each of the potential threat mitigation features with respect to protecting existing and future critical assets and/or critical asset sites.

### RELATED APPLICATIONS

This application claims the benefit of U.S. Provisional Patent Application No. 63/740,861, filed in the name of Jason William Pfaff on Dec. 31, 2024, entitled “METHOD AND SYSTEM FOR DETERMINING AND MITIGATING THREATS TO CRITICAL ASSETS,” which is hereby incorporated by reference in its entirety as if it were fully set forth herein.

### BACKGROUND

One of the challenges facing the world today is the need to protect critical structures, locations, and personnel from various types of attack. A particular challenge is the need to protect critical assets and critical asset sites, such as power generation, power storage, transmission and distribution systems and components, communication systems and components, transportation systems and components, government facilities and components, and the like from attempts to disable the systems and components using small arms, explosives, and/or other types of guided and/or ballistic threats.

As a specific example, power production and transmission systems/sites, communications systems/sites, and various other infrastructure systems/sites have proven to be vulnerable to such attacks and often present an attractive target to anyone who wishes to disrupt the lives of the public, disable organizations, disable public services, and/or disrupt government function. These targets are particularly vulnerable in that they are critical structures and components that, once in place, typically cannot be moved nor are they readily hidden from the public eye and the public record.

As one example, on Apr. 16, 2013, a small team of gunmen first cut telephone communication lines to a California electrical substation. The team then used readily available .30 caliber small arms fire to destroy 17 electrical transformers in 19 minutes. Only through quick response by law enforcement and PG&E workers was a long-term blackout in Silicon Valley avoided. However, the result of this 19-minute attack by very few actors was 15 million dollars of damage.

Similarly, in 2023 a single attacker used explosives to destroy 2 electrical transformers at a California substation which left 1,500 homes without power. The number of physical attacks on power grid infrastructure, including substations, has been steadily increasing in recent years, with a significant jump reported in the first half of 2023 alone (Department of Energy). These attacks indicate a trend of rising incidents with more anticipated.

While both these attacks were significant and caused considerable damage, these attacks were made by small groups or individuals that, it is believed, were not sponsored by foreign powers nor were they particularly sophisticated or well-funded. It can only be imagined how much more vulnerable to attack these facilities are, and how much more disruption and damage could be caused, if individuals and groups that are sponsored by foreign powers and/or well-funded sophisticated backers are involved.

In response to these threats, various power regulation and oversight authorities, including the Federal Energy Regulatory Commission (FERC), have mandated that physical security measures be implemented at all power production facilities in the United States. In addition, the North American Electric Reliability Corporation (NERC) has initially issued a reliability standard CIP-014 that further mandates that electrical equipment and facilities be protected from physical attack. In addition, throughout the world various other regulations and guidelines are in place to impose standards to protect electrical equipment and facilities from physical attack.

As result, mitigation measures such as physical barriers, monitors, sensors, and various other protective systems are now required at virtually every existing electrical production and transmission station, most communications system facilities, and in a wide variety of infrastructure and critical asset locations.

In addition, threat mitigation analysis must now be part of the planning, building and long-term operation process for virtually every proposed electrical production and transmission station, most communications system facilities, and a wide variety of infrastructure and critical asset locations. In short, all over the world there is a recognition of the need to protect critical infrastructure assets and locations. As a result, the planning and implementation of threat mitigation measures is now a significant component to be incorporated into both existing and proposed infrastructure assets and locations/sites.

Despite this critical, and often mandated, requirement to implement various mitigation measures at existing and proposed infrastructure asset locations, there are very few specific requirements mandated at present and there has been very little effort put into making the analysis and implementation of mitigation measures more effective, uniform, and efficient. In short, while the problem is recognized, and mitigation of the threat is often mandated, systematic threat analysis procedures, specific threat mitigation levels, and exact requirements are not currently set forth in any consistent, objective, and efficient way.

Consequently, sophisticated and effective prior art threat analysis, mitigation feature analysis, and implementation of mitigation measures are currently lacking. What few systems and methods are currently available typically rely on two dimensional (2D) cross sectional representations and drawings which, in turn, use labor intensive site data collection, and highly manual methods in an attempt to identify threats, threat vectors, and vulnerabilities.

This prior art analysis is then used to create static 2D proposals that may not address all known site-line issues, specifically to the range of a ballistic threat (up to 1000+ yards). Additionally, the traditional method is relying on static design information, making it challenging for project teams to understand the context of site conditions out to the distance of ballistic threats, and difficult to properly evaluate the effectiveness of mitigation recommendations. Therefore, lacking truly effective tools to help understand the threats and effectiveness of various mitigation measures, owners/operators and builders of critical assets and critical asset sites typically employ either ineffective solutions or inefficient overkill solutions, or both. This not only leads to a false sense of security and/or an inefficient use of resources, but often still fails to identify the mitigation features that would be most effective in evolving threat situations.

In addition, prior art threat analysis and mitigation methods and systems typically fail to provide any real-time interactive capability or effective visualization of the threats and mitigation options to the builder/operator, security teams or engineers/designers of the existing and future critical assets and critical asset sites. Consequently, prior art analysis and implementation models typically fail to provide the builder/operator with a thorough threat and mitigation option analysis in a time and labor/resource efficient manner.

FIGS. 1A through 1C show some typical results of prior art analysis and implementation models of an electrical power sub-station and proposed mitigation measures.

As seen in FIG. 1A, using prior art methods, a 2D static cross-sectional sketch 100 of a critical asset location, such as the location of sub-station 110, would be made based on data that is largely collected from existing drawings and manual data collection methods such as photographs and visual sources. These 2D sketches would then be used to identify critical assets 101 at the critical asset location, such as the location of sub-station 110.

In particular, FIG. 1A shows the 2D side view or cross-sectional sketch 100 of the sub-station 110 including a 2D representation of critical assets 101 such as transformers, powerlines, and various electrical power transmission components.

FIG. 1B shows the 2D side view or cross-sectional sketch 120 of the sub-station 110 of FIG. 1A including a 2D representation of critical assets 101 of FIG. 1A with a 2D representation of proposed threat mitigation feature 150 that, in this example, is a perimeter wall of uniform height extending across the entire length of sub-station 110. In this particular example, proposed threat mitigation feature 150 would be an example of an “overkill” proposed threat mitigation feature 150 in that portions of the wall could be lower than shown and still provide the required protection.

FIG. 1C shows the 2D side view or cross-sectional sketch 130 of the sub-station 110 of FIG. 1A including a 2D representation of critical assets 101 and a 2D representation of second proposed threat mitigation feature 160 that, in this example, is a wall of varying height extending across the entire length of sub-station 110. While the second proposed threat mitigation feature 160 of FIG. 1C is more efficient than proposed threat mitigation feature 150 of FIG. 1B, the proposed solution of FIG. 1C is static and does not allow for real time user interaction and/or analysis of various angles/perspectives, threats, or threat positions. Consequently, using the second proposed threat mitigation feature 160 of cross-sectional sketch 130 of FIG. 1C there is no way to thoroughly visualize, compare, or analyze different types of threats and the effectiveness of second proposed threat mitigation feature 160 against those threats from different positions and locations.

While providing some insight into one type of threat mitigation, the prior art methods shown in FIGS. 1A through 1C are static and do not provide the ability to truly visualize the effectiveness, or weaknesses, of various threat mitigation options such as physical mitigation features, security cameras, radar, earth features, or even vegetation. In addition, there is little ability to visualize what a potential threat, or various types of threats, might be able to access from varying positions, angles, heights, and distances.

In addition, the prior art methods do not accommodate dynamic analysis of combinations of different types of threats such as various calibers, munitions, or evolving threat capabilities, nor the effectiveness of various collections of threat mitigation features with respect to these various threats. As noted, using prior art methods, each threat, position, capability, and type of threat mitigation would, at best, require separate sketches and data analysis, and each could take days or even weeks to prepare.

In addition, prior analysis and implementation models of mitigation measures typically focused on one or two threat mitigation options and/or technologies and one or two types of threats rather than approaching the problem holistically using a wide range of options, technologies, and capabilities.

Consequently, the prior art methods shown in FIGS. 1A through 1C represent a piecemeal approach to threat and threat mitigation analysis and therefore fail to provide a realistic and holistic analysis ability of existing and evolving potential threats and various forms of threat mitigation.

As a result, prior art methods and systems fail to provide effective and efficient mechanisms for analyzing and visualizing various threats, identifying vulnerability to those threats, and determining and visualizing the effectiveness of various threat mitigation features against those threats.

What is needed is a technical solution to the long standing technical problem of providing critical asset threat and threat mitigation analysis that is efficient, effective, and that provides for interactive and relative real time analysis of multiple potential threats, multiple threat mitigation options, and the effectiveness of those threat mitigation features in protecting existing and future critical assets.

### SUMMARY

Disclosed herein is a holistic and dynamically interactive solution to the long standing technical problem of providing critical asset threat and threat mitigation analysis that is efficient, effective, and that provides for relative real time dynamic analysis of multiple potential threats, multiple potential threat mitigation measures, and the effectiveness of the potential threat mitigation features with respect to protecting existing and future critical assets.

To this end, in one embodiment, disclosed herein are processes and systems for identifying and mitigating threats to critical assets that leverage interactive 3D modeling systems, such as gaming engines, to generate customized interactive 3D critical asset site models. These interactive 3D critical asset site models then provide interactive visual displays of multiple potential threats, multiple potential threat mitigation measures, and the effectiveness of the potential threat mitigation features with respect to protecting existing and future critical assets and/or critical asset sites.

In one embodiment, the process and system includes processes and systems for identifying existing and/or proposed environmental features and existing and/or proposed critical assets at an existing or proposed critical asset site.

In one embodiment, the processes and systems include obtaining critical asset site data representing existing and/or proposed environmental features and existing and/or proposed critical assets at the existing or proposed critical asset site.

In one embodiment, the process and system includes processing the critical asset site data to convert the critical asset site data into three dimensional (3D) critical asset site data representing the critical asset site including the existing and/or proposed environmental features and the existing and/or proposed critical assets.

In one embodiment, the process and system includes providing the 3D model data to an interactive 3D modeling system. In one embodiment, the interactive 3D modeling system transforms the 3D model data into an interactive 3D model representation of the critical asset site including the existing and/or proposed environmental features and the existing and/or proposed critical assets.

In one embodiment, the process and system includes methods and structures for identifying potential threats to the existing and/or proposed critical assets at the critical asset site and generating potential threat data.

In one embodiment, the process and system includes identifying potential vulnerabilities associated with the existing and/or proposed critical assets at the critical asset site and generating potential vulnerability data representing the identified potential vulnerabilities associated with the existing and/or proposed critical assets at the critical asset site.

In one embodiment, the process and system includes identifying potential threat mitigation features capable of mitigating the determined potential vulnerability of the existing and/or proposed critical assets at the critical asset site and generating potential threat mitigation feature data representing the identified potential threat mitigation features.

In one embodiment, the process and system includes processing the threat data, the potential vulnerability data, and the potential threat mitigation feature data to generate an interactive visualization of the effectiveness of the potential threat mitigation features for protecting the existing and/or proposed critical assets at the critical asset site.

In one embodiment, the process and system includes displaying the interactive visualization of the effectiveness of the potential threat mitigation features for protecting the existing and/or proposed critical assets at the critical asset site.

In one embodiment, the process and system includes selecting one or more mitigation features based, at least in part, on the visualization of the effectiveness of the potential threat mitigation features for protecting the existing and/or proposed critical assets at the critical asset site.

In one embodiment, the process and system includes generating selected threat mitigation feature data representing the type, dimensions, and location of the selected threat mitigation features for the existing and/or proposed critical assets at the critical asset site.

In one embodiment, the process and system includes generating critical asset site threat mitigation implementation data using the selected threat mitigation feature data.

In one embodiment, the disclosed processes and systems for determining and mitigating threats to critical assets includes a process and system for determining and mitigating threats to existing critical assets. These embodiments are also referred to herein as “existing facilities/structures” processes and systems for determining and mitigating threats to existing critical assets.

In one embodiment, the process and system includes performing a critical asset site inventory, the critical asset site inventory including identifying environmental features and existing critical assets at the critical asset site.

In one embodiment, the process and system includes obtaining/generating existing critical asset site data representing the environmental features and existing critical assets at the critical asset site.

In one embodiment, the process and system includes processing the existing critical asset site data to convert the existing critical asset site data into 3D model data representing the critical asset site including the environmental features and the existing critical assets.

In one embodiment, the process and system includes providing the 3D model data to an interactive 3D modeling system. In one embodiment, the interactive 3D modeling system transforms the 3D model data into an interactive 3D model representation of the existing critical asset site including the environmental features and the existing critical assets.

In one embodiment, the process and system includes identifying potential threats to the existing critical assets at the critical asset site and generating potential threat data.

In one embodiment, the process and system includes identifying potential vulnerabilities associated with the existing critical assets at the critical asset site and generating potential vulnerability data representing the identified potential vulnerabilities associated with the existing critical assets at the critical asset site.

In one embodiment, the process and system includes identifying potential threat mitigation features capable of mitigating the determined potential vulnerability of the existing critical assets at the critical asset site. In one embodiment, potential threat mitigation feature data representing the identified potential threat mitigation features is then generated.

In one embodiment, the process and system includes processing the threat data, potential vulnerability data, and the potential threat mitigation feature data to generate an interactive visualization of the effectiveness of the potential threat mitigation features for protecting the existing critical assets at the critical asset site.

In one embodiment, the process and system includes displaying the interactive visualization of the effectiveness of the potential threat mitigation features for protecting the existing critical assets at the critical asset site.

In one embodiment, the process and system includes selecting one or more threat mitigation features based, at least in part, on the visualization of the effectiveness of each of the potential threat mitigation features for protecting the existing critical assets at the critical asset site.

In one embodiment, the process and system includes generating selected threat mitigation feature data representing the type and location of the selected threat mitigation features for the existing critical assets at the critical asset site.

In one embodiment, the process and system includes generating critical asset site threat mitigation implementation data using the selected threat mitigation feature data.

In one embodiment, the disclosed processes and systems for determining and mitigating threats to critical assets includes processes and systems for determining and mitigating threats to future, or proposed, critical assets.

In these embodiments, called “green field” planning embodiments, the disclosed process and system includes obtaining proposed critical assets data representing proposed critical assets to be located at a critical asset site.

In one embodiment, the process and system includes obtaining environmental feature data representing existing and/or proposed environmental features at the critical asset site.

In one embodiment, the process and system includes processing the proposed critical assets data and the environmental feature data to convert the proposed critical assets data and the environmental feature data into 3D model data representing the critical asset site including the proposed and/or existing environmental features and the proposed critical assets.

In one embodiment, the process and system includes providing the 3D model data to an interactive 3D modeling system. In one embodiment, the interactive 3D modeling system transforms the 3D model data into an interactive 3D model representation of the critical asset site including the existing and/or proposed environmental features and the proposed critical assets.

In one embodiment, the process and system includes identifying potential threats to the proposed critical assets at the critical asset site and generating potential threat data.

In one embodiment, the process and system includes identifying potential vulnerabilities associated with the proposed critical assets at the critical asset site and generating potential vulnerability data representing the identified potential vulnerabilities associated with the proposed critical assets at the critical asset site.

In one embodiment, the process and system includes identifying potential threat mitigation features capable of mitigating the potential vulnerability of the proposed critical assets at the critical asset site and generating potential threat mitigation feature data representing the identified potential threat mitigation features.

In one embodiment, the process and system includes processing the threat data, the potential vulnerability data, and the potential threat mitigation feature data to generate an interactive visualization of the effectiveness of the potential threat mitigation features for protecting the proposed critical assets at the critical asset site.

In one embodiment, the process and system includes displaying the interactive visualization of the effectiveness of the potential threat mitigation features for protecting the proposed critical assets at the critical asset site.

In one embodiment, the process and system includes selecting one or more threat mitigation features based, at least in part, on the visualization of the effectiveness of each of the potential threat mitigation features for protecting the proposed critical assets at the critical asset site.

In one embodiment, the process and system includes generating selected threat mitigation feature data representing the type and location of the selected threat mitigation features for the proposed critical assets at the critical asset site.

In one embodiment, the process and system includes generating critical asset site threat mitigation implementation data using the selected threat mitigation feature data.

Disclosed herein are processes and systems for identifying and mitigating threats to critical assets that leverage interactive 3D modeling systems, such as gaming engines, to generate customized interactive 3D critical asset site models that provide interactive visual displays of multiple potential threats, multiple potential threat mitigation measures, and the effectiveness of the potential threat mitigation features with respect to protecting existing and future critical assets and/or critical asset sites.

Consequently, as discussed in more detail below, the disclosed processes and systems for determining and mitigating threats to critical assets allow for the creation of highly detailed interactive 3D modeling of both existing and proposed critical assets, their critical asset sites, and the surrounding environment. These interactive 3D models are fully interactive with threat analysis and mitigation parameters that can be varied in relative real time to visualize numerous options and configurations in a single sitting.

In addition, the disclosed processes and systems for determining and mitigating threats to critical assets provide for analysis of numerous kinds of threats so that the resultant threat mitigation plan can be modified to adapt to evolving threats.

In addition, in one embodiment, the disclosed processes and systems for determining and mitigating threats to critical assets provide rough cost calculations for the proposed threat mitigation features so that the owner/operator/builder of the critical assets can do rough cost comparisons of threat mitigation features while, at the same time, seeing the effectiveness of those threat mitigation features from virtually any position, perspective, or angle.

Consequently, the disclosed processes and systems for determining and mitigating threats to critical assets provide a solution to the long standing technical problem of providing critical asset threat and mitigation analysis that is efficient, effective, and holistic and that provides for interactive and relative real time analysis of potential threats and mitigation measures with respect to existing and future critical assets to generate cost effective and efficient threat mitigation solutions for the existing and future critical assets.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows a cross-sectional view of a 2D model of a critical asset site as would be generated using typical prior art methods and systems.

FIG. 1B shows the 2D model of a critical asset site of FIG. 1A with a 2D representation of a proposed first mitigation feature as would be generated using typical prior art methods and systems.

FIG. 1C shows the 2D model of a critical asset site of FIG. 1A with a 2D representation of a proposed second mitigation feature as would be generated using typical prior art methods and systems.

FIG. 2 is a flow chart showing some of the major operations of a process for identifying and mitigating threats to critical assets in accordance with one embodiment.

FIG. 3A is a flow chart showing some of the major operations of a process for determining and mitigating threats to existing critical assets in accordance with one embodiment.

FIG. 3B is a screenshot of an interactive display of an interactive 3D model representation of an existing critical asset site in accordance with one embodiment.

FIG. 3C is a screenshot of the interactive display of the interactive 3D model representation of an existing critical asset site of FIG. 3B including the placement of a first virtual light/illumination source for identifying potential vulnerability of a selected critical asset at the critical asset site in accordance with one embodiment.

FIG. 3D is a screenshot of the interactive display of the interactive 3D model representation of an existing critical asset site of FIG. 3B including the placement of a second virtual light/illumination source for identifying potential vulnerability of the selected critical asset at the critical asset site in accordance with one embodiment.

FIG. 3E is a screenshot of the interactive display of the interactive 3D model representation of an existing critical asset site of FIGS. 3B, 3C, and 3D including a wide-angle view of the potential threat and potential vulnerability of the selected critical asset at the critical asset site in accordance with one embodiment.

FIG. 3F is a screenshot of the interactive display of the interactive 3D model representation of an existing critical asset site of FIGS. 3B, 3C, 3D and 3E including a wide-angle view of the potential threat and potential vulnerability of the selected critical asset at the critical asset site that is a transformer and a proposed threat mitigation feature in accordance with one embodiment.

FIG. 3G is a screenshot of the interactive display of the interactive 3D model representation of an existing critical asset site of FIGS. 3B, 3C, 3D, 3E and 3F including a zoomed in angled view of the potential threat and potential vulnerability of the selected critical asset at the critical asset site and the proposed threat mitigation feature in accordance with one embodiment.

FIG. 3H is a screenshot of the interactive display of the interactive 3D model representation of an existing critical asset site of FIGS. 3B, 3C, 3D, 3E, 3F, and 3G including a close-up angled view of the potential threat and potential vulnerability of the selected critical asset at the critical asset site and the proposed threat mitigation feature in accordance with one embodiment.

FIG. 3I is a screenshot of the interactive display of the interactive 3D model representation of an existing critical asset site of FIG. 3B including the placement of three virtual light/illumination sources for identifying potential vulnerability of the selected critical asset at the critical asset site in accordance with one embodiment.

FIG. 3J is a screenshot of the interactive display of the interactive 3D model representation of an existing critical asset site of FIGS. 3B, 3C, and 3D including a wide-angle view of the potential threat and potential vulnerability of the selected critical asset at the critical asset site in accordance with one embodiment.

FIG. 3K is a screenshot of the interactive display of the interactive 3D model representation of an existing critical asset site of FIG. 3I including the potential vulnerability of the selected critical asset at the critical asset site and a first proposed threat mitigation feature that is a wall segment running in a first direction, e.g., from north to south in accordance with one embodiment.

FIG. 3L is a screenshot of the interactive display of the interactive 3D model representation of an existing critical asset site of FIG. 3I including the potential vulnerability of the selected critical asset at the critical asset site and a first proposed threat mitigation feature that is a wall and a second proposed threat mitigation feature that is also a wall running in a second direction, e.g., from east to west in accordance with one embodiment.

FIG. 4A is a flow chart showing some of the major operations of a process for determining and mitigating threats to future, or proposed, critical assets in accordance with one embodiment.

FIG. 4B shows a representation of the proposed critical assets to be located at a critical asset site in accordance with one embodiment.

FIG. 4C shows a representation of the combined proposed critical assets data and environmental feature data representing the existing and/or proposed environmental features and proposed critical assets at the critical asset site in accordance with one embodiment.

FIG. 4D shows an interactive display screen of an interactive 3D model representation of the critical asset site including the existing and/or proposed environmental features and the proposed critical assets in accordance with one embodiment.

FIG. 4E shows the identification and selection of a specific critical asset within the interactive 3D model representation of the critical asset site in accordance with one embodiment.

FIG. 4F shows a screenshot of an interactive display of the interactive 3D model representation of an angled view of the existing critical asset site including the placement of a at least one virtual light/illumination source identifying the potential vulnerability of the selected proposed critical asset at the critical asset site in accordance with one embodiment.

FIG. 4G shows a screenshot of an interactive display of the interactive 3D model representation of an overhead view of the existing critical asset site including the placement of at least one virtual light/illumination source identifying potential vulnerability of the selected critical asset at the critical asset site in accordance with one embodiment.

FIG. 4H shows a screenshot of an interactive display of the interactive 3D model representation of a zoomed in angled view of the existing critical asset site including the placement of at least one virtual light/illumination source identifying the potential vulnerability of the selected critical asset at the critical asset site in accordance with one embodiment.

FIG. 4I shows a screenshot of the interactive display of the interactive 3D model representation of an existing critical asset site of FIG. 4H including a wide-angle view of the potential threat and potential vulnerability of the selected critical asset at the critical asset site and a first proposed mitigation feature that is a screening wall in accordance with one embodiment.

FIG. 4J shows a screenshot of the interactive display of the interactive 3D model representation of an existing critical asset site of FIGS. 4H and 4I including a zoomed in angle view of the potential threat and potential vulnerability of the selected critical asset at the critical asset site and a first proposed mitigation feature that is a screening wall and a second proposed mitigation feature that is a perimeter wall in accordance with one embodiment.

FIG. 4K shows a screenshot of the interactive display of the interactive 3D model representation of an existing critical asset site of FIGS. 4H, 4I and 4J including a zoomed in angle view of the potential threat and potential vulnerability of the selected critical asset at the critical asset site and a first proposed mitigation feature that is a screening wall and a second proposed mitigation feature that is a perimeter wall in accordance with one embodiment.

FIG. 5 is a high-level block diagram of one example of the disclosed system for identifying and mitigating threats to critical assets in accordance with one embodiment.

FIGS. 6A through 6P are screen shots of interactive visual display screens generated using one embodiment of the disclosed processes and systems showing some of the analysis capabilities of the disclosed interactive 3D models.

FIGS. 7A through 7C are screen shots of interactive visual display screens generated using one embodiment of the disclosed processes and systems showing some of the analysis capabilities of the disclosed interactive 3D models using visual detection mitigation features.

FIGS. 8A through 8C are screen shots of interactive visual display screens generated using one embodiment of the disclosed processes and systems showing some of the analysis capabilities of the disclosed interactive 3D models using radar detection mitigation features.

FIGS. 9A through 9H are screen shots of interactive visual display screens generated using one embodiment of the disclosed processes and systems showing various analysis capabilities of the disclosed interactive 3D models using an “in looking” threat view.

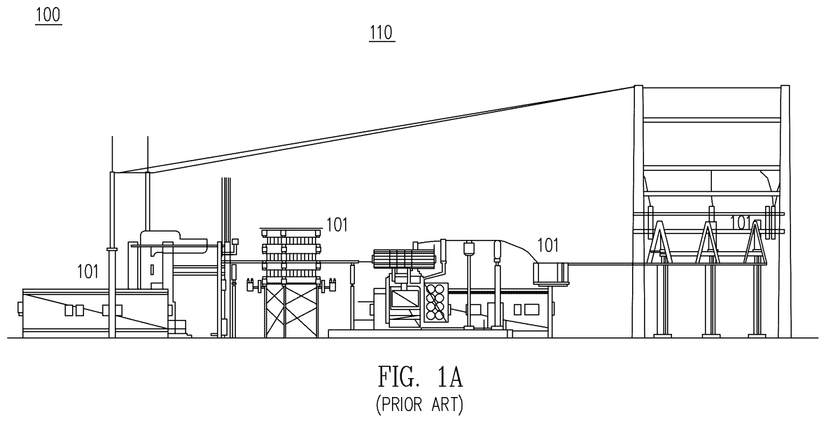

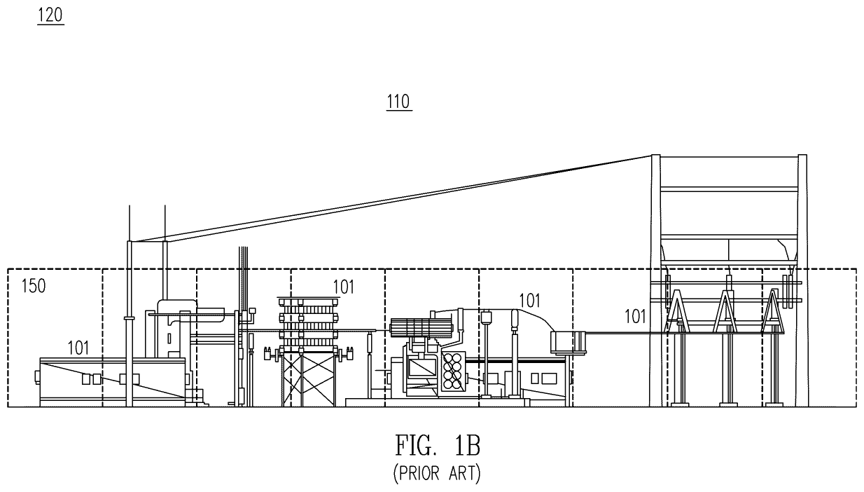

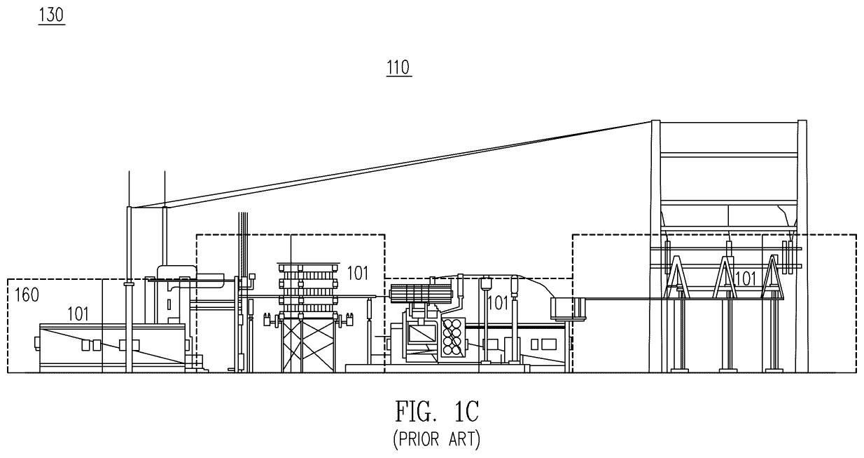

Common reference numerals are used throughout the figures and the detailed description to indicate like elements. One skilled in the art will readily recognize that the above figures are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

As used herein, the term “gaming module,” and “gaming engine” are used interchangeably and include any interactive 3D visualization system capable of transforming 3D model data, such as 3D mesh data, representing various features and structures into an interactive representation of the structures and features represented in the 3D model data.

As used herein, the term “data source” includes, but is not limited to one or more databases, one or more memories or portions of memories, one or more RAM systems, one or more ROM systems, one or more data disks, one or more caches, one or more registers, one or more servers, one or more computing systems, and/or any other form of data storage and/or data source, whether volatile or non-volatile, as discussed herein and/or as known in the art at the time filing, and/or as developed after the time of filing capable of storing data and/or providing data.

Disclosed herein is a holistic and dynamically interactive solution to the long standing technical problem of providing critical asset threat and mitigation analysis that is efficient, effective, and that provides for relative real time dynamic analysis of potential threats, potential mitigation measures, and the effectiveness of the potential threat mitigation features with respect to protecting existing and future critical assets.

To this end, in one embodiment, disclosed herein are processes and systems for identifying and mitigating threats to critical assets that leverage interactive 3D modeling systems, such as gaming engines, to generate customized interactive 3D critical asset site models that provide interactive visual displays of multiple potential threats, multiple vulnerabilities, multiple potential threat mitigation features/measures, and the effectiveness of each of the potential threat mitigation features with respect to protecting existing and future critical assets and/or critical asset sites.

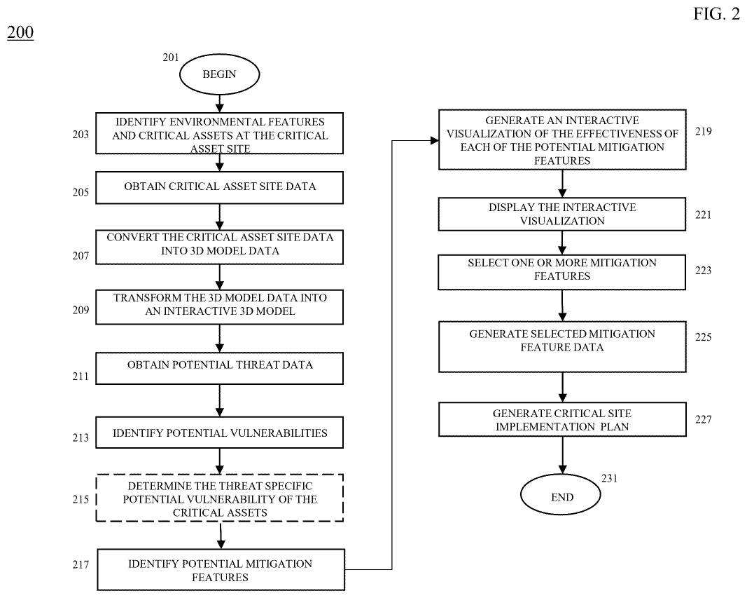

FIG. 2 is a flow chart showing some of the major operations of a process 200 for identifying and mitigating threats to critical assets in accordance with one embodiment.

As seen in FIG. 2, process 200 begins at operation 201 and process flow proceeds to operation 203. In one embodiment, at operation 203 existing and/or proposed environmental features and existing and/or proposed critical assets at the critical asset site are identified.

In various embodiments, the critical asset sites of operation 203 can be existing and/or proposed critical asset sites, such as, but not limited to, power generation facilities including electrical power generation substations, wind farms, solar farms, and hydro-electric dams and facilities; military, government, and civilian communication stations and substations; port facilities and Naval stations; water production facilities including reservoirs, dams, pumping facilities and aqueducts; airports; sewage treatment sites; chemical production facilities; railways and railway stations; food storage facilities; and/or any other site where critical assets can be found as discussed herein and/or as known at the time of filing, and/or as developed after the time of filing.

In addition, the critical asset sites of operation 203 can, and most often will, include not only the actual or proposed critical asset site but also surrounding features and land including, but not limited to, surrounding terrain, roads, buildings, developments, etc.

In various embodiments, the critical assets identified at operation 203 can be existing critical assets and/or proposed critical assets. In various embodiments, the environmental features identified at operation 203 can be existing environmental features and/or proposed environmental features.

In various embodiments, the critical assets identified at operation 203 can be, but are not limited to: electrical transformers, electrical generators, power lines, and any power production and/or transmission components; signal transmission stations and signal transmission towers; dams, aqueducts, and control facilities; communication stations and communication antennas; various governmental buildings; airport control towers, fueling stations, radars and communication systems; and/or any other critical assets as discussed herein, and/or as known in the art at the time of filing, and/or as become known or available after the time of filing that are deemed subject to attack.

In various embodiments, the environmental features identified at operation 203 can be, but are not limited to: existing or planned grading and topographical features; existing or planned hills, mounds, and other soil or rock features; existing natural vegetation, or proposed vegetation plantings resulting from agriculture or aesthetic purposes; existing or planned water features; existing or planned public and/or private highways, roads, trails, or paths; and/or any other environmental features as discussed herein, and/or as known in the art at the time of filing, and/or as become known or available after the time of filing.

In various embodiments, the critical assets and/or environmental features can be identified in various ways including being identified by the owner operator/builder of the critical asset site, publicly or privately collected satellite and/or photographic imagery, existing or proposed critical asset site diagrams, drawings, and models, drone images, aerial LiDAR or photogrammetric systems, terrestrial LiDAR or photogrammetric systems, radar systems, CAD drawings, images and models, and/or any other source for identifying existing and/or proposed critical assets and/or environmental features at a critical asset site as discussed herein, and/or as known in the art at the time of filing, and/or as become known or available after the time of filing.

In some embodiments, only portions of the critical assets identified at operation 203 need to be protected. Typically these are portions of the critical assets that are particularly vulnerable to attack and/or that are the most critical feature of the critical assets.

In one embodiment, once the critical assets and/or environmental features are identified at operation 203, process flow proceeds to operation 205.

In one embodiment, at operation 205, critical asset site data representing the identified existing and/or proposed environmental features and existing and/or proposed critical assets at the critical asset site is collected or otherwise obtained.

In various embodiments, at operation 205 the critical asset site data representing the identified existing and/or proposed environmental features and existing and/or proposed critical assets at the critical asset site is collected/obtained using one or more data collection systems discussed above. Consequently, in various embodiments, the critical asset site data can include, but is not limited to, one or more of: publicly or privately collected satellite and/or photographic data; existing or proposed critical asset site diagrams, drawings, and model data; drone data; aerial LiDAR or photogrammetric data; terrestrial LiDAR or photogrammetric data; radar data, CAD data, and/or any other data representing existing and/or proposed critical assets and/or environmental features at a critical asset site as discussed herein, and/or as known in the art at the time of filing, and/or as become known or available after the time of filing.

In one embodiment, once the critical asset site data representing the identified existing and/or proposed environmental features and critical assets at the critical asset site is collected at operation 205, process flow proceeds to operation 207.

In one embodiment, at operation 207, the critical asset site data is provided to a 3D modeling system.

In one embodiment, at operation 207 the 3D modeling system converts the critical asset site data into 3D model data representing the critical asset site including existing and/or proposed environmental features and the existing and/or proposed critical assets.

In one embodiment, at operation 207, the 3D modeling system converts two or more types of critical asset site data from two of more collection systems into 3D model data. In various embodiments, a particular type of critical asset site data may be preferred, and used, to represent particular critical assets and environmental features while a different type of critical asset site data may be preferred, and used, to represent other critical assets and environmental features.

As a specific example, in one embodiment, aerial drone data might be used to represent environmental features while more detailed terrestrial LiDAR data might be used to represent critical assets and/or specific critical asset features such as transformers. In this specific example, the 3D modeling system could use the aerial drone data as the base data and then terrestrial LiDAR data could be inserted into the model to represent the transformers at the critical asset site. In this way the desired detail for the critical asset can be relatively seamlessly provided in the 3D model.

The 3D modeling system of operation 207 can be any 3D modeling system discussed herein, and/or as known in the art at the time of filing, and/or as developed/made available after the time of filing capable of converting various types of critical asset site data into a 3D model of the critical asset site.

Specific examples of 3D modeling systems are modeling systems available from “Autodesk” such as “3DS Max”. However, several 3D modeling systems are well known and available. Thus, the operation and use of 3D modeling systems is well known. Consequently, a more detailed discussion of any particular 3D modeling system is omitted here to avoid detracting from the invention.

In one embodiment, once the critical asset site data is provided to a 3D modeling system and the 3D modeling system converts the critical asset site data into 3D model data representing the critical asset site including existing and/or proposed environmental features and the existing and/or proposed critical assets at operation 207, process flow proceeds to operation 209.

In one embodiment, at operation 209 the 3D model data is provided to an interactive 3D modeling system that transforms the 3D model data into an interactive 3D model representation of the critical asset site including existing and/or proposed environmental features and the existing and/or proposed critical assets.

In one embodiment, at operation 209 the 3D model data of operation 207 is first converted into a format that can be processed by the interactive 3D modeling system. In one embodiment, this conversion is accomplished using known data conversion systems such as “Datasmith Exporter” available from “Epic Games”. In other embodiments, any data conversion system capable of formatting the 3D model data of operation 207 into data usable by an interactive 3D modeling system can be used at operation 209.

Several data conversion systems are well known and available. Thus the operation and use of data conversion systems is well known. Consequently, a more detailed discussion of any particular data conversion systems is omitted here to avoid detracting from the invention.

In one embodiment, once the 3D model data of operation 207 is converted into a format that can be processed by the interactive 3D modeling system, the converted 3D model data is provided to an interactive 3D modeling system.

In one embodiment, the interactive 3D modeling system transforms the 3D model data into an interactive 3D model representation of the critical asset site including existing and/or proposed environmental features and the existing and/or proposed critical assets.

In various embodiments, the interactive 3D modeling system of operation 209 can be any interactive 3D modeling system capable of transforming 3D model data, such as 3D mesh data, representing various features and structures into an interactive visualization of the structures and features represented in the 3D model data.

As a specific example, in one embodiment, the interactive 3D modeling system of operation 209 can be “Unreal Engine” available from “Epic Games”. However, several interactive 3D modeling systems are known in the art. Consequently, the basic use and operation of any specific interactive 3D modeling system is omitted here to avoid detracting from the invention.

However, as discussed in more detail below, using the disclosed embodiments, the basic interactive 3D modeling system of operation 209 is provided access to operational data specific to the field of critical asset analysis and mitigation to provide dynamically interactive features related to identified potential threats for a given critical asset site, the effectiveness of the identified potential threats, the vulnerability of the critical assets and/or critical asset site, and the effectiveness of various threat mitigation features against the identified potential threats.

In one embodiment, once the 3D model data of operation 207 is provided to an interactive 3D modeling system that transforms the 3D model data into an interactive 3D model representation of the critical asset site including existing and/or proposed environmental features and the existing and/or proposed critical assets at operation 209, process flow proceeds to operation 211.

In one embodiment, at operation 211 potential threats to the existing and/or proposed critical assets at the critical asset site identified at operation 203 are identified and potential threat data including data representing the identified potential threats' capabilities is generated.

In various embodiments, at operation 211 the types of threats that are considered likely potential threats for the critical asset site are identified and/or the threat data indicating the capabilities of those threats is obtained from one or more threat data sources.

In various embodiments, the types of threats most likely to be available in the area of the critical asset site can be obtained from private and public data sources including, but not limited to: intelligence from national, state, and local authorities; historical data; recent arms purchases data; known weapons systems used by potential threat groups; worst-case scenario estimates; and/or any other source of threat data discussed herein, and/or as known in the art at the time of filing, and/or as developed/made available after the time of filing that can provide data about potential threats to the critical asset site.

In various embodiments, the threat data can include, but is not limited to data indicating small arms such as rifles, pistols, and automatic weapons potentially in the area; data indicating any mortars, grenades, or rocket propelled grenades potentially in the area; data indicating anti-aircraft, anti-personnel, or anti-vehicle weapons potentially in the area; data indicating explosives such as dynamite, TNT, C4, etc. in the area; data indicating Improvised Explosive Devices (IEDs), or the capability to make IEDs, in the area; and/or data sources indicating any weapons that could be used to attack the critical assets or critical asset site as discussed herein, and/or as known in the art at the time of filing, and/or as made available after the time of filing.

In some embodiments, in the absence of specific threat data, worst-case scenario data is obtained/generated representing the most destructive weapons that could be used to attack the critical assets or critical asset site.

In various embodiments, at operation 211 the capabilities of the various types of threats are included in the threat data including, but not limited to, one or more of, calibers, ranges, magazine capacity, reload capacity, blast radii, etc.

In some embodiments, the threat data is stored and made available to the interactive 3D modeling system that transforms the 3D model data into an interactive 3D model representation of the critical asset site for processing various displays and models. In other embodiments, at least some of the threat data is stored and/or provided outside of the interactive 3D model representation of the critical asset site.

In one embodiment, once the types of threats that are considered likely potential threats for the critical asset site are identified and the data indicating the capabilities of those threats is obtained from one or more threat data sources at operation 211, process flows to operation 213.

In one embodiment, at operation 213 potential vulnerabilities associated with the existing and/or proposed critical assets at the critical asset site are identified and potential vulnerability data representing the identified potential vulnerabilities associated with the existing and/or proposed critical assets at the critical asset site is generated.

In one embodiment, the potential vulnerabilities associated with the existing and/or proposed critical assets at the critical asset site are identified using the interactive 3D model created by the interactive 3D modeling system.

In one embodiment, this is accomplished by providing one or more virtual light/illumination sources indicating line-of-sight vulnerability. In one embodiment, one or more these virtual light/illumination sources can be interactively placed anywhere desired within the interactive 3D model. Consequently, the virtual light/illumination sources can be interactively placed at, on, or in any existing or proposed critical asset or environmental feature.

As discussed in more detail below, in one embodiment, the virtual light/illumination sources virtually illuminate all portions and features of the interactive 3D model of the critical asset site that can be seen, and potentially attacked, from the location of the virtual light/illumination sources.

Thus, in one embodiment, the virtual light/illumination sources can be placed at each of the critical assets, and/or portion or feature of the critical assets, and/or critical asset site. Then any of the critical assets, and/or portion or feature of the critical assets, and/or critical asset site illuminated by the virtual light/illumination sources is considered vulnerable to attack.

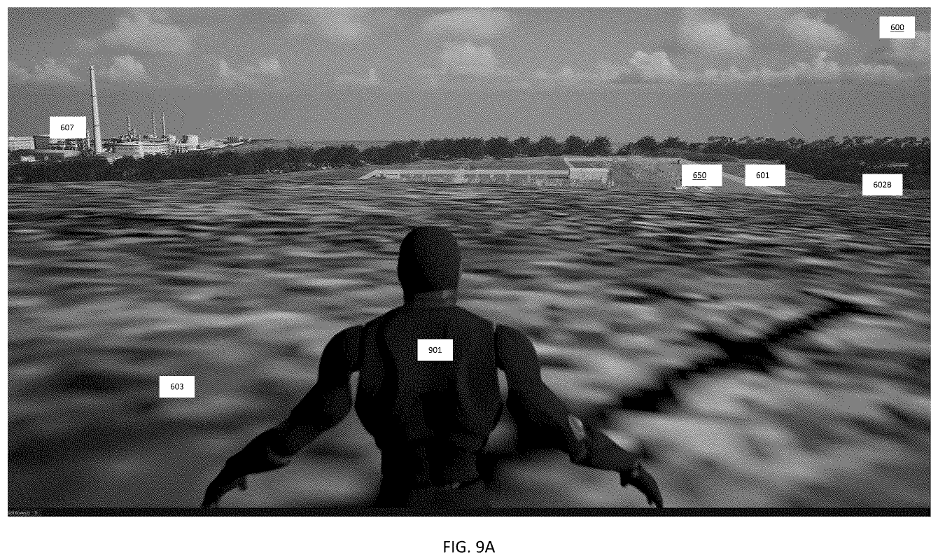

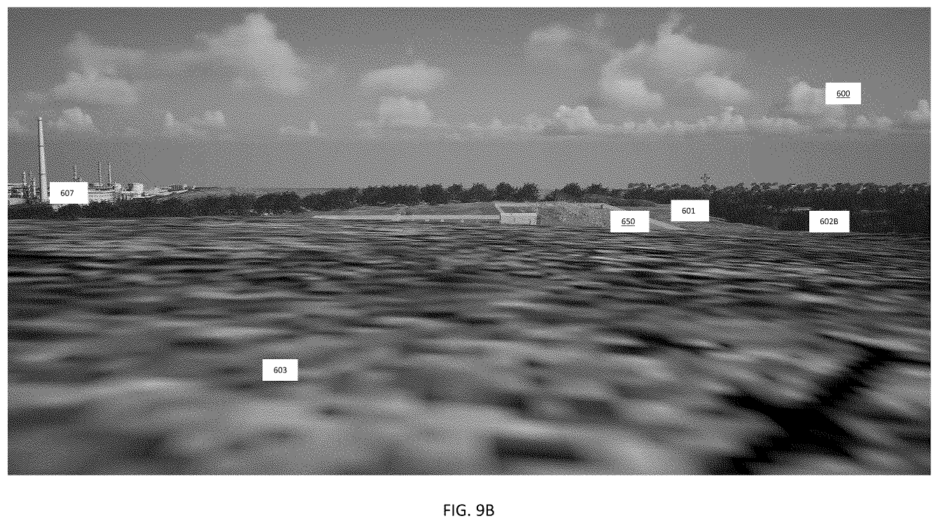

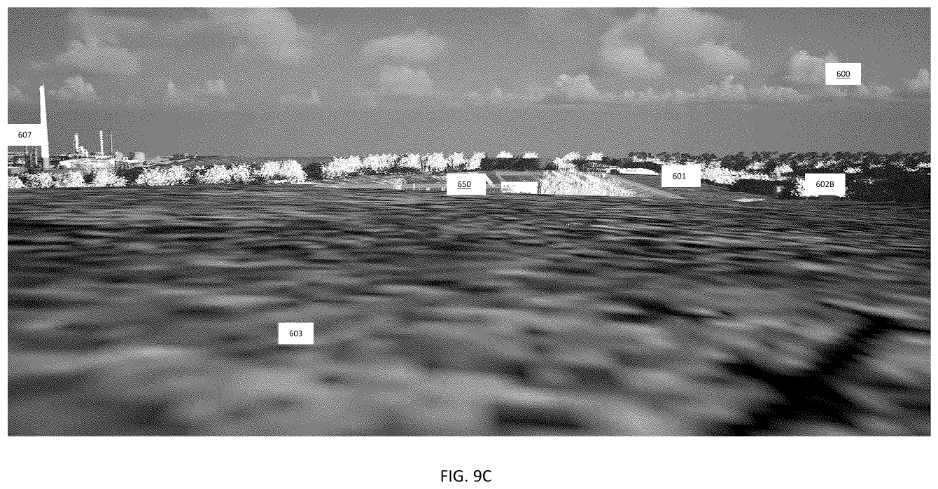

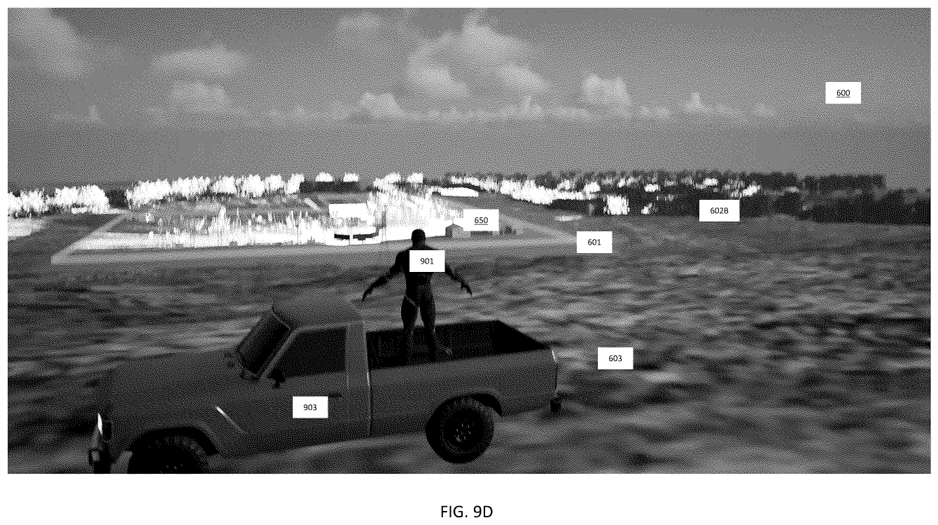

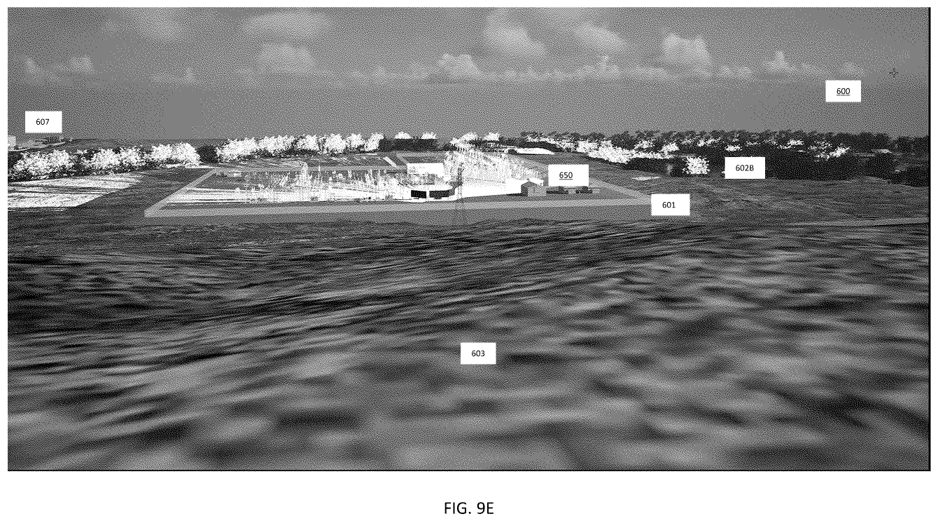

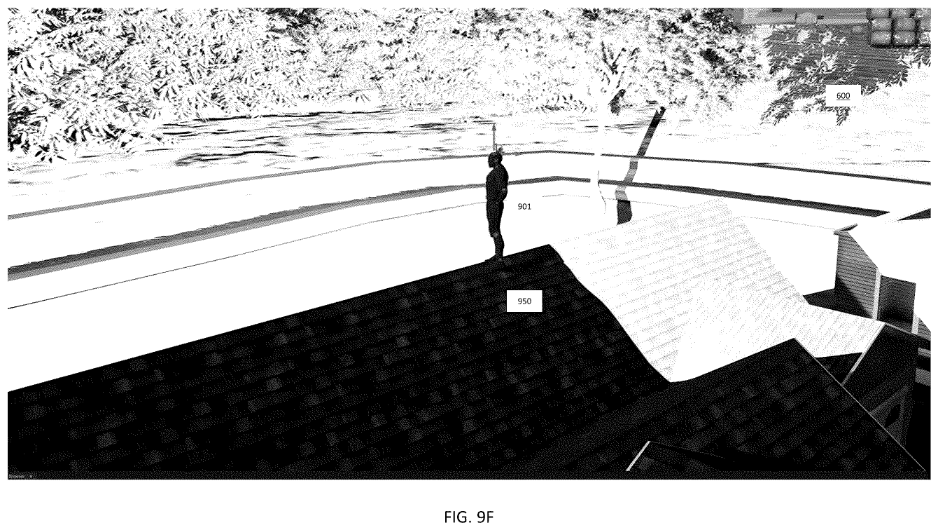

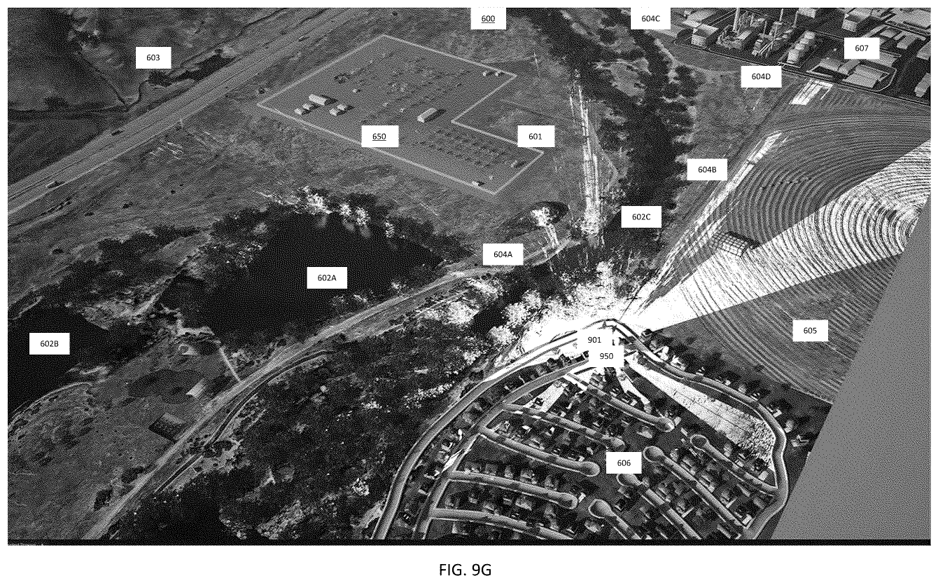

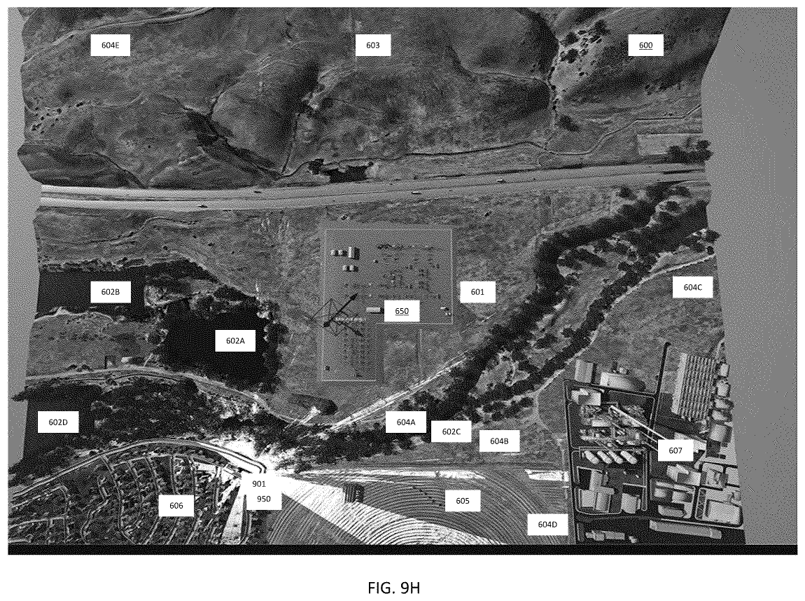

As discussed in more detail below, in other embodiments, avatars representing human threats can be generated to provide inward looking views with respect to the critical assets and critical asset site. This feature is discussed below with respect to FIGS. 9A through 9H.

In other embodiments, the potential vulnerabilities associated with the existing and/or proposed critical assets at the critical asset site are identified using other features of the interactive 3D model created by the interactive 3D modeling system such as varying views and perspectives, and/or various vectors and vector analysis.

In one embodiment, once the potential vulnerabilities associated with the existing and/or proposed critical assets at the critical asset site are identified using the interactive 3D model created by the interactive 3D modeling system at operation 213, process flow proceeds to optional operation 215.

In some embodiments, various operational data, such as the interactive 3D model threat data of operation 211, the vulnerability data of operation 213, and mitigation feature data of operation 217 discussed below are made available to the interactive 3D modeling system that transforms the 3D model data into an interactive 3D model representation of the critical asset site for processing various displays models.

In various embodiments, the operational data includes, but is not limited to, one or more of ranging data, threat ballistics data, mitigation feature data, mitigation feature cost data, updated intelligence data, visual monitoring mitigation feature data, and/or radar mitigation feature data. In one embodiment, this operational data is used to provide dynamic and relatively real time analysis of the vulnerability of the critical assets and the effectiveness of various threat mitigation features as various parameters are manipulated and changed by the user.

In one embodiment, at operation 215, the operational data is automatically processed to determine any threat specific potential vulnerability of the existing and/or proposed critical assets at the critical asset site to the identified potential threats and specific potential vulnerability data is generated representing the determined threat specific potential vulnerability of the existing and/or proposed critical assets at the critical asset site.

In other embodiments, at operation 215 the threat data of operation 211 is used to determine specific vulnerability of the critical assets by automatically adjusting the range of the analysis performed to the maximum range of the threat identified having the longest range and/or greatest capabilities.

As one specific example, when at 213 virtual light/illumination sources are used to identify critical asset vulnerabilities as discussed above, at optional operation 215 the range of virtual illumination of the virtual light/illumination sources can be adjusted to the maximum range of the identified threat. In another example, when avatars representing human threats are generated to provide inward looking views with respect to the critical assets and critical asset site, the avatars are automatically limited in placement to the maximum range of the identified threat.

In one embodiment, once the interactive 3D model is provided access to various operational data, such as the threat data of operation 211 and the vulnerability data of operation 213 and this operational data is processed to determine any threat specific potential vulnerability of the existing and/or proposed critical assets at the critical asset site at optional operation 215, process flow proceeds to operation 217.

In one embodiment, at operation 217, various threat mitigation features that can potentially be used to protect the critical assets and critical asset site are identified and mitigation feature data indicating parameters associated with those mitigation features is obtained and/or generated.

In one embodiment, the mitigation features can include, but are not limited to, one or more of: physical wall portions of various types, shapes, materials, widths, lengths, and heights; full screening perimeter walls of various types, shapes materials, widths, lengths, and heights; firewalls of various types, shapes, materials, widths, lengths, and heights; ballistic plating of various types, shapes, materials, widths, lengths, and heights; Kevlar or other bullet proof curtains of various types, shapes, widths, lengths, and heights; landscape environmental screening features of various types, shapes, materials, widths, lengths, and heights; visual detection systems of various types such as cameras; radar detection systems of various types; infrared detection systems of various types; equipment placement/relocations; and/or any other mitigation features capable of protecting the identified critical assets from various types of threats as discussed herein; and/or as known/available in the art at the time of filing, and/or as developed/made available after the time of filing.

In one embodiment, mitigation feature data representing the various threat mitigation features and parameters is generated at operation 217. As noted above, various operational data, such as the threat data of operation 211, the vulnerability data of operation 213, and mitigation feature data of operation 217 are made available to the interactive 3D modeling system that transforms the 3D model data into an interactive 3D model representation of the critical asset site for processing various displays and models. In other embodiments, the operational data is stored and/or provided outside of the interactive 3D model representation of the critical asset site.

As noted above, in one embodiment, the operational data, including the mitigation feature data, is used to provide relatively real time interactive and dynamic analysis of the vulnerability of the critical assets and the effectiveness of various threat mitigation features as various parameters/operational data related to the threat mitigation features are manipulated and changed by the user.

In one embodiment, once the threat mitigation feature data representing the various threat mitigation features and parameters is generated at operation 217, process flow proceeds to operation 219.

In one embodiment, at operation 219, the interactive 3D modeling system that transforms the 3D model data into an interactive 3D model representation of the critical asset site of operation 209 processes the threat data of operation 211, the vulnerability data of operation 213 and/or the threat specific potential vulnerability data of operation 215, and the potential threat mitigation feature data of operation 217 to generate an interactive visualization display of the effectiveness of the potential threats to the critical assets and/or critical asset site, the potential vulnerability of the critical assets and/or critical asset site, and the effectiveness of the potential threat mitigation features for protecting the existing and/or proposed critical assets and critical asset site.

In one embodiment, once the interactive 3D modeling system generates the interactive 3D model representation of the critical asset site at operation 209 and generates an interactive visualization display of the effectiveness of the potential threats to the critical assets and/or critical asset site, the potential vulnerability of the critical assets and/or critical asset site, and the effectiveness of the potential threat mitigation features for protecting the existing and/or proposed critical assets and critical asset site at operation 219, process flow proceeds to operation 221.

In one embodiment, at operation 221, the interactive 3D modeling system generates and displays interactive 3D model representations that dynamically change in response to user interactions with the interactive 3D model representation.

In one embodiment, at operation 221, the user can interact with the interactive 3D model representation using any one of various interface devices such as a touch screen, mouse, etc. In this way the user can change potential threats, potential ranges, and potential threat mitigation features and parameters.

Then, in response to these changed input parameters, the interactive 3D model representation modifies the interactive 3D model display to indicate the threat, the vulnerabilities of the critical assets to that threat, and the effectiveness of various threat mitigation features and parameters with respect to the threat; all in relative real time and all being dynamically adjusted according to the user's input.

In this way, the interactive visualization of the effectiveness of each of the potential threat mitigation features for protecting the existing and/or proposed critical assets at the critical asset site within the interactive 3D model representation of the critical asset site is presented in a seamlessly modified series of dynamically adjustable displays.

In one embodiment, once the interactive 3D modeling system generates and displays interactive 3D model representations that dynamically change in response to user interactions with the interactive 3D model representation at operation 221, process flow proceeds to operation 223.

In one embodiment, at operation 223 one or more mitigation features are selected by the user based, at least in part, on the visualization of the effectiveness of the potential threat mitigation features for protecting the existing and/or proposed critical assets at the critical asset site provided at operation 221.

In one embodiment, once one or more mitigation features are selected by the user based, at least in part, on the visualization of the effectiveness of the potential threat mitigation features for protecting the existing and/or proposed critical assets at the critical asset site at operation 223, process flow proceeds to operation 225.

In one embodiment, at operation 225, selected threat mitigation feature data is generated representing the type, dimensions, and location of the selected threat mitigation features for the existing and/or proposed critical assets at the critical asset site.

In one embodiment, once selected threat mitigation feature data is generated at operation 225, process flow proceeds to operation 227.

In one embodiment, at operation 227, a critical asset site mitigation feature implementation plan is generated incorporating the selected threat mitigation features represented by the selected threat mitigation feature data of operation 225.

In one embodiment, process 200 is then exited at END operation 231.

In one embodiment, the disclosed processes and systems for determining and mitigating threats to critical assets includes processes for determining and mitigating threats to existing critical assets. These embodiments are also referred to as “existing facilities/structures” processes and systems for determining and mitigating threats to existing critical assets.

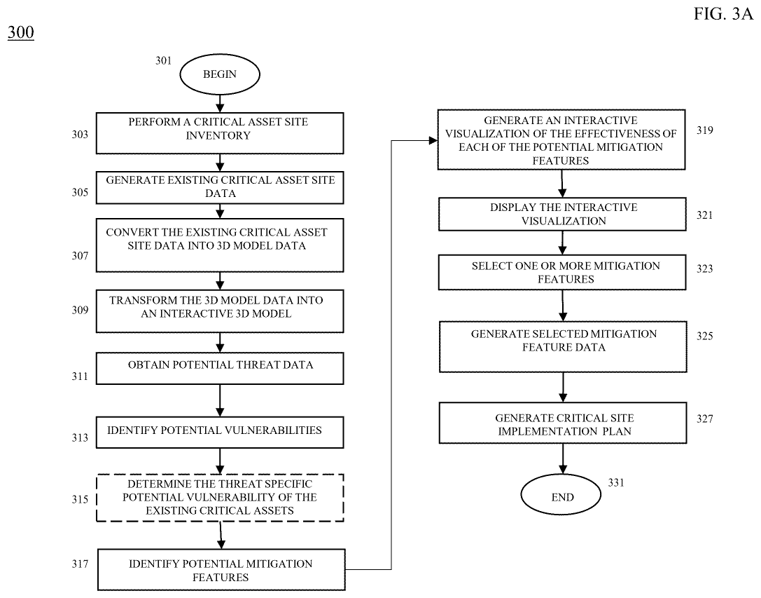

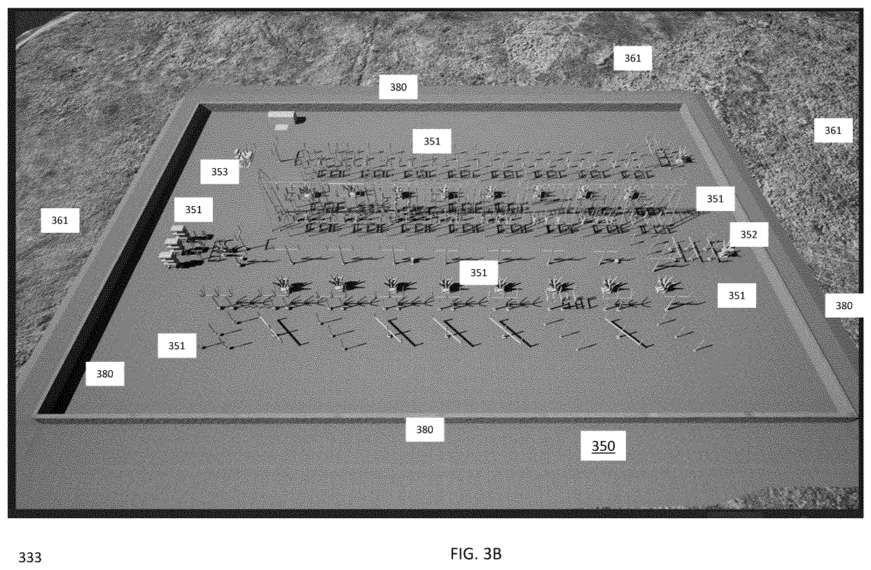

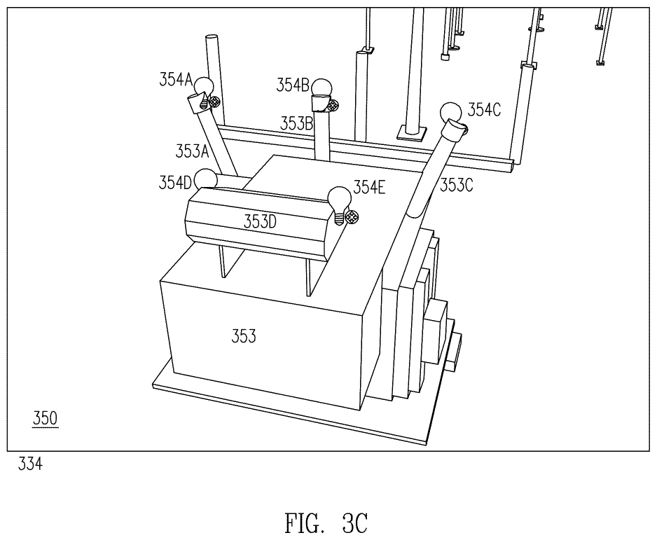

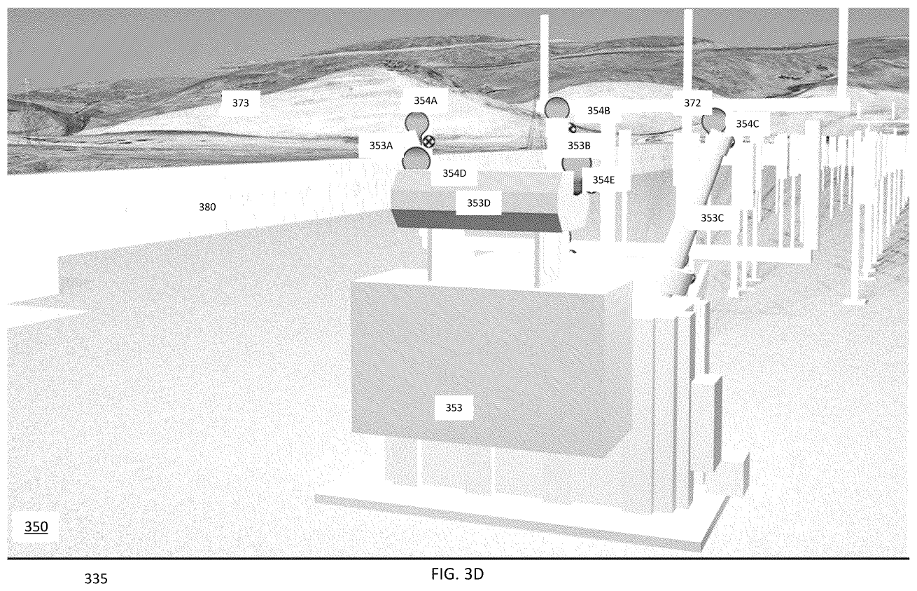

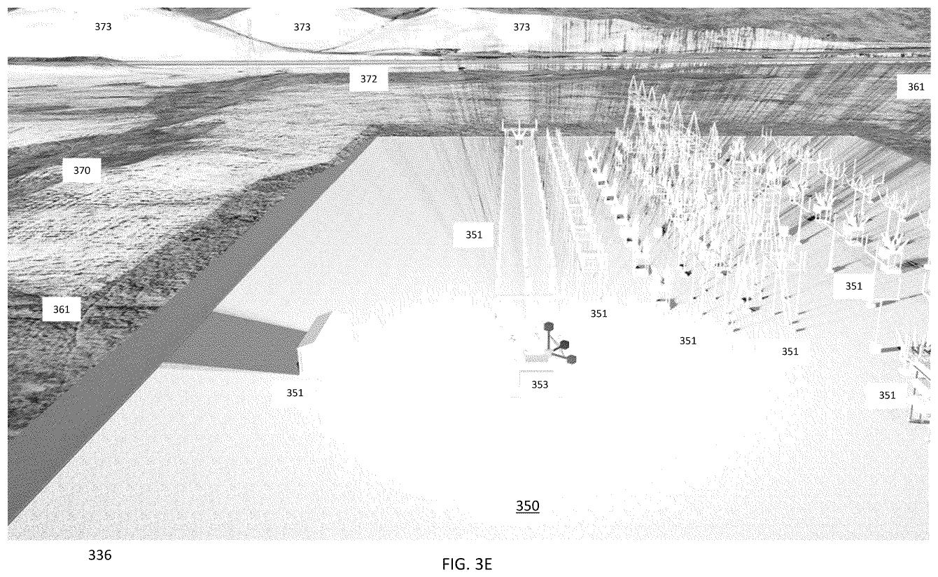

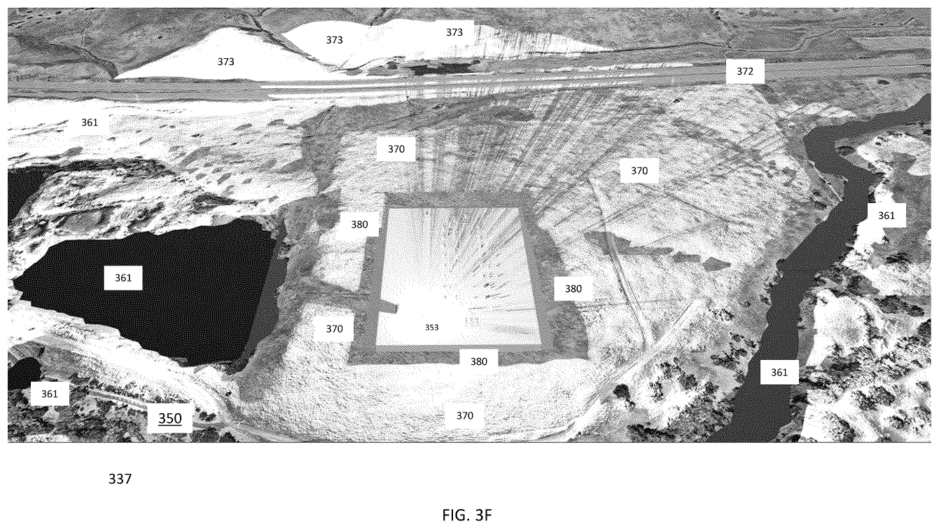

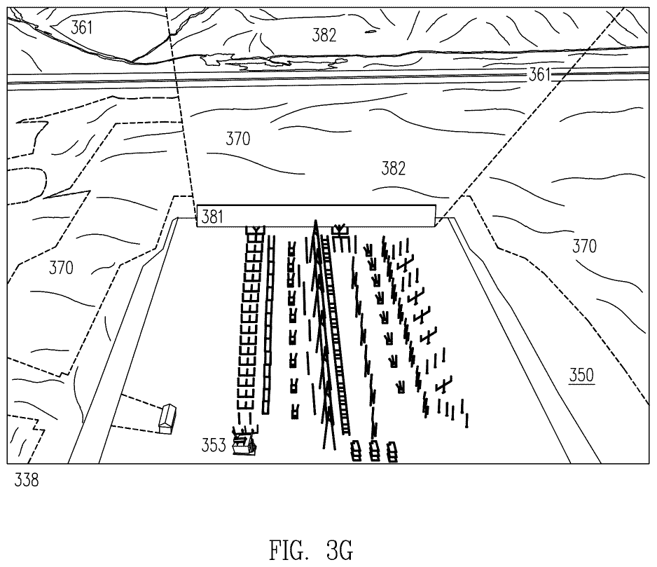

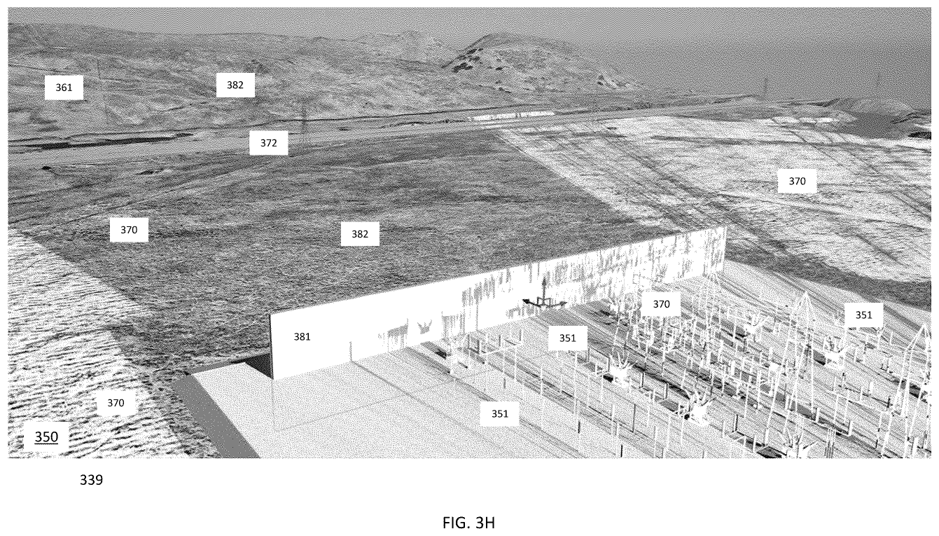

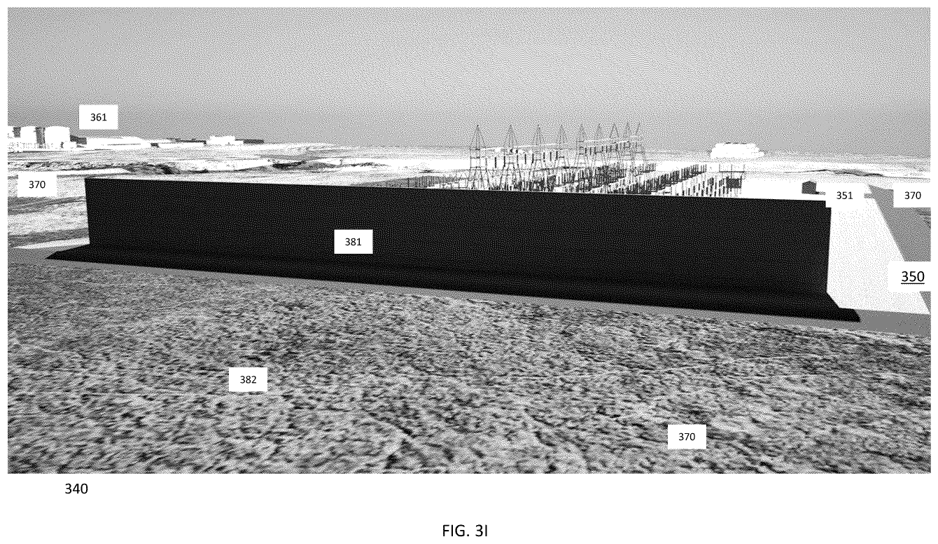

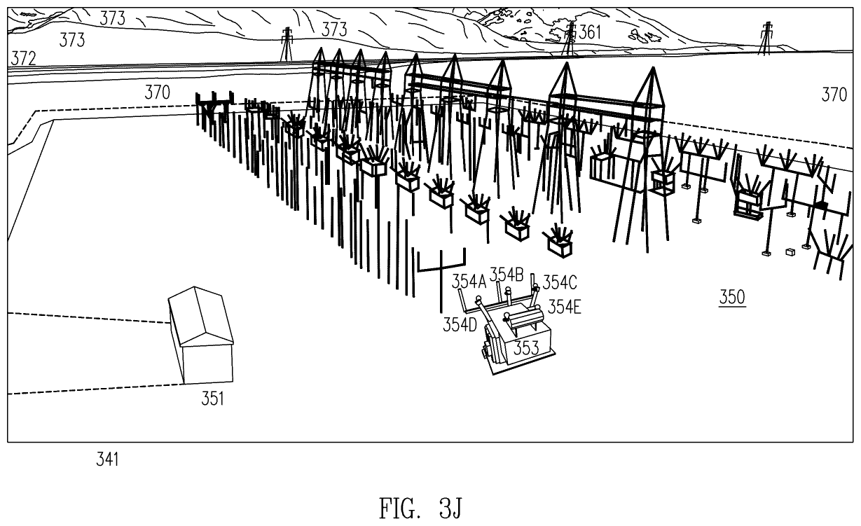

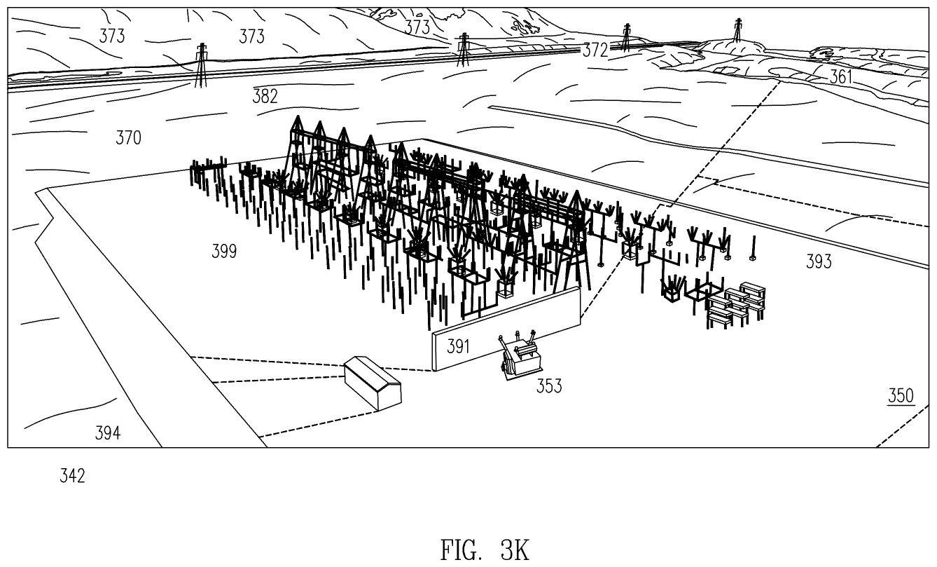

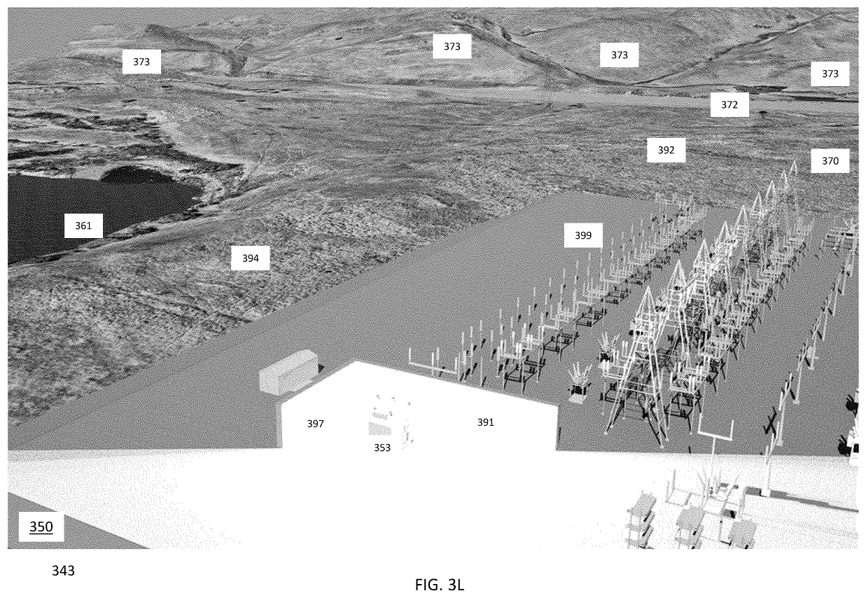

FIG. 3A is a flow chart showing some of the major operations of a process 300 for identifying and mitigating threats to existing critical assets in accordance with one embodiment.

As seen in FIG. 3A, process 300 begins at begin operation 301 and process flow proceeds to operation 303. In one embodiment, at operation 303 a critical asset site inventory of existing critical assets and existing and/or proposed environmental features at the critical asset site is performed.

In various embodiments, the critical asset sites of operation 303 can be any existing critical asset sites, such as, but not limited to, power generation facilities including electrical power generation substations, wind farms, solar farms, and hydro-electric dams and facilities; military, government, and civilian communication stations and substations; port facilities and Naval stations; water production facilities including reservoirs, dams, pumping facilities and aqueducts; airports; sewage treatment sites; chemical production facilities; railways and railway stations; food storage facilities; and/or any other site where critical assets can be found as discussed herein and/or as known at the time of filing, and/or as developed after the time of filing.

In addition, the critical asset sites of operation 303 can, and most often will, include not only the existing critical asset site but also surrounding features and land including, but not limited to, surrounding terrain, roads, buildings, developments, etc.

In various embodiments, the critical assets identified at operation 303 are existing critical assets. In various embodiments, the environmental features identified at operation 303 can be existing environmental features and/or proposed environmental features.

In various embodiments, the existing critical assets identified at operation 303 can be, but are not limited to: electrical transformers, electrical generators, power lines, and any power production and/or transmission components; signal transmission stations and signal transmission towers; dams, aqueducts, and control towers; communication stations and communication antennas; various governmental buildings; airport control towers, fueling stations, radars stations, and communication systems; and/or any other critical assets as discussed herein, and/or as known in the art at the time of filing, and/or as become known or available after the time of filing that are deemed subject to attack.

In various embodiments, the environmental features identified at operation 303 can be, but are not limited to: existing or planned grading and topographical features; existing or planned hills, mounds, and other soil or rock features; existing or planned water features; existing or planned public and/or private highways, roads, trails, or paths; and/or any other environmental features as discussed herein, and/or as known in the art at the time of filing, and/or as become known or available after the time of filing.

In various embodiments, the critical assets and/or environmental features can be identified in various ways including being identified by the owner operator/builder of the critical asset site, publicly or privately collected satellite and/or photographic imagery, existing critical asset site diagrams, drawings, and models, drone images, aerial LiDAR systems, terrestrial LiDAR systems, radar systems, CAD drawings, images and models, and/or any other source for identifying existing proposed critical assets and/or environmental features at a critical asset site as discussed herein, and/or as known in the art at the time of filing, and/or as become known or available after the time of filing.

In some embodiments, only portions of the critical assets identified at operation 303 need to be protected. Typically these are portions of the critical assets that are particularly vulnerable to attack and/or that are the most critical features of the critical assets.

In one embodiment, once the critical assets and/or environmental features are identified at operation 303, process flow proceeds to operation 305.

In one embodiment, at operation 305, critical asset site data representing the identified existing critical assets and environmental features at the critical asset site is collected.

In various embodiments, at 305, the critical asset site data representing the identified existing critical assets and/or environmental features at the critical asset site is collected using one or more of the data collection systems discussed above. Consequently, in various embodiments, the critical asset site data can include, but is not limited to one or more of: publicly or privately collected satellite and/or photographic data; existing or proposed critical asset site diagram, drawing, and model data; drone data; aerial LiDAR data; terrestrial LiDAR data; radar data, CAD data, and/or any other data representing existing critical assets and/or environmental features at a critical asset site as discussed herein, and/or as known in the art at the time of filing, and/or as become known or available after the time of filing.

In one embodiment, once the critical asset site data representing the identified existing or proposed environmental features and existing critical assets at the critical asset site is collected at operation 305, process flow proceeds to operation 307.

In one embodiment, at operation 307, the critical asset site data is provided to a 3D modeling system.

In one embodiment, at operation 307 the 3D modeling system converts the critical asset site data into 3D model data representing the critical asset site including the environmental features and the existing critical assets.

In one embodiment, at operation 307, the 3D modeling system converts two or more types of critical asset site data from two of more data collection systems into 3D model data. In various embodiments, a particular type of critical asset site data may be preferred, and used, to represent particular critical assets and environmental features while a different type of critical asset site data may be preferred, and used, to represent other critical assets and environmental features.

As a specific example, in one embodiment, aerial drone data might be used to represent critical asset site features such as environmental features while more detailed terrestrial LiDAR data might be used to represent critical assets and/or specific critical asset features such as transformers. In this specific example, the 3D modeling system could use the aerial drone data as the base data and then terrestrial LiDAR data representing the transformers or other critical assets or features could be inserted into the model to represent these features at the critical asset site. In this way the desired detail for the existing critical assets can be relatively seamlessly provided in the 3D model.

The 3D modeling system of operation 307 can be any 3D modeling system discussed herein, and/or as known in the art at the time of filing and/or as developed/made available after the time of filing capable of converting various types of critical asset site data into a 3D model of the critical asset site.

Specific examples of 3D modeling systems are any 3D modeling systems available from “Autodesk” such as “3DS Max”. However, several 3D modeling systems are well known and available. Thus, the operation and use of 3D modeling systems is well known. Consequently, a more detailed discussion of any particular 3D modeling system is omitted here to avoid detracting from the invention.

In one embodiment, once the critical asset site data is provided to a 3D modeling system and the 3D modeling system converts the critical asset site data into 3D model data representing the critical asset site including existing and/or proposed environmental features and the existing critical assets at operation 307, process flow proceeds to operation 309.

In one embodiment, at operation 309 the 3D model data is provided to an interactive 3D modeling system that transforms the 3D model data into an interactive 3D model representation of the critical asset site including existing and/or proposed environmental features and the existing critical assets.

In one embodiment, at operation 309 the 3D model data of operation 307 is first converted into a format that can be processed by the interactive 3D modeling system. In one embodiment, this conversion is accomplished using known data conversion systems such as “Datasmith Exporter” available from “Epic Games”. In other embodiments, any data conversion system capable of formatting the 3D model data of operation 307 into data usable by an interactive 3D modeling system can be used at operation 309.

Several data conversion systems are well known and available. Thus, the operation and use of data conversion systems is well known. Consequently, a more detailed discussion of any particular data conversion system is omitted here to avoid detracting from the invention.

In one embodiment, once the 3D model data of operation 307 is converted into a format that can be processed by the interactive 3D modeling system, the converted 3D model data is provided to an interactive 3D modeling system.

In one embodiment, the interactive 3D modeling system transforms the 3D model data into an interactive 3D model representation of the critical asset site including existing and/or proposed environmental features and the existing critical assets.

In various embodiments, the interactive 3D modeling system of operation 309 can be any interactive 3D modeling system capable of transforming 3D model data, such as 3D mesh data, representing various features and structures into an interactive visualization of the structures and features represented in the 3D model data.

As a specific example, in one embodiment, the interactive 3D modeling system of operation 309 can be “Unreal Engine” available from “Epic Games”. However, several interactive 3D modeling systems are known in the art. Consequently, the basic use and operation of any specific interactive 3D modeling system is omitted here to avoid detracting from the invention.

However, as discussed in more detail below, using the disclosed embodiments, the basic interactive 3D modeling system of operation 309 is provided access to operational data specific to the field of critical asset analysis and mitigation. Using this operational data, dynamically interactive features related to potential threats for a given critical asset site, the effectiveness of the potential threats, and the effectiveness of various threat mitigation features against the potential threats can be generated and displayed.

FIGS. 3B through 3L show several screen shots 333-343 of an interactive display of an interactive 3D model representation of an existing critical asset site 350 including various existing critical assets and structures 351, an existing mitigation feature 380, in this example a permitter wall, and various environmental features 361 as would be generated using process 300 for identifying and mitigating threats to existing critical assets in accordance with one embodiment.

In particular, FIG. 3B shows a screen shot 333 of an interactive display of an interactive 3D model representation of existing critical asset site 350 including the various existing critical assets and structures 351 and various environmental features 361 as would be generated using process 300 for identifying and mitigating threats to existing critical assets in accordance with one embodiment.

Of note in FIG. 3B is critical asset 353 which in this specific illustrative example is a transformer that will be used for analysis in FIGS. 3C through 3L as an illustrative example below.

Referring back to FIG. 3A, in one embodiment, once the 3D model data of operation 307 is provided to an interactive 3D modeling system that transforms the 3D model data into an interactive 3D model representation of the critical asset site including existing and/or proposed environmental features and the existing and/or proposed critical assets at operation 309, process flow proceeds to operation 311.

In one embodiment, at operation 311 information about potential threats to the existing and/or proposed critical assets at the critical asset site identified at operation 303 is obtained to generate potential threat data including data representing the identified potential threats' capabilities.

In various embodiments, at operation 311 the types of threats that are considered likely potential threats for the critical asset site are identified and the data indicating the capabilities of those threats is obtained from one or more threat data sources.

In various embodiments, information regarding the types of threats most likely to be available in the area of the critical asset site can be obtained from private and public data sources including, but not limited to: intelligence from national, state, and local authorities; historical data; recent arms purchases data; known weapons systems used by potential threat groups; worst-case scenario estimates; and/or any other source of threat data as discussed herein, and/or as known in the art at the time of filing, and/or as developed/made available after the time of filing that can provide data about potential threats to the critical asset site.

In various embodiments, the threat data can include, but is not limited to, data indicating small arms such as rifles, pistols, and automatic weapons potentially in the area; data indicating any mortars, grenades, or rocket propelled grenades potentially in the area; data indicating anti-aircraft, anti-personnel, or anti-vehicle weapons potentially in the area; data indicating explosives such as dynamite, TNT, C4, etc. in the area; data indicating Improvised Explosive Devices (IEDs), or the capability to make IEDs, in the area; and/or data indicating any weapons that could be used to attack the critical assets or the critical asset site as discussed herein, and/or as known in the art at the time of filing, and/or as made available after the time of filing.

In some embodiments, in the absence of specific threat data, worst-case scenario data is obtained representing the most destructive weapons systems that could be used to attack the critical assets or critical asset site.

In various embodiments, at operation 311 the capabilities of the various types of threats are included in the threat data including, but not limited to, one or more of, calibers, ranges, magazine capacity, reload capacity, blast radii, etc.

In some embodiments, the threat data is stored and made available to the interactive 3D modeling system that transforms the 3D model data into an interactive 3D model representation of the critical asset site for processing various displays models. In other embodiments, the threat data is stored and/or provided outside of the interactive 3D model representation of the critical asset site.

In one embodiment, once the types of threats that are considered likely potential threats for the critical asset site are identified and the data indicating the capabilities of those threats is obtained from one or more threat data sources at operation 311, process flows to operation 313.

In one embodiment, at operation 313 potential vulnerabilities associated with the existing critical assets at the critical asset site are identified and potential vulnerability data representing the identified potential vulnerabilities associated with the existing critical assets at the critical asset site is generated.

In one embodiment, the potential vulnerabilities associated with the existing critical assets at the critical asset site are identified using the interactive 3D model created by the interactive 3D modeling system.

In one embodiment, this is accomplished by providing one or more virtual light/illumination sources indicating line-of-sight vulnerability. In one embodiment, one or more of these virtual light/illumination sources can be interactively placed anywhere desired within the interactive 3D model.

As discussed in more detail below, in one embodiment, the virtual light/illumination sources virtually illuminate all portions and features of the interactive 3D model of the critical asset site that can be seen and therefore potentially attacked.

Thus, in one embodiment, the virtual light/illumination sources can be placed at each of the critical assets, and/or portions or features of the critical assets, and/or any location in or around the critical asset site. Then the critical assets, and/or portions or features of the critical assets, and/or portions of the critical asset site illuminated by the virtual light/illumination sources are considered vulnerable to attack.

As noted above, FIGS. 3B through 3L show several screen shots 333-343 of an interactive display of an interactive 3D model representation of existing critical asset site 350 including various existing critical assets and structures 351 and various environmental features 361 as would be generated using process 300 for identifying and mitigating threats to existing critical assets in accordance with one embodiment.

FIGS. 3C and 3D show screen shots 334 and 335 of an interactive display of the interactive 3D model representation of the existing critical asset site of FIG. 3B including the placement of virtual light/illumination sources 354A through 354E for identifying potential vulnerability of a selected critical asset 353 at the existing critical asset site 350. In FIG. 3C, virtual light/illumination sources 354A, 354B, and 354C are interactively placed at the top of bushing portions 353A, 353B, and 353C, respectively, of selected critical asset 353.

As seen in FIGS. 3C, 3D and 3E, virtual light/illumination sources 354A, 354B, 354C, 354D and 354E identify line-of-sight vulnerability of portions 353A, 353B, 353C and 353D of selected critical asset 353, in this example a transformer, by showing illuminated areas. In this example, any area or feature illuminated by virtual light/illumination sources 354A, 354B, 354C, 354D and 354E in FIG. 3C, including the entire field 370, road 372, hillsides 373, and various other environmental features 361 is a location where a person or other threat would have line-of-sight access to portions 353A, 353B, 353C, 353D of the selected critical asset 353.

Similarly, FIG. 3E shows a screen shot 336 of an interactive display of the interactive 3D model representation of the existing critical asset site of FIGS. 3B, 3C, and 3D including the placement of virtual light/illumination sources 354A, 354B, 354C, 354D and 354E identifying potential vulnerability of selected critical asset 353 at the critical asset site 350.

In various embodiments, any number of virtual lights/illumination sources, such as virtual light/illumination sources 354A, 354B, 354C, 354D and 354E can be generated and placed at any location within the 3D model representation of an existing critical asset site 350. Consequently, line-of-sight vulnerability of any location, and any critical asset or critical asset portion, and any location within the critical asset site or surrounding area desired can be visualized and analyzed. This, in turn, provides for dynamically interactive holistic analysis of the vulnerability of the entire critical asset site and surrounding area and any and all critical assets at the critical asset site.

As discussed in more detail below, in other embodiments, avatars representing human threats can be generated to provide inward looking views with respect to the critical assets and critical asset site. This feature is discussed below with respect to FIGS. 9A through 9H.

Referring back to FIG. 3A, in other embodiments, the potential vulnerabilities associated with the existing critical assets at the critical asset site are identified using other features of the interactive 3D model created by the interactive 3D modeling system such as varying views and perspectives and/or various vectors and vector analysis.

In one embodiment, once the potential vulnerabilities associated with the existing and/or proposed critical assets at the critical asset site are identified using the interactive 3D model created by the interactive 3D modeling system at operation 313, process flow proceeds to optional operation 315.

In one embodiment, various operational data, such as the interactive 3D model threat data of operation 311, the vulnerability data of operation 313, and mitigation feature data of operation 317 discussed below are made available to the interactive 3D modeling system that transforms the 3D model data into an interactive 3D model representation of the critical asset site for processing various displays. In other embodiments, the operational data is stored and/or provided outside of the interactive 3D model representation of the critical asset site.

In one embodiment, the operational data includes, but is not limited to, one or more of ranging data, threat ballistics data, mitigation feature data, mitigation feature cost data, and updated intelligence data regarding known and/or potential threats. In one embodiment, this operational data is used to provide dynamic relatively real time analysis of the vulnerability of the critical assets and the effectiveness of various threat mitigation features as various parameters are manipulated and changed by the user.

In one embodiment, at optional operation 315 the operational data is processed to automatically determine and identify any threat specific potential vulnerability of the existing and/or proposed critical assets at the critical asset site to the identified potential threats and to automatically generate specific potential vulnerability data representing the determined threat specific potential vulnerability of the existing and/or proposed critical assets at the critical asset site.

In other embodiments, at optional operation 315 the threat data of operation 311 is used to determine specific vulnerability of the critical assets by simply adjusting the range of the analysis performed to the maximum range of the threat identified having the longest range and/or greatest capabilities.

As one specific example, when at operation 313 virtual light/illumination sources are used to identify critical asset vulnerabilities as discussed above, at optional operation 315 the range of virtual illumination from the virtual light/illumination sources can be adjusted to the maximum range of the identified threat.

In another example, when avatars representing human threats are generated to provide inward looking views with respect to the critical assets and critical asset site, the position at which the avatars can be placed is the maximum range of the identified threat.

In one embodiment, once the interactive 3D model is provided access to various operational data, such as the threat data of operation 311 and the vulnerability data of operation 313, and this operational data is processed to determine any threat specific potential vulnerability of the existing critical assets at the critical asset site at optional operation 315, process flow proceeds to operation 317.

In one embodiment, at operation 317, various threat mitigation features that can potentially be used to protect the critical assets and critical asset site are identified and mitigation feature data indicating parameters associated with those mitigation features is obtained and/or generated.

In one embodiment, the mitigation features can include, but are not limited to, one or more of: physical wall portions of various types, shapes, materials, widths, lengths, and heights; full screening perimeter walls of various types, shapes materials, widths, lengths, and heights; firewalls of various types, shapes, materials, widths, lengths, and heights; ballistic plating of various types, shapes, materials, widths, lengths, and heights; Kevlar or other bullet proof curtains of various types, shapes, widths, lengths, and heights; landscape environmental screening features of various types, shapes, materials, widths, lengths, and heights; visual detection systems of various types such as cameras; radar detection systems of various types; infrared detection systems of various types; equipment placement/relocations; and/or any other mitigation features capable of protecting the identified critical assets from various types of threats as discussed herein; and/or as known/available in the art at the time of filing, and/or as developed/made available after the time of filing.

In one embodiment, mitigation feature data representing the various threat mitigation features and parameters is generated at operation 317. As noted above, various operational data, such as the interactive 3D model threat data of operation 211, the vulnerability data of operation 213, and mitigation feature data of operation 217 are made available to the interactive 3D modeling system that transforms the 3D model data into an interactive 3D model representation of the critical asset site for processing various displays models. In other embodiments, the operational data is stored and/or provided outside of the interactive 3D model representation of the critical asset site.

As noted above, and discussed in more detail below, in one embodiment, the operational data, including the mitigation feature data, is used to provide dynamic relatively real time analysis of the vulnerability of the critical assets and the effectiveness of various threat mitigation features as various parameters are manipulated and changed by the user.

In one embodiment, once the mitigation feature data representing the various threat mitigation features and parameters is generated at operation 317, process flow proceeds to operation 319.

In one embodiment, at operation 319, the interactive 3D modeling system that transforms the 3D model data into an interactive 3D model representation of the critical asset site of operation 309 processes the threat data of operation 311, the vulnerability data of operation 313 and/or the threat specific potential vulnerability data of operation 315, and the potential threat mitigation feature data of operation 317 to generate an interactive visualization display of the effectiveness of the potential threats to the critical assets and/or critical asset site, the potential vulnerability of the critical assets and/or critical asset site, and the effectiveness of the potential threat mitigation features for protecting the existing critical assets and critical asset site.

In one embodiment, once the interactive 3D modeling system generates the interactive 3D model representation of the critical asset site at operation 309 and generates an interactive visualization display of the effectiveness of the potential threats to the critical assets and/or critical asset site, the potential vulnerability of the critical assets and/or critical asset site, and the effectiveness of the potential threat mitigation features for protecting the existing critical assets and critical asset site at operation 319, process flow proceeds to operation 321.

In one embodiment, at operation 321, the interactive 3D modeling system generates and displays interactive 3D model representations that dynamically change in response to user interactions with the interactive 3D model representation.

In one embodiment, at operation 321, the user can interact with the interactive 3D model representation using any one of various interface devices such as a touch screen, mouse, etc. In this way the user can change potential threats, potential ranges, and potential threat mitigation features and parameters. Then, in response to these changed input parameters, the interactive 3D modeling system modifies the interactive 3D model display to indicate the threat, the vulnerabilities to that threat for the critical assets, and the effectiveness of various threat mitigation features with respect to the threat; all in relative real time and all being dynamically adjusted according to the users' input.

In this way, the interactive visualization of the effectiveness of the potential threat mitigation features for protecting the existing and/or proposed critical assets at the critical asset site within the interactive 3D model representation of the critical asset site using the interactive 3D modeling system is presented in a seamless series of dynamically adjustable displays.

FIG. 3F shows a screen shot 337 of an interactive display of the interactive 3D model representation of the existing critical asset site 350 of FIGS. 3B, 3C, 3D and 3E.

FIG. 3F shows a wide-angle view of the potential threat and potential vulnerability of the selected critical asset 353, a transformer, at critical asset site 350 before any proposed threat mitigation features are generated.

Referring to FIGS. 3D, 3E and 3F together, as was the case with screen shot 336 of FIG. 3E, screen shot 337 of FIG. 3F includes virtual lights/illumination sources 354A, 354B, 354C, 354D, and 354E placed at portions 353A, 353B, 353C, and 353D of selected critical asset 353. Line-of-sight vulnerability of portions 353A, 353B, 353C, and 353D of selected critical asset 353 is then indicated by illuminated areas. In this example, any area or feature illuminated by virtual lights/illumination sources 354A, 354B, 354C, 354D, and 354E in FIGS. 3D, 3E, and 3F, including almost the entire fields 370, portions of road 372, hillsides 373, and other environmental features 361 is a location where a person or other threat would have line-of-sight access to portions 353A, 353B, 353C, and 353D of the selected critical asset 353.

Referring back to FIG. 3A, in one embodiment, at operation 321 of FIG. 3A, the user can interact with the interactive 3D model representation using any one of various interface devices such as a touch screen, mouse, etc. In this way the user can change potential threat mitigation features and parameters. Then, in response to these changed input parameters, the interactive 3D model representation modifies the interactive 3D model display to indicate the remaining vulnerabilities to the threat for each critical asset, and the effectiveness of various threat mitigation features with respect to the threat; all in relative real time and all being dynamically adjusted.

FIG. 3G shows a screen shot 338 of the interactive display of the interactive 3D model representation of the existing critical asset site of FIGS. 3B, 3C, 3D, 3E and 3F including an angled view of the potential vulnerability of the selected critical asset 353 at the existing critical asset site 350 when a proposed threat mitigation feature 381 is virtually implemented.

Referring to FIGS. 3E, 3F, and 3G together, as seen in FIG. 3G, using the disclosed process a proposed threat mitigation feature 381 that is a wall portion has been virtually inserted into the critical asset site 350 interactive 3D model. As can also be seen in FIG. 3G, proposed threat mitigation feature 381 creates shaded area 382 where there is now no illumination from virtual lights/illumination sources 354A through 354E. Consequently, FIG. 3G indicates that a threat located in shaded area 382 would no longer have line-of-sight access to portions 353A, 353B, 353C, and 353D of the selected critical asset 353.

FIG. 3H shows a screen shot 339 of the interactive display of the interactive 3D model representation of the existing critical asset site 350 of FIGS. 3B, 3C, 3D, 3E, 3F, and 3G including a close-up angled view of the potential vulnerability of the selected critical asset 353 at the critical asset site 350 after the proposed threat mitigation feature 381 is virtually implemented.

In various embodiments, the user can interact with the interactive 3D model representations to view all aspects of the interactive 3D model representations from any perspective, angle, and/or distance desired.

For instance, in one example the user may wish to view the interactive 3D model representation, including critical assets, virtual lights/illumination sources, and the critical asset site from the perspective of a person looking into the critical asset site. Using the disclosed embodiments this can be achieved by simply using an interface device to change the perspective view and/or viewpoint.

Referring to FIGS. 3G, 3H, and 3I together, FIG. 3I shows a screen shot 340 of the interactive display of the interactive 3D model representation of the existing critical asset site 350 of FIGS. 3G and 3H from a position in the shaded area 382 outside of the proposed threat mitigation feature 381. As can be seen, due to the presence of proposed threat mitigation feature 381, a threat positioned in the shaded area 382 can no longer see any of the features of selected critical asset 353.

FIG. 3J shows a screen shot 341 of the interactive display of the interactive 3D model representation of the existing critical asset site 350 of FIGS. 3B, 3C, 3D, 3E, 3F, 3G, 3H, and 3I including the placement of virtual light/illumination sources 354A through 354E identifying potential vulnerability of a selected critical asset 353 at the existing critical asset site 350 from a different angle. As can be seen in FIG. 3J, mitigation feature 381 of FIGS. 3G, 3H, and 3I has been removed.

As seen in FIG. 3J, like FIG. 3F, any area or feature illuminated by of virtual light/illumination sources 354A through 354E in FIG. 3J, including the almost the entire fields 370, portions of road 372, and hillsides 373 is a location where a person or other threat would have line-of-sight access to portions 353B, 353A, 353C, and 353D of the selected critical asset 353.

Again, in accordance with the disclosed embodiments, the interactive 3D modeling system generates and displays interactive 3D model representations that dynamically change in response to user interactions with the interactive 3D model representation. In this way, the type of proposed threat mitigation features, the numbers of proposed threat mitigation features, the parameters/dimensions of the proposed threat mitigation features, and the location of proposed threat mitigation features can all be interactively changed using the disclosed methods and systems. Therefore, using the disclosed embodiments, a dynamic analysis can be made of the effectiveness of various types, sizes, numbers and locations of proposed threat mitigation features in a single sitting and in relative real time.

As another specific illustrative example of these capabilities, FIG. 3K shows a screen shot 342 of the interactive display of the interactive 3D model representation of the existing critical asset site 350 of FIG. 3J including a second proposed threat mitigation feature 391 that is a wall segment running parallel to road 372, e.g., from north to south.

Referring to FIGS. 3H, 3J, and 3K together, as seen in FIG. 3K, unlike proposed mitigation feature 381 proposed threat mitigation feature 391 is not a full perimeter wall, but a smaller wall section that has been placed significantly closer to selected critical asset 353 than proposed threat mitigation feature 381.

Comparing FIGS. 3H and 3K, it is readily observable that the placement of proposed threat mitigation feature 391 provides more effective protection for critical asset 353 from shaded area 392 of field 370, road 372, and hillsides 373, than proposed threat mitigation feature 381. In addition, proposed threat mitigation feature 391 even protects critical asset 353 from various shaded potions 399 within critical asset site 350. However, proposed threat mitigation feature 391 does leave critical asset 353 exposed to threats in areas 393 and 394.

To address this issue, a second proposed threat mitigation feature is provided. FIG. 3L shows a screen shot 343 of the interactive display of the interactive 3D model representation of the existing critical asset site 350 of FIG. 3K including the second proposed threat mitigation feature 391 of FIG. 3K that is a wall section running in a first direction, e.g., north to south, and a third proposed threat mitigation feature 397 that is also a wall section running in a second direction, e.g., from east to west.

Comparing FIGS. 3H, 3K, and 3L it is readily observable that the placement of proposed threat mitigation features 391 and 397 provide more effective protection for critical asset 353 from shaded area 392 of field 370, road 372, hillsides 373, and other environmental features 261 than proposed threat mitigation feature 381 or 391 alone. In addition, the second and third proposed threat mitigation features 391 and 397 also provide more effective protection for critical asset 353 from threats in now shaded area 399 within critical asset site 350.

In addition, in some embodiments, cost and distance calculators are included in the disclosed methods and systems. These cost and distance calculators can then be used to compare the distances, materials, and cost of proposed mitigation features for a comparison analysis.

In the specific illustrative example shown in FIGS. 3F through 3L it is determined that the distance/length of the proposed mitigation feature 381 is twice the combined distance/length of the proposed mitigation features 391 and 397. Consequently, the cost of proposed mitigation feature 381 is approximately twice the cost of the combination of the proposed mitigation features 391 and 397. So, in this specific illustrative example, proposed mitigation feature 381 is estimated to be twice the cost of the combined proposed mitigation features 391 and 397 while providing less protection for selected critical asset 353. Therefore, using the disclosed embodiments, an owner/operator/builder of existing critical asset site 350 would have the information needed to make the most efficient and effective choice.

The discussion of FIGS. 3B through 3L illustrate but one specific example of just a few of the capabilities provided using the disclosed methods and systems. Those of skill in the art will recognize that by leveraging interactive 3D modeling systems, such as gaming engines, to generate customized interactive 3D critical asset site models, the disclosed processes and systems provide interactive visual displays of multiple potential threats, multiple potential mitigation measures, and the effectiveness of the each of the potential threat mitigation features with respect to protecting existing and future critical assets and/or critical asset sites.

Consequently, using the disclosed processes and systems, detailed analysis of numerous threats, vulnerabilities, and threat mitigation features can be interactively and dynamically visualized and analyzed from multiple perspectives for virtually any critical asset and/or location at a critical asset site; all in relative real time and all being dynamically adjusted according to the users' input.

Referring back to FIG. 3A, in one embodiment, once the interactive 3D modeling system generates and displays interactive 3D model representations that dynamically change in response to user interactions with the interactive 3D model representation at operation 321, process flow proceeds to operation 323.

In one embodiment, at operation 323 one or more mitigation features are selected by the user based, at least in part, on the visualization of the effectiveness of each of the potential threat mitigation features for protecting the existing and/or proposed critical assets at the critical asset site provided at operation 321.

In one embodiment, once one or more mitigation features are selected by the user based, at least in part, on the visualization of the effectiveness of each of the potential threat mitigation features for protecting the existing and/or proposed critical assets at the critical asset site at operation 323, process flow proceeds to operation 325.

In one embodiment, at operation 325, selected threat mitigation feature data is generated representing the type and location of the selected threat mitigation features for the existing and/or proposed critical assets at the critical asset site.

In one embodiment, once selected threat mitigation feature data is generated at operation 225, process flow proceeds to operation 327.

In one embodiment, at operation 327, a critical asset site threat mitigation implementation plan is generated incorporating the selected threat mitigation features represented by the selected threat mitigation feature data of operation 325.

In one embodiment, process 300 is then exited at END operation 331.

In one embodiment, the disclosed processes and systems for determining and mitigating threats to critical assets includes processes for determining and mitigating threats to future or proposed critical assets. These embodiments are also referred to as a “green field” embodiments.

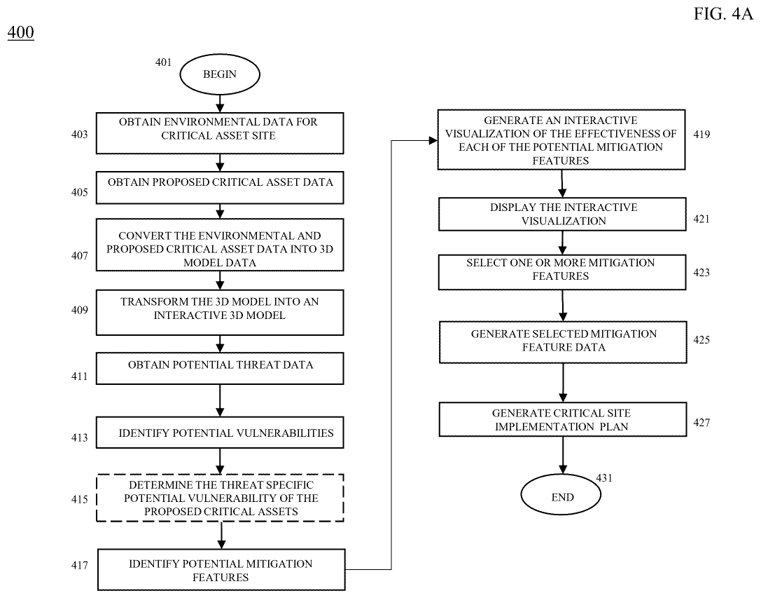

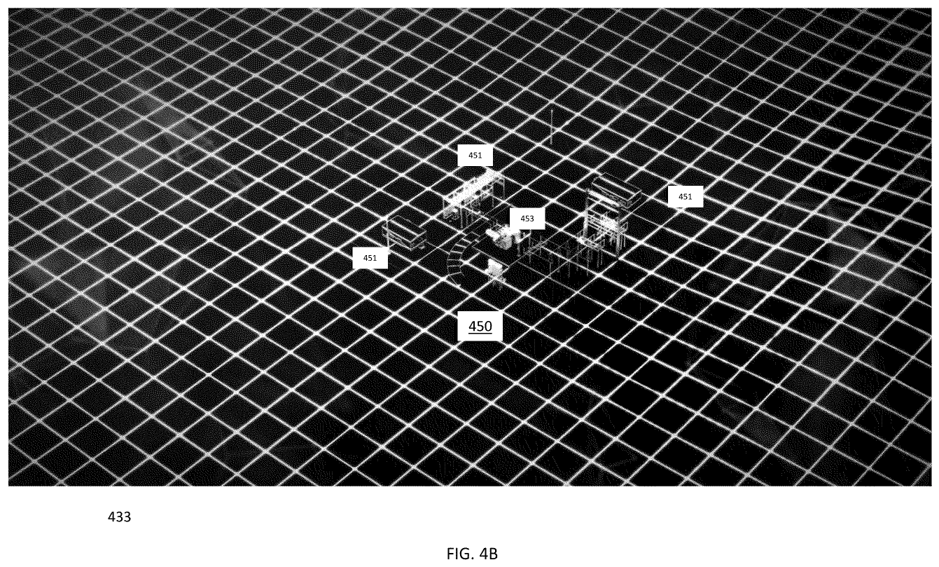

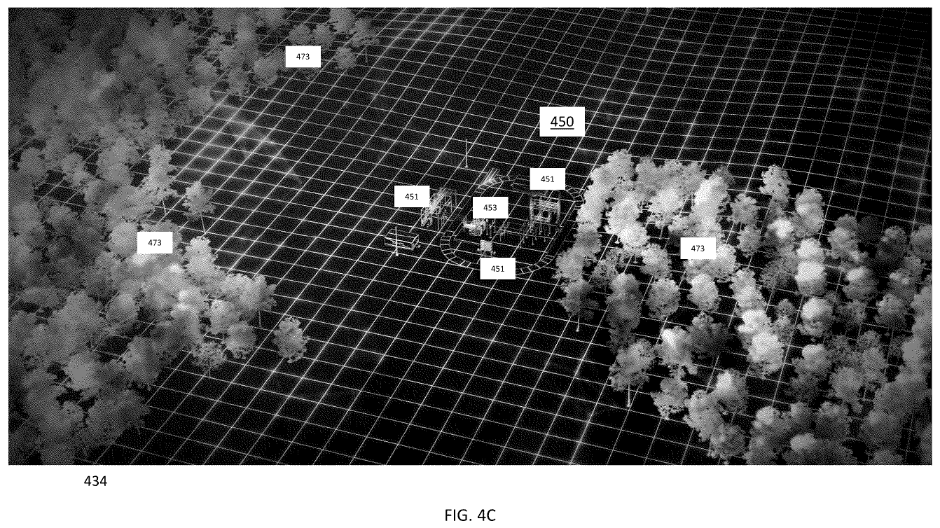

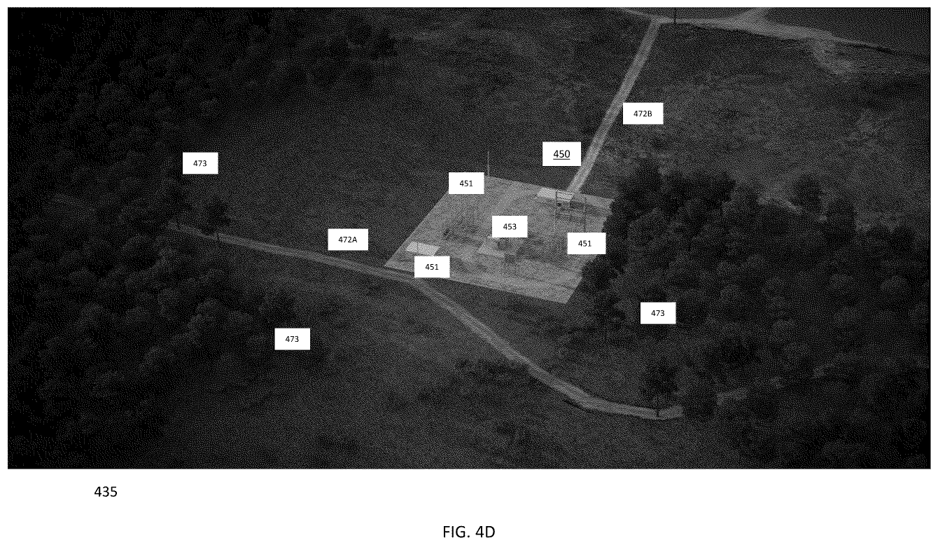

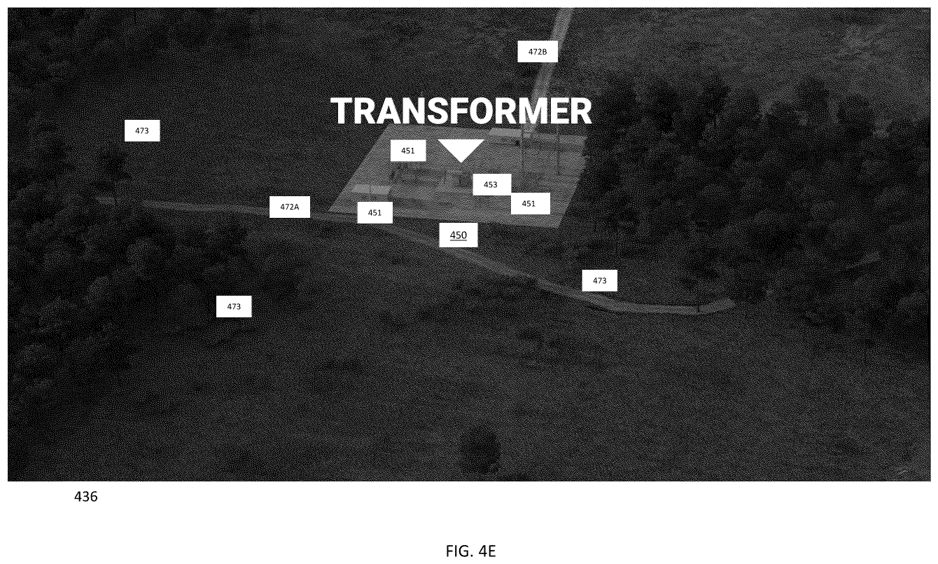

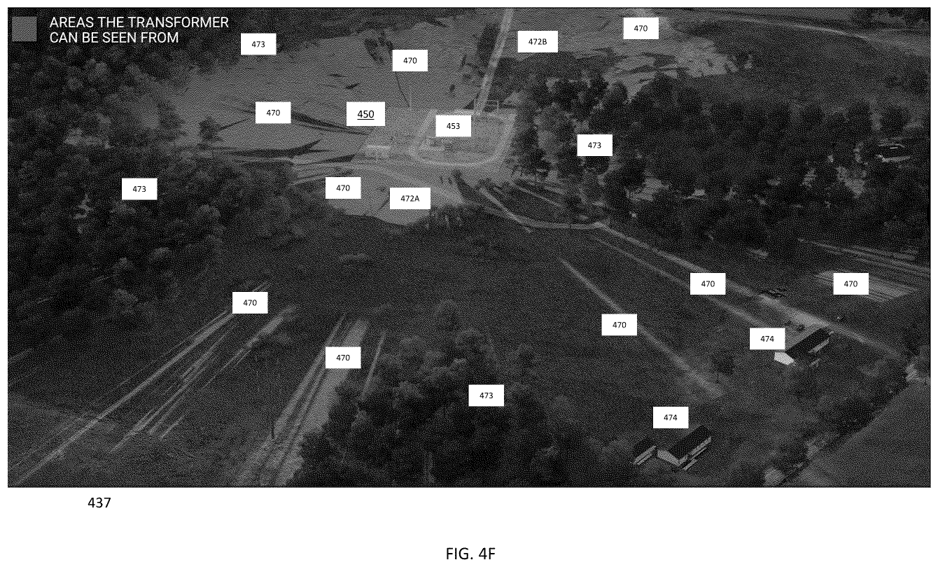

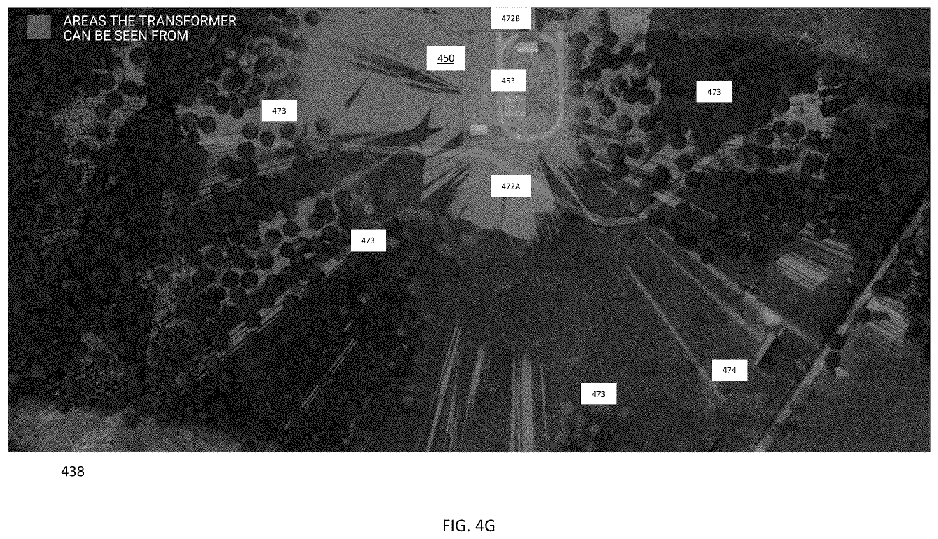

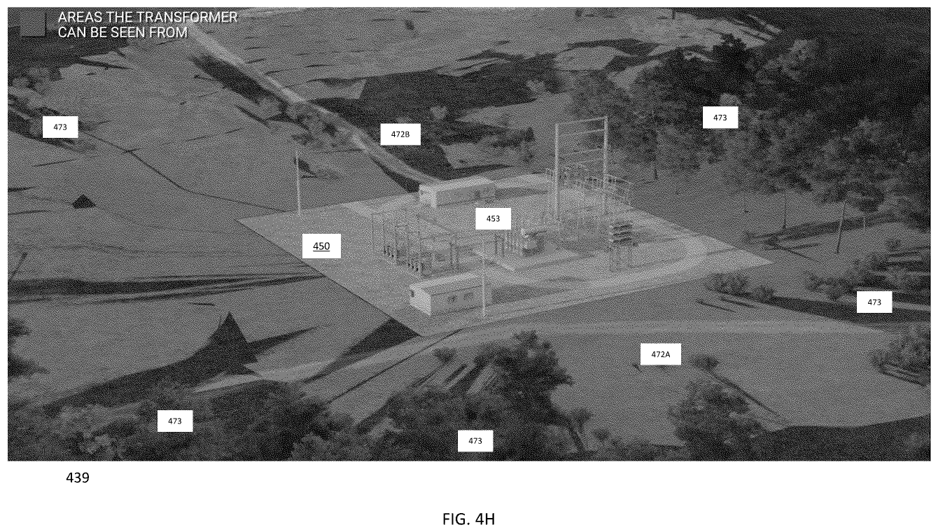

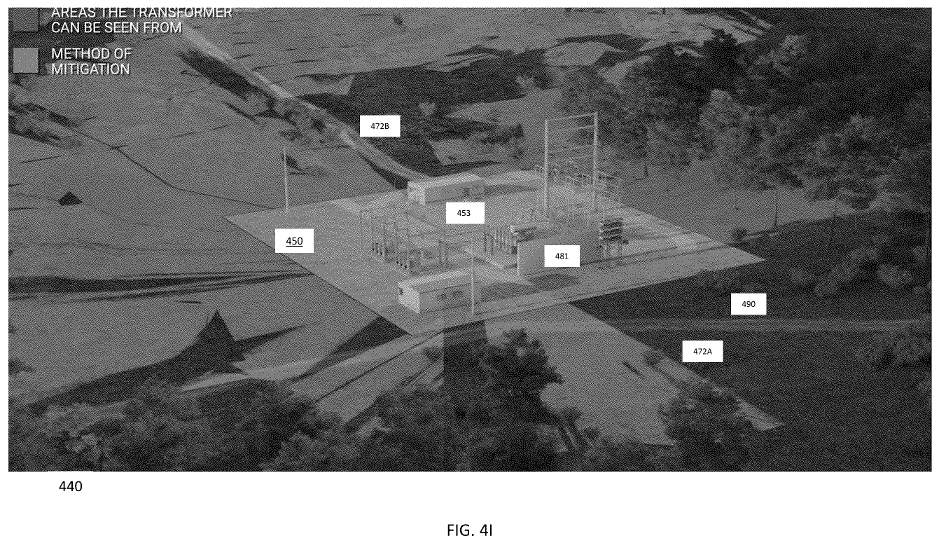

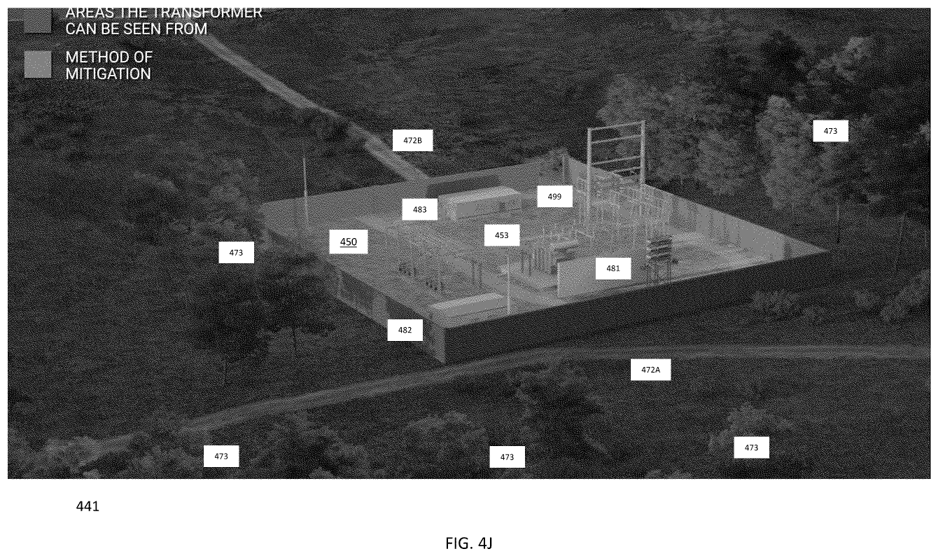

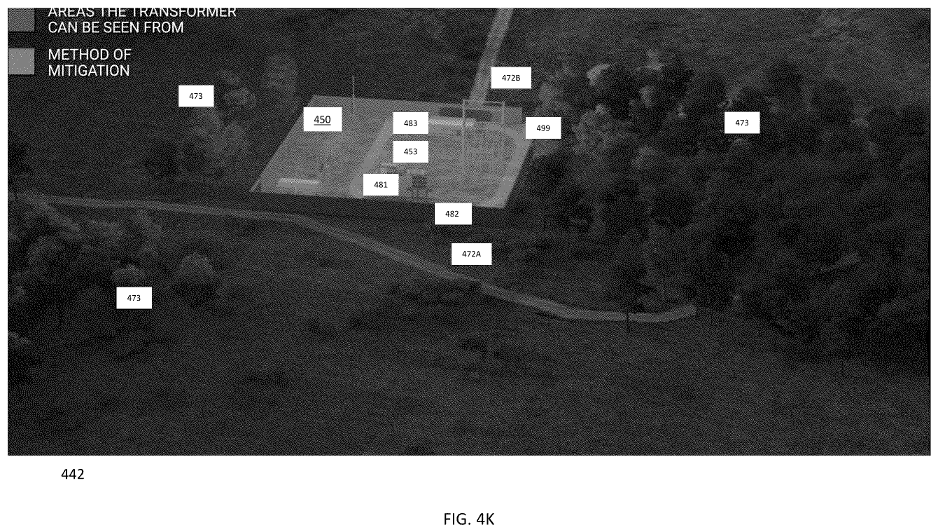

FIG. 4A is a flow chart showing some of the major operations of a process 400 for identifying and mitigating threats to proposed critical assets in accordance with one embodiment.

As seen in FIG. 4A, process 400 begins at BEGIN operation 401 and process flow proceeds to operation 403.

In various embodiments, the proposed critical asset site can be an existing or proposed critical asset site. In various embodiments, the proposed critical asset site can include, but is not limited to, power generation facilities including electrical power generation substations, wind farms, solar farms, and hydro-electric dams and facilities; military, government, and civilian communication stations and substations; port facilities and Naval stations; water production facilities including reservoirs, dams, pumping facilities and aqueducts; airports; sewage treatment sites; chemical production facilities; railways and railway stations; food storage facilities; and/or any other location/site where critical assets can be found as discussed herein and/or as known at the time of filing, and/or as developed after the time of filing.

In one embodiment, at operation 403 planned/proposed site environment data about the proposed critical asset site and existing site features and surroundings is collected. In various embodiments, the environmental data includes data representing environmental and terrain features of the critical asset site.

In one embodiment, the environmental data representing the identified environmental and terrain features can include, but is not limited to, data representing fence lines, existing or planned grading and topographical features; existing or planned hills, mounds, and other soil or rock features; existing or planned water features; existing or planned public and/or private highways, roads, trails, or paths; and/or any other environmental features as discussed herein, and/or as known in the art at the time of filing, and/or as become known or available after the time of filing.

In addition, the environmental data of operation 403 can, and most often will, include not only the proposed critical asset site but also surrounding features and land including, but not limited to, surrounding terrain, roads, buildings, developments, etc.

In various embodiments, the environmental data can be obtained in various ways including being identified by the owner operator/builder of the critical asset site, publicly or privately collected satellite and/or photographic imagery, existing critical asset site diagrams, drawings, and models, drone images, aerial LiDAR systems, terrestrial LiDAR systems, radar systems, CAD drawings, images, and models, and/or any other source of data identifying existing environmental features at a critical asset site as discussed herein, and/or as known in the art at the time of filing, and/or as become known or available after the time of filing.

In one embodiment, once the environmental data representing the identified environmental and terrain features is generated at operation 403, process flow proceeds to operation 405.

In one embodiment, at operation 405 proposed critical asset data is obtained. In one embodiment, at operation 405, the proposed critical asset data is typically obtained from CAD drawings and/or DWG files. In one embodiment, the proposed critical asset data includes data indicating fence lines and proposed critical assets, asset placements, and interconnections.

In various embodiments, the proposed critical assets of operation 405 can be, but are not limited to: electrical transformers, electrical generators, power lines, and any power production and/or transmission components; signal transmission stations and signal transmission towers; dams and aqueducts; communication stations and communication antennas; various governmental buildings; airport control towers, fueling stations, radars, and communication systems; and/or any other proposed critical assets as discussed herein, and/or as known in the art at the time of filing, and/or as become known or available after the time of filing that might be deemed subject to attack.

In some embodiments, only portions of the proposed critical assets need to be protected. Typically these are portions of the proposed critical assets that are particularly vulnerable to attack and/or that are the most critical features of the proposed critical assets.

In one embodiment, once the proposed critical asset data is obtained at operation 405, process flow proceeds to operation 407.

In one embodiment, at operation 407, the environmental data and proposed critical asset site data is provided to a 3D modeling system.

In one embodiment, at operation 407 the 3D modeling system converts the environmental data and proposed critical asset site data into 3D model data representing the critical asset site including the environmental features and the proposed critical assets.

In one embodiment, at operation 407, the 3D modeling system converts two or more types of environmental data and proposed critical asset site data from two of more collection systems into 3D model data. In various embodiments, a particular type of the environment data and proposed critical asset site data may be preferred, and used, to represent particular critical assets and environmental features while a different type of the environment data and/or proposed critical asset site data may be preferred, and used, to represent other critical assets and environmental features.

As a specific example, in one embodiment, aerial drone data might be used to represent natural environmental features while more detailed terrestrial LiDAR data might be used to represent man-made environmental features.

The 3D modeling system of operation 407 can be any 3D modeling system discussed herein, and/or as known in the art at the time of filing and/or as developed/made available after the time of filing capable of converting various types of planned/proposed site environment data and proposed critical asset site data into a 3D model of the critical asset site.

Specific examples of 3D modeling systems are any 3D modeling system available from “Autodesk” such as “3DS Max”. However, several 3D modeling systems are well known and available. Thus, the operation and use of 3D modeling systems is well known. Consequently, a more detailed discussion of any particular 3D modeling system is omitted here to avoid detracting from the invention.

FIGS. 4B through 4K show several screen shots of the development and resultant interactive display of a 3D model representation of a proposed critical asset site 450 including various proposed critical assets and structures 451 and various planned/proposed site environmental features such as roads 472A, 472B, trees and tree lines 473 as would be generated using process 400 for identifying and mitigating threats to existing critical assets in accordance with one embodiment.

In particular, FIG. 4B shows a 3D mesh representation 433 of a proposed critical asset site 450 including various proposed critical assets and structures 451. Of particular note in FIG. 4B is selected critical asset 453 which, in this particular example, is a transformer that is the subject of one example of analysis discussed below.

FIG. 4C shows a 3D mesh representation 434 of the proposed critical asset site 450 of FIG. 4B combined with planned/proposed site environmental features which, in this specific example, are shown as trees and tree lines 473.

Referring back to FIG. 4A, in one embodiment, once the planned/proposed site environment data and proposed critical asset site data is provided to a 3D modeling system and the 3D modeling system converts the planned/proposed site environment data and proposed critical asset site data into 3D model data representing the critical asset site including existing and/or proposed environmental features and the proposed critical assets at operation 407, process flow proceeds to operation 409.

In one embodiment, at operation 409 the 3D model data is provided to an interactive 3D modeling system that transforms the 3D model data into an interactive 3D model representation of the critical asset site including existing and/or proposed environmental features and the proposed critical assets.

In one embodiment, at operation 409 the 3D model data of operation 407 is first converted into a format that can be processed by the interactive 3D modeling system. In one embodiment, this conversion is accomplished using known data conversion systems such as “Datasmith Exporter” available from “Epic Games”. In other embodiments, any data conversion system capable of formatting the 3D model data of operation 407 into data usable by an interactive 3D modeling system can be used at operation 409.

Several data conversion systems are well known and available. Thus, the operation and use of data conversion systems is well known. Consequently, a more detailed discussion of any particular data conversion system is omitted here to avoid detracting from the invention.

In one embodiment, once the 3D model data of operation 407 is converted into a format that can be processed by the interactive 3D modeling system, the converted 3D model data is provided to an interactive 3D modeling system.

In one embodiment, the interactive 3D modeling system transforms the 3D model data into an interactive 3D model representation of the critical asset site including existing and/or proposed environmental features and the proposed critical assets.

In various embodiments, the interactive 3D modeling system of operation 409 can be any interactive 3D modeling system capable of transforming 3D model data, such as 3D mesh data, representing various features and structures into an interactive visualization of the structures and features represented in the 3D model data.

As a specific example, in one embodiment, the interactive 3D modeling system of operation 409 can be “Unreal Engine” available from “Epic Games”. However, several interactive 3D modeling systems are known in the art. Consequently, the basic use and operation of any specific interactive 3D modeling system is omitted here to avoid detracting from the invention.

However, as discussed in more detail below, using the disclosed embodiments, the basic interactive 3D modeling system of operation 409 is provided access to operational data specific to the field of critical asset analysis and mitigation. Using this operational data, dynamically interactive features related to the identified potential threats for a given critical asset site, the effectiveness of the identified potential threats, and the effectiveness of various threat mitigation features against the identified potential threats can be generated and displayed by the interactive 3D modeling system.

FIG. 4D shows a screen shot 435 of an interactive display of the interactive 3D model representation that would be created at operation 409 of the proposed critical asset site 450 of FIG. 4B, and 4C including the existing and/or proposed environmental features, such as roads 472A and 472B, trees and tree lines 473, and the proposed critical assets and structures 451 including selected critical asset 453.

Referring back to FIG. 4A, in one embodiment, once the 3D model data of operation 407 is provided to an interactive 3D modeling system that transforms the 3D model data into an interactive 3D model representation of the critical asset site including existing and/or proposed environmental features and the proposed critical assets at operation 409, process flow proceeds to operation 411.

In one embodiment, at operation 411 potential threats to the proposed critical assets at the critical asset site of operation 405 is obtained and processed to generate potential threat data including data representing the identified potential threats' capabilities.

In various embodiments, at operation 411 the types of threats that are considered likely potential threats for the critical asset site are identified and the data indicating the capabilities of those threats is obtained from one or more threat data sources.

In various embodiments, the types of threats most likely to be available in the area of the critical asset site can be obtained from private and public data sources including, but not limited to: intelligence from national, state, and local authorities; historical data; recent arms purchases data; known weapons systems used by potential threat groups; worst-case scenario estimates; and/or any other source of threat data discussed herein, and/or as known in the art at the time of filing, and/or as developed/made available after the time of filing that can provide data about potential threats to the critical asset site.

In various embodiments, the threat data can include, but is not limited to data indicating small arms such as rifles, pistols, and automatic weapons potentially in the area; data indicating any mortars, grenades, or rocket propelled grenades potentially in the area; data indicating anti-aircraft, anti-personnel, or anti-vehicle weapons potentially in the area; data indicating explosives such as dynamite, TNT, C4, etc. in the area; data indicating Improvised Explosive Devices (IEDs), or the capability to make IEDs, in the area; and/or any data indicating any weapons that could be used to attack the critical assets or the critical asset site as discussed herein, and/or as known in the art at the time of filing, and/or as made available after the time of filing.

In some embodiments, in the absence of specific threat data, worst-case scenario data is obtained representing the most destructive weapons systems that could be used to attack the proposed critical assets or critical asset site.

In various embodiments, at operation 411 the capabilities of the various types of threats are included in the threat data including, but not limited to, one or more of, calibers, ranges, magazine capacity, reload capacity, blast radii, etc.

In some embodiments, the threat data is stored and made available to the interactive 3D modeling system that transforms the 3D model data into an interactive 3D model representation of the critical asset site for processing various displays models. In other embodiments, at least some of the threat data is stored and/or provided outside of the interactive 3D model representation of the critical asset site.

In one embodiment, once the types of threats that are considered likely potential threats for the critical asset site are identified and the data indicating the capabilities of those threats is obtained from one or more threat data sources at operation 411, process flows to operation 413.

In one embodiment, at operation 413 potential vulnerabilities associated with the proposed critical assets at the critical asset site are identified and potential vulnerability data representing the identified potential vulnerabilities associated with the proposed critical assets at the critical asset site is generated.

In one embodiment, the potential vulnerabilities associated with the proposed critical assets at the critical asset site are identified using the interactive 3D model created by the interactive 3D modeling system. In one embodiment, this is accomplished by providing one or more virtual light/illumination sources indicating line-of-sight vulnerability. In one embodiment, one or more of these virtual light/illumination sources can be interactively placed anywhere desired within the interactive 3D model.

As discussed in more detail below, in one embodiment, the virtual light/illumination sources virtually illuminate all portions and features of the interactive 3D model of the critical asset site that can be seen and therefore potentially attacked.

Thus, in one embodiment, the virtual light/illumination sources can be placed at each of the proposed critical assets, and/or portions or features of the proposed critical assets, and/or any critical asset site or surrounding location. Then, the proposed critical assets, and/or portions or features of the proposed critical assets, and/or any critical asset site or surrounding area location illuminated by the virtual light/illumination sources are considered vulnerable to attack.

FIG. 4E shows a screen shot 436 of the interactive display of the interactive 3D model representation of the proposed critical asset site 450 of FIGS. 4B, 4C, and 4D including the existing and/or proposed environmental features, such as roads 472A and 472B, trees and tree lines 473 and the proposed critical assets and structures 451, including selected critical asset 453. FIG. 4E also includes the identification and selection of selected critical asset 453 within the interactive 3D model representation of the critical asset site for analysis.

FIG. 4F shows a screen shot 437 of the interactive display of the interactive 3D model representation of FIG. 4E that includes a perspective view of the placement of at least one virtual light/illumination source identifying the potential vulnerability of the selected critical asset 453 at the proposed critical asset site 450.

FIG. 4G shows a screen shot 438 of an interactive display of the interactive 3D model representation that includes an overhead view of the placement of at least one virtual light/illumination source identifying the potential vulnerability of the selected critical asset 453 at the proposed critical asset site 450.

FIG. 4H shows a screen shot 439 of an interactive display of the interactive 3D model representation that includes a second perspective view of the placement of at least one virtual light/illumination source identifying the potential vulnerability of the selected critical asset 453 at the proposed critical asset site 450.

As seen in FIGS. 4F, 4G, and 4H the at least one virtual light/illumination source identifies line-of-sight vulnerability of selected critical asset 453, in this example a transformer, by showing illuminated surrounding areas. In this example, any area or feature illuminated by the one or more virtual lights/illumination sources in FIGS. 4F, 4G, and 4H, including roads 472A and 472B, portions of trees and tree line 473, and portions of buildings 474 is a location where a person or other threat would have line-of-sight access to the selected critical asset 453.

In various embodiments, any number of virtual lights/illumination sources can be generated and placed at any location within the 3D model representation of a critical asset site. Consequently, line-of-sight vulnerability of any location, and any proposed critical asset, or proposed critical asset portion, desired can be visualized and analyzed. This, in turn, provides for dynamically interactive holistic analysis of the vulnerability of the entire critical asset site and any and all proposed critical assets at the critical asset site before the critical assets are actually built. This level and versatility of interactive analysis is not provided by prior art methods and systems. Clearly this level and versatility of interactive analysis provided by the disclosed embodiments has the potential to save significant time, resources, and costs.

Referring back to FIG. 4A, as discussed in more detail below, in other embodiments, avatars representing human threats can be generated to provide inward looking views with respect to the critical assets and critical asset site. These features of one embodiment are discussed below with reference to FIGS. 9A through 9H.

In other embodiments, the potential vulnerabilities associated with the proposed critical assets at the critical asset site are identified using other features of the interactive 3D model created by the interactive 3D modeling system such as varying views, angle, and perspective, and/or various vectors and vector analysis.

In one embodiment, once the potential vulnerabilities associated with the proposed critical assets at the critical asset site are identified using the interactive 3D model created by the interactive 3D modeling system at operation 413, process flow proceeds to optional operation 415.

In one embodiment, various operational data, such as the interactive 3D model threat data of operation 411, the vulnerability data of operation 413, and mitigation feature data of operation 417 discussed below are made available to the interactive 3D modeling system that transforms the 3D model data into an interactive 3D model representation of the critical asset site for processing various displays models. In other embodiments, the operational data is stored and/or provided outside of the interactive 3D model representation of the critical asset site.

In one embodiment, the operational data includes, but is not limited to, one or more of ranging data, threat ballistics data, mitigation feature data, mitigation feature cost data, and updated intelligence data regarding known and/or potential threats. In one embodiment, this operational data is used to provide dynamic relatively real time analysis of the vulnerability of the critical assets and the effectiveness of various threat mitigation features as various parameters are manipulated and changed by the user.

In one embodiment, at optional operation 415 the operational data is processed to automatically determine any threat specific potential vulnerability of the proposed critical assets at the critical asset site to the identified potential threats and to automatically generate specific potential vulnerability data representing the determined specific potential vulnerability of the proposed critical assets at the critical asset site.

In other embodiments, at optional operation 415 the threat data of operation 411 is used to automatically determine specific vulnerability of the proposed critical assets by simply automatically adjusting the range of the analysis performed to the maximum range of the threat identified having the longest range and/or greatest capabilities.

As one specific example, when at 413 virtual light/illumination sources are used to identify critical asset vulnerabilities as discussed above, at operation 415 the range of virtual illumination from the virtual light/illumination sources is automatically adjusted to the maximum range of the identified threat.

In another example, when avatars representing human threats are generated to provide inward looking views with respect to the critical assets and critical asset site, the avatars can only be placed at the maximum range of the identified threat.

In one embodiment, once the interactive 3D model is provided access to various operational data, such as the threat data of operation 411 and the vulnerability data of operation 413 and this operational data is automatically processed to determine any threat specific potential vulnerability of the proposed critical assets at the critical asset site at optional operation 415, process flow proceeds to operation 417.

In one embodiment, at operation 417, various threat mitigation features that can potentially be used to protect the proposed critical assets and critical asset site are identified and mitigation feature data indicating parameters associated with those mitigation features is obtained and/or generated.

In one embodiment, the mitigation features can include, but are not limited to, one or more of: physical wall portions of various types, shapes, materials, widths, lengths, and heights; full screening perimeter walls of various types, shapes materials, widths, lengths, and heights; firewalls of various types, shapes, materials, widths, lengths, and heights; ballistic plating of various types, shapes, materials, widths, lengths, and heights; Kevlar or other bullet proof curtains of various types, shapes, widths, lengths, and heights; landscape environmental screening features of various types, shapes, materials, widths, lengths, and heights; visual detection systems of various types such as cameras; radar detection systems of various types; infrared detection systems of various types; equipment placement/relocations; and/or any other mitigation features capable of protecting the identified critical assets from various types of threats as discussed herein; and/or as known/available in the art at the time of filing, and/or as developed/made available after the time of filing.

In one embodiment, mitigation feature data representing the various threat mitigation features and parameters is generated at operation 417. As noted above, various operational data, such as the interactive 3D model threat data of operation 411, the vulnerability data of operation 413, and mitigation feature data of operation 417 are made available to the interactive 3D modeling system that transforms the 3D model data into an interactive 3D model representation of the critical asset site for processing various displays models. In other embodiments, the operational data is stored and/or provided outside of the interactive 3D model representation of the critical asset site.

As noted above, and discussed in more detail below, in one embodiment, the operational data, including the mitigation feature data, is used to provide dynamic relatively real time analysis of the vulnerability of the proposed critical assets and the effectiveness of various threat mitigation features as various parameters are manipulated and changed by the user.

In one embodiment, once the mitigation feature data representing the various threat mitigation features and parameters is generated at operation 417, process flow proceeds to operation 419.

In one embodiment, at operation 419, the interactive 3D modeling system that transforms the 3D model data into an interactive 3D model representation of the critical asset site of operation 409 processes the threat data of operation 411, the vulnerability data of operation 413 and/or the threat specific potential vulnerability data of operation 415, and the potential threat mitigation feature data of operation 417 to generate interactive visualization displays of the effectiveness of the potential threats to the proposed critical assets and/or critical asset site, the potential vulnerability of the proposed critical assets and/or critical asset site, and the effectiveness of the potential threat mitigation features for protecting the proposed critical assets and critical asset site.

In one embodiment, once the interactive 3D modeling system generates the interactive visualization displays of the effectiveness of the potential threats to the proposed critical assets and/or critical asset site, the potential vulnerability of the proposed critical assets and/or critical asset site, and the effectiveness of the potential threat mitigation features for protecting the proposed critical assets and critical asset site at operation 419, process flow proceeds to operation 421.

In one embodiment, at operation 421, the interactive 3D modeling system generates and displays interactive 3D model representations that dynamically change in response to user interactions with the interactive 3D model representation.

In one embodiment, at operation 421, the user can interact with the interactive 3D model representation using any one of various interface devices such as a touch screen, mouse, etc. In this way the user can change potential threats, potential ranges, and potential threat mitigation features and parameters. Then, in response to these changed input parameters, the interactive 3D model representation modifies the interactive 3D model displays to indicate the threat, the vulnerabilities to that threat for the critical assets, and the effectiveness of various threat mitigation features with respect to the threat; all in relative real time and all being dynamically adjusted according to the users' input.

In this way, the interactive visualization of the effectiveness of each of the potential threat mitigation features for protecting the proposed critical assets at the critical asset site within the interactive 3D model representation of the critical asset site using the interactive 3D modeling system is presented in a seamless series of dynamically adjustable displays.

As noted, in one embodiment, at operation 421, the user can interact with the interactive 3D model representation using any one of various interface devices such as a touch screen, mouse, etc. In this way the user can change potential threat mitigation features and parameters. Then, in response to these changed input parameters, the interactive 3D model representation modifies the interactive 3D model display to indicate the remaining vulnerabilities to the threat for each critical asset, and the effectiveness of various threat mitigation features with respect to the threat; all in relative real time and all being dynamically adjusted.

FIG. 4I is a screen shot 440 of the interactive display of the interactive 3D model representation of the proposed critical asset site 450 of FIGS. 4F through 4H including a zoomed in perspective view of the potential vulnerability of the selected critical asset 453 at the proposed critical asset site 450 when a first proposed threat mitigation feature 481 is virtually implemented.

In FIG. 4I the first proposed threat mitigation feature 481 can be a firewall, a Kevlar structure, a wall, etc. In this specific illustrative example, first proposed threat mitigation feature 481 is designed to provide protection for selected critical asset 453 from threats in area 490 and a portion of road 472A.

Referring to FIGS. 4H and 4I together, as seen in FIG. 4I, using the disclosed process, first proposed threat mitigation feature 481 has been virtually inserted into the proposed critical asset site 450 interactive 3D model. As can also be seen in FIG. 4I, first proposed threat mitigation feature 481 creates shaded area 490 where there is now no illumination from the one or more virtual lights/illumination sources. Consequently, in this specific illustrative example, first proposed threat mitigation feature 481 is designed to provide protection for selected critical asset 453 from threats in area 490 and portions of road 472A.

In various embodiments, the user can interact with the interactive 3D model representations to view all aspects of the interactive 3D model representations from any perspective, angle, and/or distance desired.

For instance, in one example the user may wish to view the interactive 3D model representation, including critical assets, virtual lights/illumination sources, and the critical asset site from the perspective of a person looking into the critical asset site. Using the disclosed embodiments this can be achieved by simply using an interface device to change the perspective view and/or viewpoint.

Again, in accordance with the disclosed embodiments, the interactive 3D modeling system generates and displays interactive 3D model representations that dynamically change in response to user interactions with the interactive 3D model representation. In this way the type of proposed threat mitigation features, the numbers of proposed threat mitigation features, the parameters/dimensions of the proposed threat mitigation features, and the location of proposed threat mitigation features can all be interactively changed using the disclosed methods and systems. Therefore, using the disclosed embodiments, a dynamic analysis can be made of the effectiveness of various types, sizes, numbers and locations of proposed threat mitigation features in a single sitting and in relative real time.

FIGS. 4J and 4K show screen shots 441 and 442, respectively, of the interactive display of the interactive 3D model representation of the proposed critical asset site 450 of FIGS. 4F through 4I including a perspective view of the potential vulnerability of the selected critical asset 453 at the proposed critical asset site 450 after a second proposed threat mitigation feature 482 is added to first proposed threat mitigation feature 481.

As seen in FIGS. 4J and 4K, in this example, second proposed threat mitigation feature 482 is a perimeter wall surrounding most of proposed critical asset site 450.

Referring to FIGS. 4H, 4I, 4J, and 4K together, and comparing FIG. 4H with 4J, and 4K in particular, as seen in FIGS. 4J and 4K, with first proposed threat mitigation feature 481 the selected critical asset 453 is provided extra protection from threats on, or near, road 472A by virtue of second proposed threat mitigation feature 482. As also seen in FIGS. 4J and 4K, the selected critical asset 453 is provided extra protection from threats on, or near, road 472B by virtue of structure 483. Then, with the addition of second proposed threat mitigation feature 482 the entire critical asset site is protected from almost all ground level threats outside the perimeter formed by second proposed threat mitigation feature 482. Consequently, in this specific illustrative example, only site entrance 499 and the tree lines 473 above the height of second proposed mitigation feature 482 are vulnerable.

The above discussion of FIGS. 4B through 4K illustrate but one specific example of just a few of the capabilities provided using the disclosed methods and systems. Those of skill in the art will recognize that by leveraging interactive 3D modeling systems, such as gaming engines, to generate customized interactive 3D critical asset site models, the disclosed processes and systems provide interactive visual displays of multiple potential threats, multiple potential mitigation measures, and the effectiveness of each of the potential threat mitigation features with respect to protecting future critical assets and/or critical asset sites.

Consequently, using the disclosed processes and systems, detailed analysis of numerous threats, vulnerabilities, and threat mitigation features can be interactively and dynamically visualized and analyzed from multiple perspectives for virtually any critical asset and/or location at a critical asset site; all in relative real time and all being dynamically adjusted according to the users' input.

Returning back to FIG. 4A, in one embodiment, once the interactive 3D modeling system generates and displays interactive 3D model representations that dynamically change in response to user interactions with the interactive 3D model representation at operation 421, process flow proceeds to operation 423.

In one embodiment, at operation 423 one or more mitigation features are selected by the user based, at least in part, on the visualization of the effectiveness of each of the potential threat mitigation features for protecting the proposed critical assets at the critical asset site.

In one embodiment, once one or more mitigation features are selected by the user based, at least in part, on the visualization of the effectiveness of each of the potential threat mitigation features for protecting the proposed critical assets at the critical asset site at operation 423, process flow proceeds to operation 425.

In one embodiment, at operation 425, selected threat mitigation feature data is generated representing the type and location of the selected threat mitigation features for the proposed critical assets at the critical asset site.

In one embodiment, once selected threat mitigation feature data is generated at operation 425, process flow proceeds to operation 427.

In one embodiment, at operation 427, a critical asset site implementation plan is generated incorporating the selected threat mitigation features represented by the selected threat mitigation feature data of operation 425.

In one embodiment, process 400 is exited at END operation 431.

As discussed above, the disclosed processes for determining and mitigating threats to critical assets allows for the creation of highly detailed 3D modeling of both existing and proposed critical assets, their sites, and the surrounding areas. These 3D models are fully interactive with threat analysis and mitigation parameters that can be varied in relative real time to provide numerous options and configurations in a single sitting.

In addition, the disclosed processes for determining and mitigating threats to critical assets provide for analysis of numerous kinds of threats and numerous weapons so that the resultant plan can be modified to adapt to evolving threats.

In addition, in one embodiment the disclosed processes for determining and mitigating threats to critical assets provide rough cost calculations so that the owner/operator/builder of the critical assets can do rough cost comparisons of mitigation features while, at the same time, seeing the effectiveness of those features from virtually any position.

Consequently, the disclosed processes for determining and mitigating threats to critical assets provide a solution to the long standing technical problem of providing critical asset threat and mitigation analysis that is efficient, effective, and holistic and that provides for interactive and relative real time analysis of potential threats and mitigation measures with respect to existing and future critical assets to generate cost effective and efficient threat mitigation solutions for the existing and future critical assets.

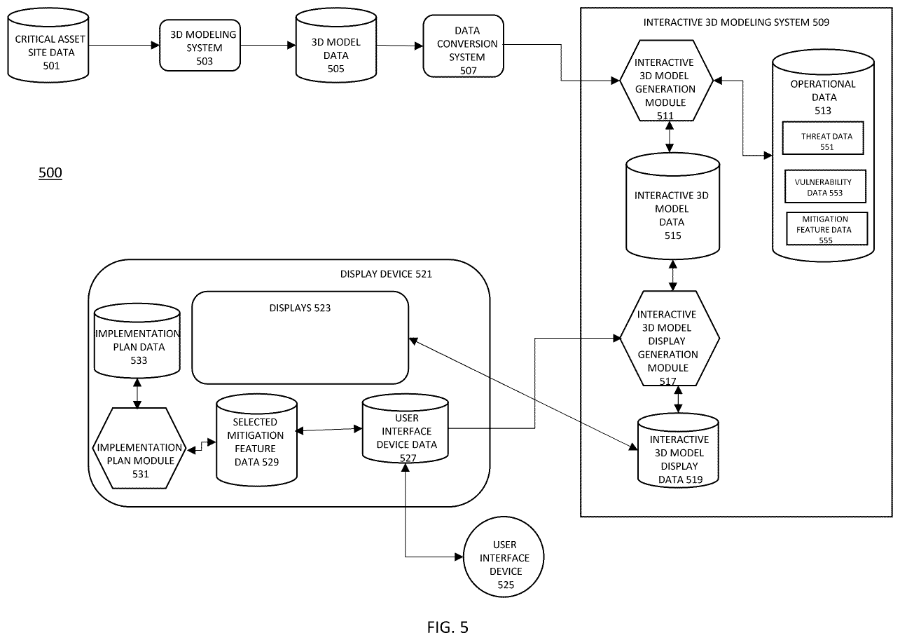

FIG. 5A is a high-level block diagram of one example of a system 500 for identifying and mitigating threats to critical assets in accordance with one embodiment.

The high-level block diagram of system 500 shown in FIG. 5 is a generalized block diagram that can represent a system for identifying and mitigating threats to existing critical assets, a system for identifying and mitigating threats to proposed critical assets, and/or a hybrid system for identifying and mitigating threats to existing and proposed critical assets.

In addition, system 500 shown in FIG. 5 can be used to implement any of the processes disclosed herein.

As seen in FIG. 5, process 500 includes a critical asset source or database that includes critical asset site data 501.

In various embodiments, critical asset site data 501 includes data representing existing and/or proposed critical assets and existing or proposed environmental features for a critical asset site.

In various embodiments, the critical asset sites represented in critical asset site data 501 can be existing and/or proposed critical asset sites, such as, but not limited to, power generation facilities including electrical power generation substations, wind farms, solar farms, and hydro-electric dams and facilities; military, government, and civilian communication stations and substations; port facilities and Naval stations; water production facilities including reservoirs, dams, pumping facilities and aqueducts; airports; sewage treatment sites; chemical production facilities; railways and railway stations; food storage facilities; and/or any other site where critical assets can be found as discussed herein and/or as known at the time of filing, and/or as developed after the time of filing.

In addition, the critical asset sites represented in critical asset data 501 can, and most often will, include not only the actual or proposed critical asset site but also surrounding features and land including, but not limited to, surrounding terrain, roads, buildings, developments, etc.

In various embodiments, the critical assets represented in critical asset site data 501 can be existing critical assets and/or proposed critical assets. In various embodiments, the environmental features represented in critical asset site data 501 can be existing environmental features and/or proposed environmental features.

In various embodiments, the critical assets represented in critical asset site data 501 can be, but are not limited to: electrical transformers, electrical generators, power lines, and any power production and/or transmission components; signal transmission stations and signal transmission towers; dams, aqueducts, and control towers; communication stations and communication antennas; various governmental buildings; airport control towers, fueling stations, radars, and communication systems; and/or any other critical assets as discussed herein, and/or as known in the art at the time of filing, and/or as become known or available after the time of filing that are deemed subject to attack.

In various embodiments, the environmental features represented in critical asset site data 501 can be, but are not limited to: existing or planned grading and topographical features; existing or planned hills, mounds, and other soil or rock features; existing or planned water features; existing or planned public and/or private highways, roads, trails, or paths; and/or any other environmental features as discussed herein, and/or as known in the art at the time of filing, and/or as become known or available after the time of filing.

In various embodiments, the critical assets and/or environmental features represented in critical asset site data 501 can be collected or obtained in various ways including being identified by the owner operator/builder of the critical asset site, publicly or privately collected satellite and/or photographic imagery, existing or proposed critical asset site diagrams, drawings, and models, drone images, aerial LiDAR systems, terrestrial LiDAR systems, radar systems, CAD drawings images and models, and/or any other source for identifying existing and/or proposed critical assets and/or environmental features at a critical asset site as discussed herein, and/or as known in the art at the time of filing, and/or as become known or available after the time of filing.

In some embodiments, only portions of the critical assets represented in critical asset site data 501 need to be protected. Typically these are portions of the critical assets that are particularly vulnerable to attack and/or that are the most critical feature of the critical assets.

In one embodiment, once critical asset data 501 representing the identified existing and/or proposed environmental features and existing and/or proposed critical assets is collected or otherwise obtained using one or more of the data collection systems discussed above, critical asset site data 501 is provided to a 3D modeling system 503.

In one embodiment, 3D modeling system 503 converts critical asset site data 501 into 3D model data 505 representing the critical asset site including the existing and/or proposed environmental features and the existing and/or proposed critical assets.

In one embodiment, 3D modeling system 503 converts two or more types of critical asset site data 501 from two of more collection systems into 3D model data 505. In various embodiments, a particular type of critical asset site data 501 may be preferred, and used, to represent particular critical assets and environmental features while a different type of critical asset site data 501 may be preferred, and used, to represent other critical assets and environmental features.

As a specific example, in one embodiment, aerial drone data might be used to represent environmental features while more detailed terrestrial LiDAR data might be used to represent critical assets and/or specific critical asset features such as transformers. In this specific example, 3D modeling system 503 could use the aerial drone data as the base data and then terrestrial LiDAR data could be inserted into the model to represent the transformers at the critical asset site. In this way the desired detail for the critical asset can be relatively seamlessly provided in the 3D model data 505.

3D modeling system 503 can be any 3D modeling system discussed herein, and/or as known in the art at the time of filing, and/or as developed/made available after the time of filing capable of converting various types of critical asset site data 501 into a 3D model data 505 of the critical asset site.

One specific example of a 3D modeling system is any of the 3D modeling systems available from “Autodesk” such as “3DS Max”. However, several 3D modeling systems are well known and available. Thus, the operation and use of 3D modeling systems is well known. Consequently, a more detailed discussion of any particular 3D modeling system 503 is omitted here to avoid detracting from the invention.

In one embodiment, once the critical asset site data 501 is provided to 3D modeling system 503 and 3D modeling system 503 converts the critical asset site data 501 into 3D model data 505 representing the critical asset site including existing and/or proposed environmental features and the existing and/or proposed critical assets, the 3D model data 505 is provided to interactive 3D model generation module 511 of interactive 3D modeling system 509.

In one embodiment, before the 3D model data 505 is provided to interactive 3D modeling system 509, the 3D model data 505 is provided to data conversion system 507. In one embodiment, data conversion system 507 converts 3D model data 505 into a format that can be processed by interactive 3D modeling system 509.

In one embodiment, data conversion system 507 can be any known data conversion system such as “Datasmith Exporter” available from “Epic Games”. In other embodiments, any data conversion system capable of formatting the 3D modeling data, such as wire mesh data, into 3D model data usable by interactive 3D modeling system 509 can be used.

Several data conversion systems are well known and available. Thus, the operation and use of data conversion systems is well known. Consequently, a more detailed discussion of any particular data conversion system 507 is omitted here to avoid detracting from the invention.

In one embodiment, interactive 3D modeling system 509 transforms the 3D model data 505 into an interactive 3D model representation of the critical asset site including the existing and/or proposed environmental features and the existing and/or proposed critical assets.

In various embodiments, interactive 3D modeling system 509 can be any interactive 3D modeling system capable of transforming 3D model data 505, such as 3D mesh data, representing various features and structures into an interactive visualization of the structures and features represented in the 3D model data 505.

As a specific example, in one embodiment, interactive 3D modeling system 509 can be “Unreal Engine” available from “Epic Games”. However, several interactive 3D modeling systems are known in the art. Consequently, the basic use and operation of any specific interactive 3D modeling system 509 is omitted here to avoid detracting from the invention.

However, using the disclosed embodiments, interactive 3D modeling system 509 is provided access to operational data 513 specific to the field of critical asset analysis and mitigation. Operational data 513 is then used to provide dynamically interactive features related to potential threats for a given critical asset site, potential vulnerabilities of the critical assets and critical asset site, and the effectiveness of various threat mitigation features against the potential threats.

As seen in FIG. 5, in one embodiment, operational data 513 can include, but is not limited to, potential threat data 551, potential vulnerability data 553, and threat mitigation feature data 555.

In various embodiments, potential threat data 551 can include data indicating the types of threats most likely to be available in the area of the critical asset site and can be obtained from private and public data sources including, but not limited to: intelligence from national, state, and local authorities; historical data; recent arms purchases data; known weapons systems used by potential threat groups, worst-case scenario estimates, and/or any other source of threat data discussed herein, and/or as known in the art at the time of filing, and/or as developed/made available after the time of filing that can provide data about potential threats to the critical asset site.

In various embodiments, potential threat data 551 can include, but is not limited to, data indicating small arms such as rifles, pistols, and automatic weapons potentially in the area; data indicating any mortars, grenades, or rocket propelled grenades potentially in the area; data indicating anti-aircraft, anti-personnel, or anti-vehicle weapons potentially in the area; data indicating explosives such as dynamite, TNT, C4, etc. in the area; data indicating Improvised Explosive Devices (IEDs), or the capability to make IEDs, in the area; and/or data indicating any weapons that could be used to attack the critical assets or critical asset site as discussed herein, and/or as known in the art at the time of filing, and/or as made available after the time of filing.

In some embodiments, in the absence of specific threat data, potential threat data 551 can include worst-case scenario data representing the most destructive weapons that could be used to attack the critical assets or critical asset site.

In various embodiments, potential threat data 551 can include data representing the capabilities of the various types of threats including, but not limited to, one or more of, calibers, ranges, magazine capacity, reload capacity, blast radii, etc.

As discussed below, in operation, in one embodiment, vulnerability data 553 of operational data 513 includes data for generating virtual light/illumination sources indicating line-of-sight vulnerability of critical assets and the critical asset sight.

In one embodiment, mitigation feature data 555 of operational data 513 includes data representing various threat mitigation features that can potentially be used to protect the critical assets and critical asset site and various parameters associated with those mitigation features.

In various embodiments, the mitigation features represented in mitigation feature data 555 can include, but are not limited to, one or more of: physical wall portions of various types, shapes, materials, widths, lengths, and heights; full screening perimeter walls of various types, shapes materials, widths, lengths, and heights; firewalls of various types, shapes, materials, widths, lengths, and heights; ballistic plating of various types, shapes, materials, widths, lengths, and heights; Kevlar or other bullet proof curtains of various types, shapes, widths, lengths, and heights; landscape environmental screening features of various types, shapes, materials, widths, lengths, and heights; visual detection systems of various types such as cameras; radar detection systems of various types; infrared detection systems of various types; equipment placement/relocations; and/or any other mitigation features capable of protecting the identified critical assets from various types of threats as discussed herein; and/or as known/available in the art at the time of filing, and/or as developed/made available after the time of filing.

As discussed below, in various embodiments, operational data 513 includes, but is not limited to, one or more of ranging data, threat ballistics data, mitigation feature data, mitigation feature cost data, updated intelligence data, visual monitoring mitigation feature data, radar mitigation feature data, and data regarding known and/or potential threats. In one embodiment, this operational data is used to provide dynamic relatively real time analysis of the vulnerability of the critical assets and the effectiveness of various threat mitigation features as various parameters are manipulated and changed by the user.

In one embodiment, interactive 3D modeling system 509 includes interactive 3D model generation module 511 that uses one or more processors (not shown) and operational data 513 to convert 3D model data 505 and operational data 513 into interactive 3D model data 515 representing an interactive 3D model representation of the critical asset site including existing and/or proposed environmental features and the existing and/or proposed critical assets.

In one embodiment, interactive 3D modeling system 509 includes interactive 3D model display generation module 517. In one embodiment, interactive 3D model display generation module 517 receives interactive 3D model data 515 and uses one or more processors and interactive 3D model data 515 to generate interactive 3D model display data 519.

In one embodiment, interactive 3D model display data 519 is used to generate dynamically interactive displays 523 that are displayed on display device 521.

In one embodiment, user interface device 525 is used to interact with the dynamically interactive displays 523 that are displayed on display device 521. In various embodiments, user interface device 525 can be a mouse, a touch screen, a keyboard, voice recognition, or any other user interface device/mechanism capable of allowing a user to interact with dynamically interactive displays 523 and/or display device 521.

In one embodiment, as the user manipulates user interface device 525 and dynamically interactive displays 523, user interface device data 527 is generated. User interface device data 527 is then provided to interactive 3D model display generation module 517 to modify interactive 3D model display data 519 and dynamically interactive displays 523 in accordance with the user interaction.

As noted above, in operation, in one embodiment, vulnerability data 553 of operational data 513 includes data for generating virtual light/illumination sources indicating line-of-sight vulnerability of critical assets and the critical asset sight.

In one embodiment, the potential vulnerabilities are determined using one or more these virtual light/illumination sources that can be interactively placed anywhere desired within the interactive 3D model using user interface device 525. Consequently, the virtual light/illumination sources can be interactively placed at, on, or in any existing or proposed critical asset or environmental feature in the interactive 3D model generated by interactive 3D modeling system 509.

As discussed in more detail above, in one embodiment, the virtual light/illumination sources virtually illuminate all portions and features of the interactive 3D model of the critical asset site that can be seen, and potentially attacked, from the location of the virtual light/illumination sources.

Thus, in one embodiment, the virtual light/illumination sources can be placed at each of the critical assets, and/or portion or feature of the critical assets, and/or any location within critical asset site or surrounding area. Then, the critical assets, and/or portion or feature of the critical assets, and/or any location within critical asset site illuminated by the virtual light/illumination sources is considered vulnerable to attack.

In other embodiments, avatars representing human threats can be generated to provide inward looking views with respect to the critical assets and critical asset site. This feature is discussed below with respect to FIGS. 9A through 9H.

In other embodiments, the potential vulnerabilities associated with the existing and/or proposed critical assets at the critical asset site are identified using other features of the interactive 3D model created by interactive 3D modeling system 509 such as varying views and perspective and/or various vectors and vector analysis.

In one embodiment, operational data 513 includes, but is not limited to, one or more of ranging data, threat ballistics data, mitigation feature data, mitigation feature cost data, updated intelligence data, visual monitoring mitigation feature data, radar mitigation feature data, and data regarding known and/or potential threats. In one embodiment, this operational data is used to provide dynamic relatively real time analysis of the vulnerability of the critical assets and the effectiveness of various threat mitigation features as various parameters are manipulated and changed by the user.

In one embodiment, operational data 513 is automatically processed to determine any threat specific potential vulnerability of the existing and/or proposed critical assets at the critical asset site to the identified potential threats and generating specific potential vulnerability data representing the determined threat specific potential vulnerability of the existing and/or proposed critical assets at the critical asset site.

In other embodiments, the threat data of operational data 513 is used to determine specific vulnerability of the critical assets by simply adjusting the range of the analysis performed to the maximum range of the threat identified having the longest range and/or greatest capabilities.

As one specific example, when virtual light/illumination sources are used to identify critical asset vulnerabilities as discussed above the range of virtual illumination of the virtual light/illumination sources can be adjusted to the maximum range of the identified threat. In another example, when avatars representing human threats are generated to provide inward looking views with respect to the critical assets and critical asset site, the avatars are placed at the maximum range of the identified threat.

In one embodiment, mitigation feature data 555 of operational data 513 is used by interactive 3D modeling system 509 to provide relatively real time interactive and dynamic analysis of the vulnerability of the critical assets and the effectiveness of various threat mitigation features as various parameters/operational data are manipulated and changed by the user.

In one embodiment, interactive 3D model generation module 511 of interactive 3D modeling system 509 processes the threat data 551, the vulnerability data 553, and the mitigation feature data 555 of operational data 513 to generate an interactive visualization display 523 of the effectiveness of the potential threats to the critical assets and/or critical asset site, the potential vulnerability of the critical assets and/or critical asset site, and the effectiveness of the potential threat mitigation features for protecting the existing and/or proposed critical assets and critical asset site.

As noted, in one embodiment, the interactive 3D model display generation module 517 of interactive 3D modeling system 509 generates and displays interactive 3D model displays 523 that dynamically change in response to user interactions.

As also noted above, in one embodiment, the user can interact with the interactive 3D model displays 523 using user interface device 525. In this way the user can change potential threats, potential ranges, and potential threat mitigation features and parameters. Then in response to these changed input parameters, the interactive 3D modeling system 509 modifies the interactive 3D model displays 523 to indicate the threat, the vulnerabilities to that threat for each critical asset, and the effectiveness of various threat mitigation features and parameters with respect to the threat; all in relative real time and all being dynamically adjusted according to the user's input.

In this way, the interactive visualization of the effectiveness of each of the potential threat mitigation features for protecting the existing and/or proposed critical assets at the critical asset site within the interactive 3D model representation of the critical asset site generated by interactive 3D modeling system 509 is presented in a seamlessly modified series of dynamically adjustable displays 523.

In one embodiment, one or more mitigation features are selected by the user through the user interface device 525 based, at least in part, on the visualization of the effectiveness of each of the potential threat mitigation features for protecting the existing and/or proposed critical assets at the critical asset site.

In one embodiment, the selected feature choices are recorded as selected threat mitigation feature data 529. In one embodiment, selected threat mitigation feature data 529 represents the various parameters such as height, thickness and length of the selected threat mitigation feature, as well as type, shape, and location of the selected threat mitigation features.

In one embodiment, selected threat mitigation feature data 529 is provided to implementation plan module 531 which generates implementation plan data 533 incorporating the selected threat mitigation features represented by the selected threat mitigation feature data 529.

As discussed above, using the disclosed processes and systems a user can interact with the interactive 3D model representation of a critical asset site using any one of various interface devices such as a touch screen, mouse, etc. In this way the user can change potential threats, potential ranges, potential threat mitigation features and various other operational parameters.

Then, in response to these changed input parameters, the interactive 3D model representation modifies the interactive 3D model display to indicate one or more of the new threat, the vulnerabilities to a threat for the critical assets, and the effectiveness of various threat mitigation features and parameters with respect to the threat; all in relative real time and all being dynamically adjusted according to the user's input.

In this way, an interactive visualization of the effectiveness of the potential threat mitigation features for protecting the existing and/or proposed critical assets at the critical asset site within the interactive 3D model representation of the critical asset site is presented in a series of seamlessly modified dynamically adjustable displays.

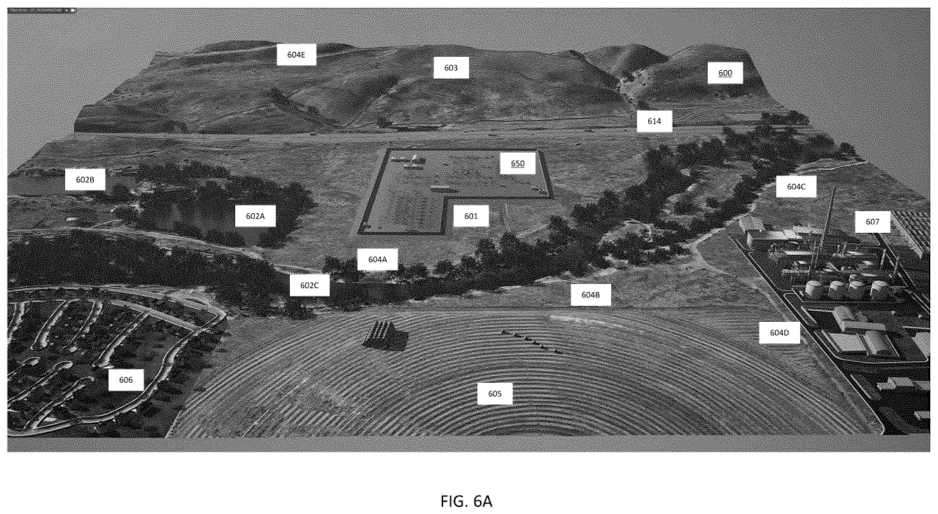

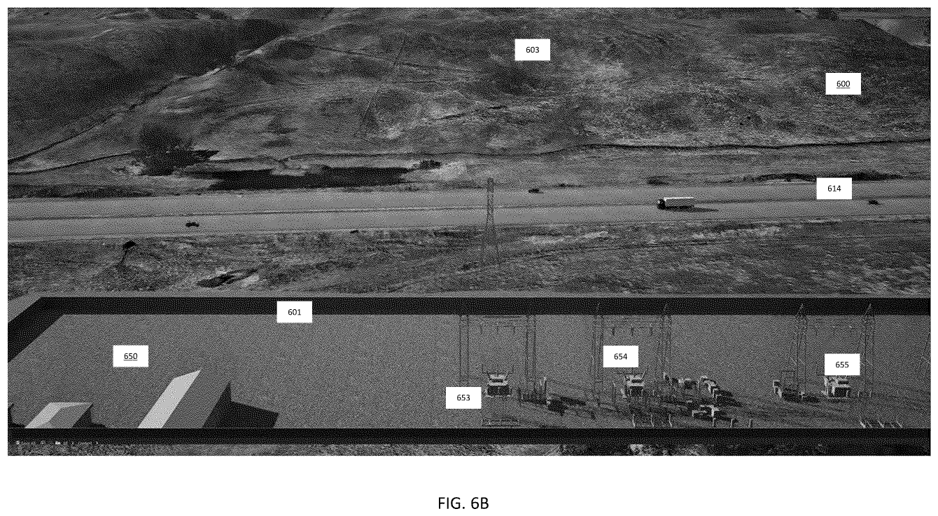

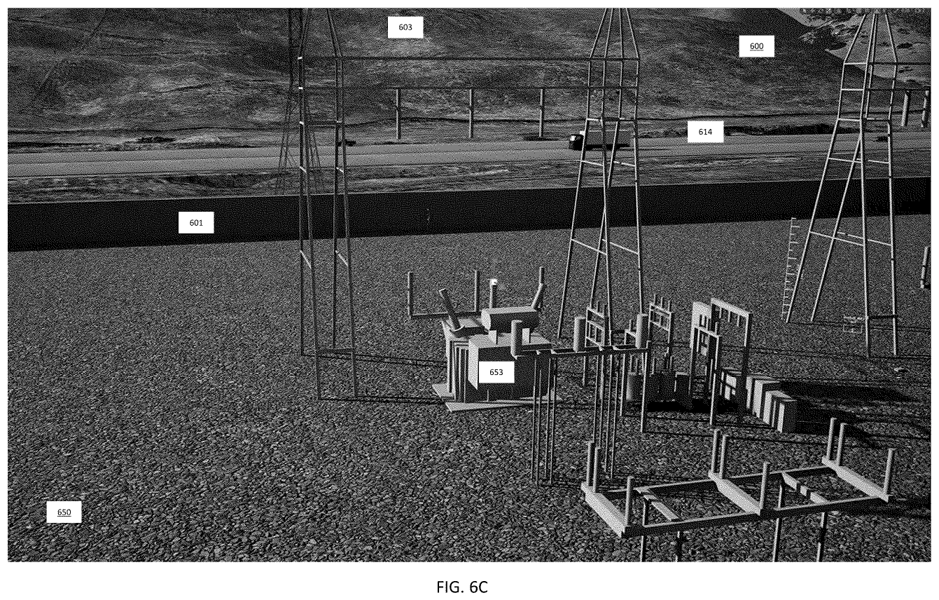

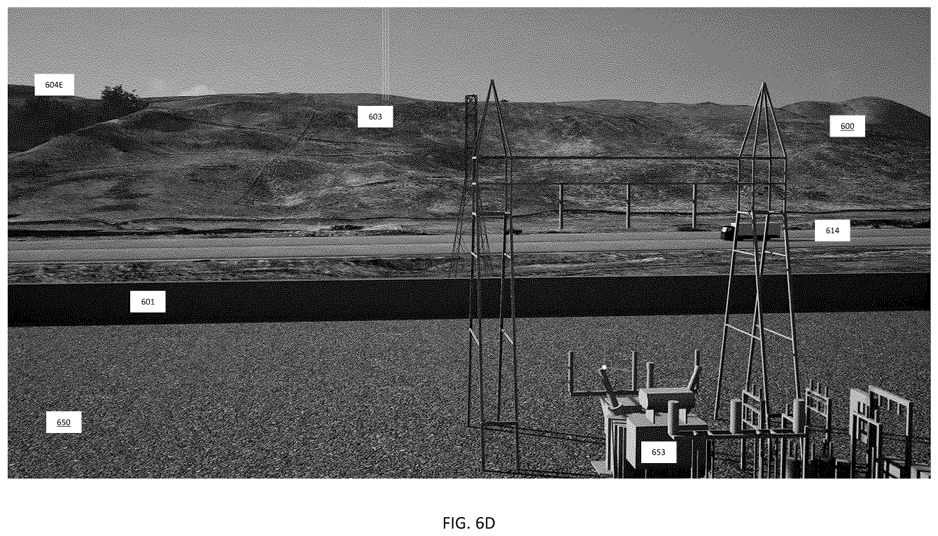

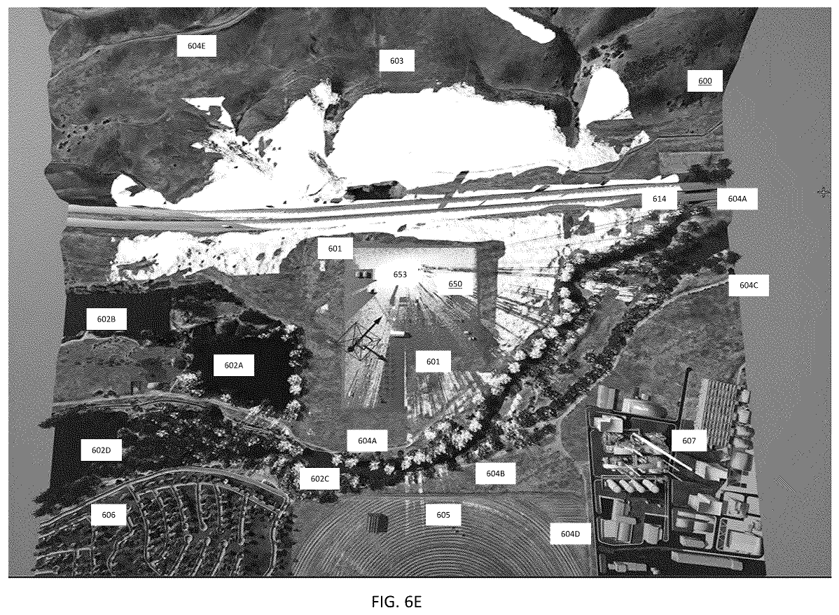

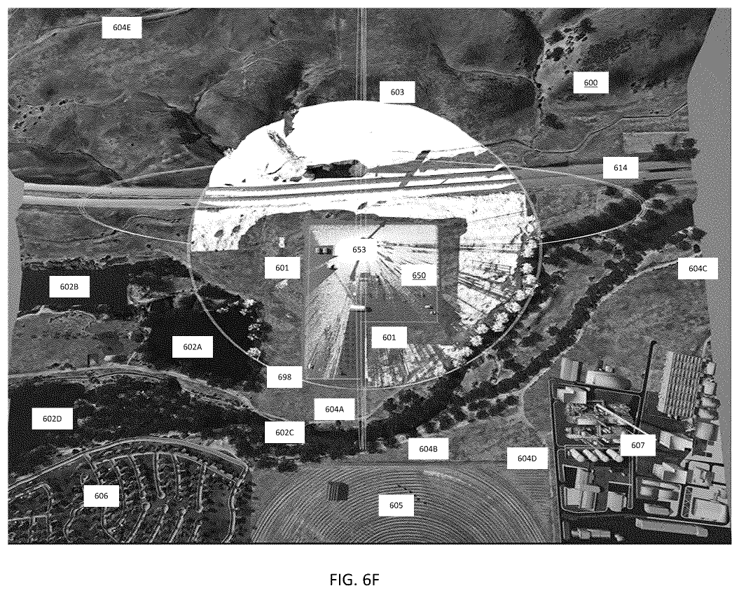

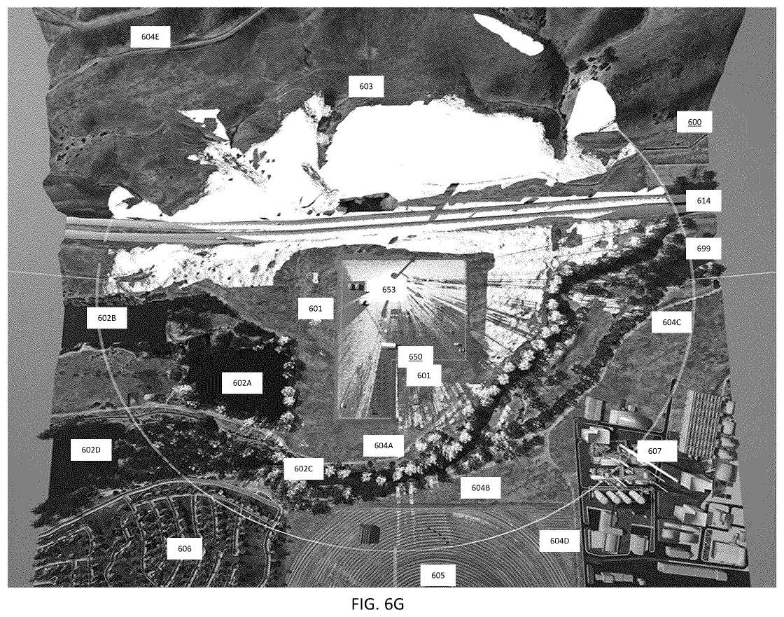

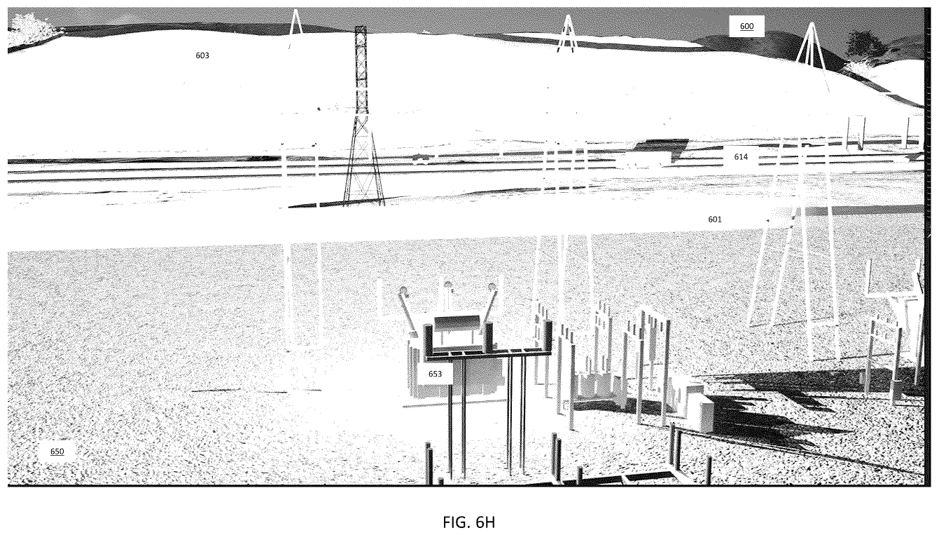

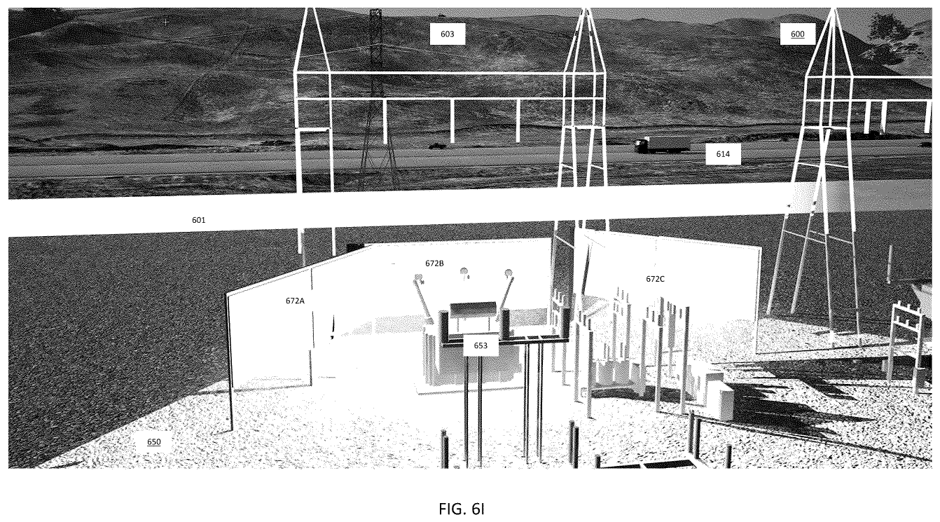

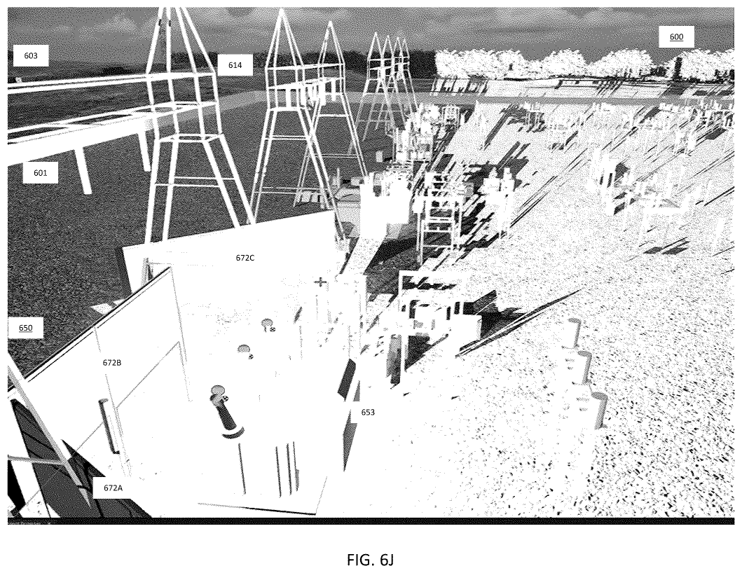

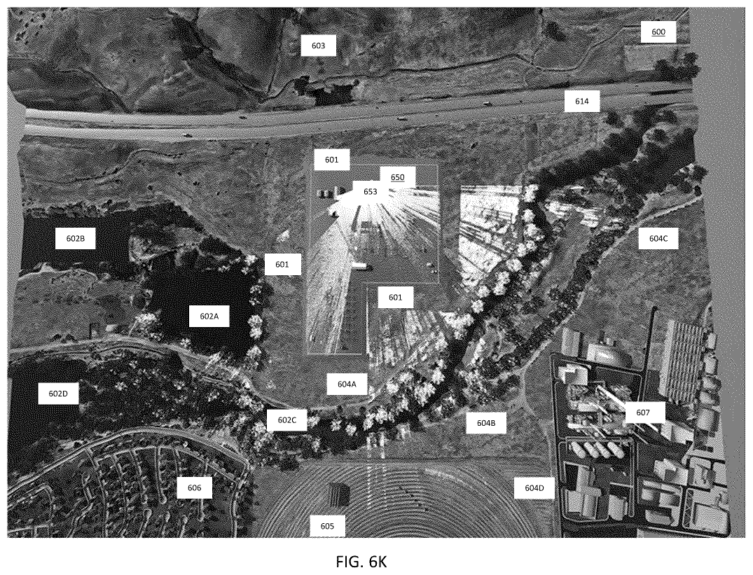

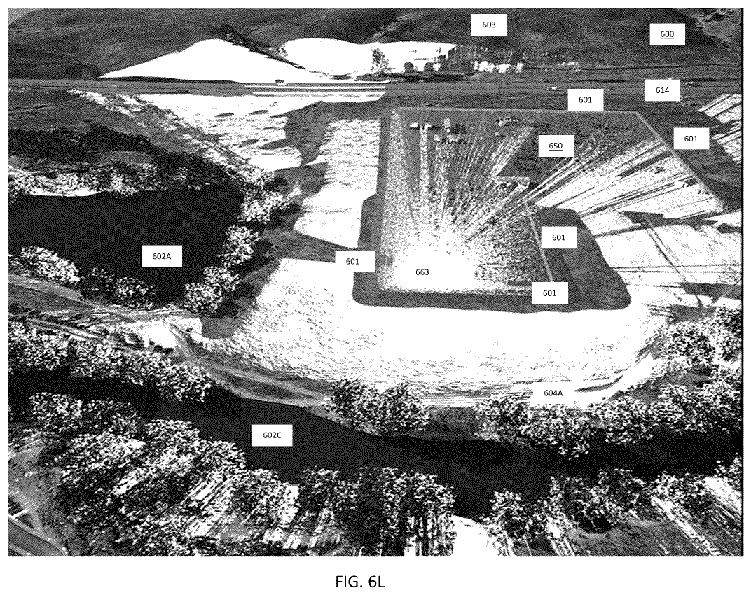

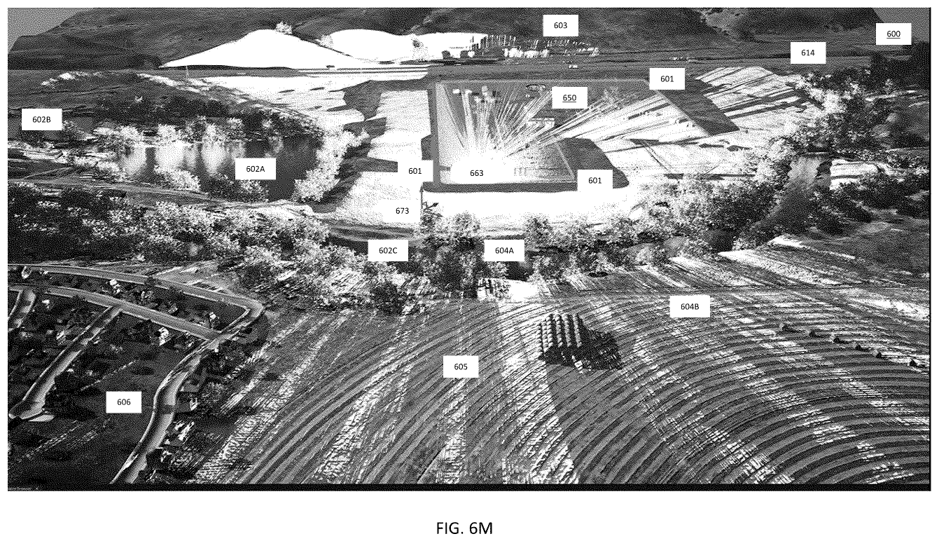

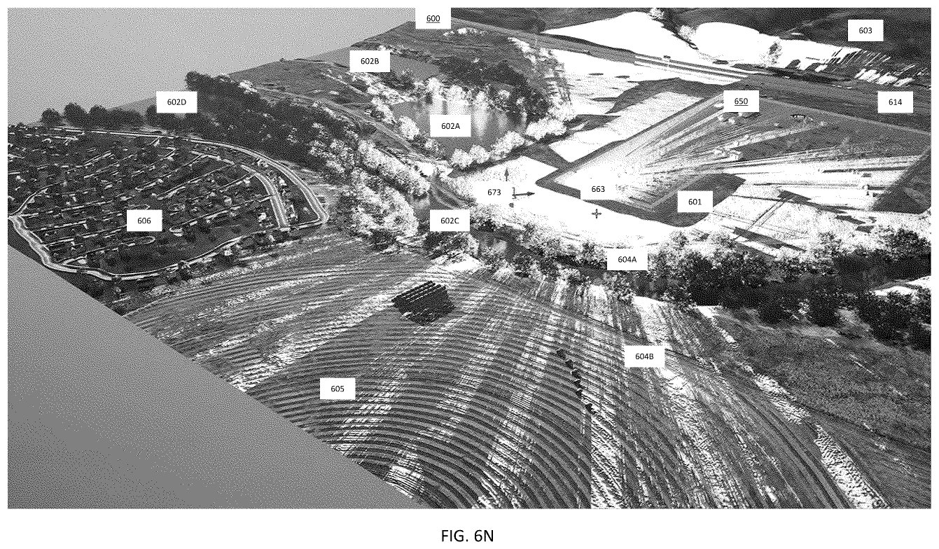

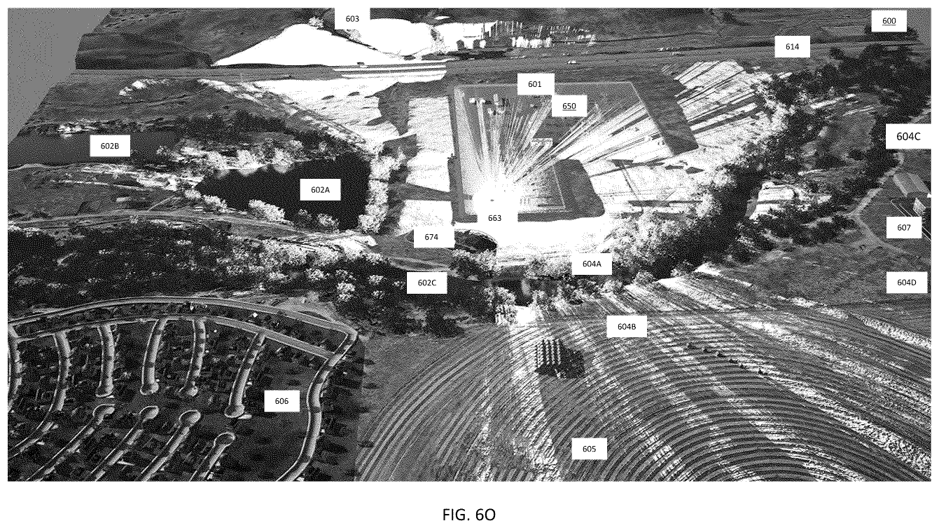

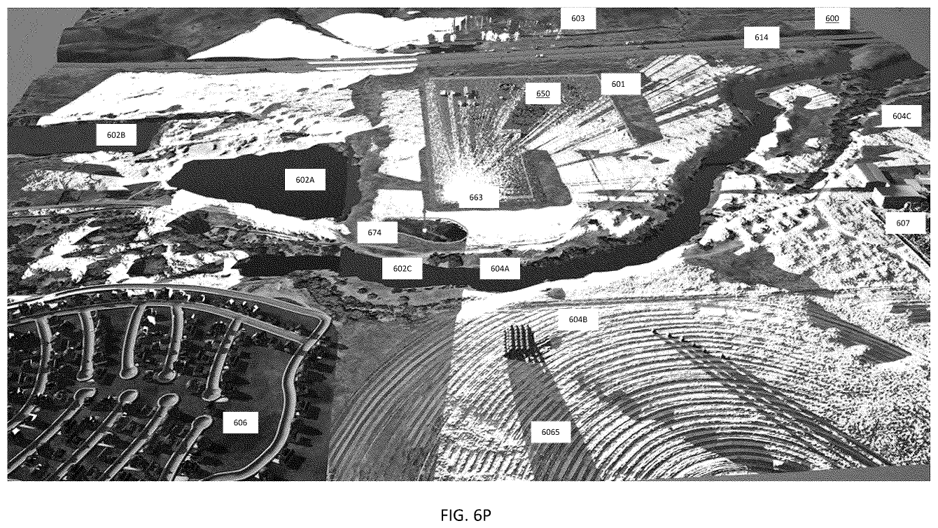

FIGS. 6A through 6P, FIGS. 7A through 7C, FIGS. 8A through 8C, and FIGS. 9A through 9H are screen shots of interactive visual display screens generated using one embodiment of the disclosed processes and systems showing just some of the analysis capabilities provided by the disclosed processes and systems.

Referring to FIGS. 6A through 6P, 7A through 7C, 8A through 8C, and 9A through 9H together, shown are screen shots of various views of an interactive 3D model representation 600 of a critical asset site 650 including various critical assets and structures and various environmental features as would be generated using any of the processes and/systems for identifying and mitigating threats to critical assets disclosed herein.

In various embodiments, the interactive 3D model representation 600 of critical asset site 650 of FIGS. 6A through 6P, 7A through 7C, 8A through 8C, and 9A through 9H is a generalized interactive 3D model representation 600 of the critical asset site 650 that can be generated using any process or system for identifying and mitigating threats to existing critical assets, any process or system for identifying and mitigating threats to proposed critical assets, and/or any process or system for identifying and mitigating threats to existing and proposed critical assets disclosed herein.

Referring to FIGS. 6A through 6P together, interactive 3D model representation 600 includes: a first mitigation feature 601; water environmental features 602A, 602B, 602C, and 602D; hillside environmental feature 603; path/road environmental features 604A, 604B, 604C, 604D, and 604E; field environmental feature 605; neighborhood environmental feature 606; industrial park environmental feature 607; highway environmental feature 614; critical asset site 650; and first selected critical asset 653.

As noted, critical asset site 650 can be a proposed critical asset site with proposed critical assets and environmental features, an existing critical asset site with existing critical assets and environmental features, and/or a hybrid critical asset site with existing and/or proposed critical assets and existing and/or proposed environmental features.

In this specific illustrative example, critical asset site 650 is a power transmission sub-station. However, as noted above, in other examples, critical asset sites can be, but are not limited to, power generation facilities including electrical power generation substations, wind farms, solar farms, and hydro-electric dams and facilities; military, government, and civilian communication stations and substations; port facilities and Naval stations; water production facilities including reservoirs, dams, pumping facilities and aqueducts; airports; sewage treatment sites; chemical production facilities; railways and railway stations; food storage facilities; and/or any other site where critical assets can be found as discussed herein and/or as known at the time of filing, and/or as developed after the time of filing.

FIG. 6A is a screen shot of a wide-angle visual display of interactive 3D model representation 600 of critical asset site 650 before any analysis is performed. FIG. 6A includes first mitigation feature 601, water environmental features 602A, 602B, 602C; hillside environmental feature 603; path/road environmental features 604A, 604B, 604C, 604D, and 604E; field environmental feature 605; neighborhood environmental feature 606; industrial park environmental feature 607; highway environmental feature 614; critical asset site 650; and first selected critical asset 653.

FIG. 6B is a screen shot of a zoomed in visual display of interactive 3D model representation 600 of critical asset site 650 showing detail of first mitigation feature 601, that in this illustrative example is a perimeter wall; hillside environmental feature 603; highway environmental feature 614; and critical assets 653, 654, and 655 which, in this specific illustrative example, are transformers.

As noted above, in other examples, the critical assets can be, but are not limited to: electrical transformers, electrical generators, power lines, and any power production and/or transmission components; signal transmission stations and signal transmission towers; dams, aqueducts, and control facilities; communication stations and communication antennas; various governmental buildings; airport control towers, fueling stations, radars and communication systems; and/or any other critical assets as discussed herein, and/or as known in the art at the time of filing, and/or as become known or available after the time of filing that are deemed subject to attack.

FIG. 6C is a screenshot of a zoomed in visual display of interactive 3D model representation 600 of critical asset site 650 showing detail of first mitigation feature 601; hillside environmental feature 603; highway environmental feature 614; and selected critical asset 653.

FIG. 6D is a screen shot of another zoomed in visual display of interactive 3D model representation 600 of critical asset site 650 showing detail of first mitigation feature 601; hillside environmental feature 603; highway environmental feature 614; path/road environmental feature 604E and selected critical asset 653.

As discussed above, in one embodiment, potential vulnerabilities associated with the existing and/or proposed critical assets at the critical asset site are identified using the interactive 3D model, such as interactive 3D model representation 600, created by an interactive 3D modeling system such as a gaming engine.

In one embodiment, this is accomplished by providing one or more virtual light/illumination sources indicating line-of-sight vulnerability. In one embodiment, one or more these virtual light/illumination sources can be interactively placed anywhere desired within interactive 3D model representation 600. Consequently, the virtual light/illumination sources can be interactively placed at, on, or in any existing or proposed critical asset or environmental feature and/or the surrounding area in the interactive 3D model representation 600 of the critical asset site 650.

In one embodiment, the virtual light/illumination sources virtually illuminate all portions and features of the interactive 3D model representation 600 of the critical asset site 650 that can be seen, and potentially attacked, from the location of the virtual light/illumination sources.

Thus, in one embodiment, the virtual light/illumination sources can be placed at, or on, any of the critical assets, and/or any portion or feature of the critical assets, and/or any location in the critical asset site, or in the surrounding area. Then any of the critical assets, and/or portion or feature of the critical assets, and/or critical asset site or surrounding area locations illuminated by the virtual light/illumination sources is considered vulnerable to attack.

FIG. 6E is a screen shot of an overhead visual display of interactive 3D model representation 600 of critical asset site 650 after a virtual light/illumination source has been placed on, or near, selected critical asset 653.

As seen in FIG. 6E, after a virtual light/illumination source has been placed on, or near, selected critical asset 653, line-of-sight vulnerability of portions of critical asset site 650 and the surrounding area is then indicated by illuminated areas. As discussed below, this line-of-sight vulnerability of portions of critical asset site 650 and the surrounding area is indicated by illuminated areas showing line-of-sight visibility extending both ways, i.e., looking into critical asset site 650 and selected critical asset 653 and looking out from critical asset site 650 and selected critical asset 653.

Thus, in this example, any area or feature illuminated by the virtual light/illumination source is a location where a person or other threat would have line-of-sight access to those illuminated portions and where a person looking out from critical asset site 650 would have line-of-sight access.

Of note, in FIG. 6E, illuminated portions include much of hillside environmental feature 603; highway environmental feature 614; path/road environmental features 604A, 604B, 604C, 604D, and 604E, and the surrounding areas illuminated. Thus, these illuminated areas show selected critical asset 653, and much of critical asset site 650, are vulnerable to attack despite the presence of first mitigation feature 601. Consequently, even with first mitigation feature 601, selected critical asset 653, and critical asset site 650, are quite vulnerable.

As noted above, in some embodiments, various operational data, such as threat data, vulnerability data, and mitigation feature data are made available to the interactive 3D modeling system that transforms the 3D model data into an interactive 3D models, such as interactive 3D model representation 600 for processing various displays.

In some embodiments, the operational data includes, but is not limited to, one or more of ranging data, threat ballistics data, mitigation feature data, mitigation feature cost data, and updated intelligence data regarding known and/or potential threats. In one embodiment, this operational data is used to provide dynamic relatively real time analysis of the vulnerability of the critical assets and the effectiveness of various threat mitigation features as various parameters are manipulated and changed by the user.

In one embodiment, the operational data is processed to automatically determine and identify any threat specific potential vulnerability of the existing and/or proposed critical assets at the critical asset site to the identified potential threats and to automatically generate specific potential vulnerability data representing the determined threat specific potential vulnerability of the existing and/or proposed critical assets at the critical asset site.

In other embodiments, the threat data is used to determine specific vulnerability of the critical assets by simply adjusting the range of the analysis performed to the maximum range of the threat identified having the longest range and/or greatest capabilities.

As one specific example, when virtual light/illumination sources are used to identify critical asset vulnerabilities as discussed above, the range of virtual illumination from the virtual light/illumination sources can be adjusted to the maximum range of the identified threat.

In another example, when avatars representing human threats are generated to provide inward looking views with respect to the critical assets and critical asset site, as discussed below, the position at which the avatars can be placed is the maximum range of the identified threat.

FIG. 6F is a screen shot of an overhead visual display of interactive 3D model representation 600 of critical asset site 650 after a virtual light/illumination source has been placed on or near selected critical asset 653. FIG. 6F includes a range limited display with the threat range, i.e., illumination range, having been limited to the area enclosed by range limiting perimeter 698. In various embodiments, range limiting perimeter 698 can be made any shape and made smaller or larger based on threat data indicating shorter or larger range threats.

FIG. 6G is a screen shot of an overhead visual display of interactive 3D model representation 600 of critical asset site 650 after a virtual light/illumination source has been placed on or near selected critical asset 653. FIG. 6G includes a range limited display with the threat range having been expanded to the area enclosed by range limiting perimeter 699.

In some instances, the user may wish to view the interactive 3D model, including critical assets, virtual lights/illumination sources, and the critical asset site from the perspective of a person looking into the critical asset site. As discussed above with respect to FIG. 3I and below with respect to FIGS. 9A through 9H, using the disclosed embodiments this can be achieved by simply using an interface device to change the perspective view and/or viewpoint.

FIG. 6H is a zoomed in view of selected critical asset 653 after a virtual light/illumination source has been placed on or near selected critical asset 653 showing the vulnerability of selected critical asset 653 when only first mitigation feature 601 is present. As seen in FIG. 6H, selected critical asset 653 has significant vulnerability to highway environmental feature 614 and hillside environmental feature 603 even when first mitigation feature 601 is employed.

As noted, in accordance with the disclosed embodiments, the interactive 3D modeling system generates and displays interactive 3D model representations that dynamically change in response to user interactions with the interactive 3D model representation. In this way the type of proposed threat mitigation features, the numbers of proposed threat mitigation features, the parameters/dimensions of the proposed threat mitigation features, and the location of proposed threat mitigation features can all be interactively changed using the disclosed methods and systems. Therefore, using the disclosed embodiments, a dynamic analysis can be made of the effectiveness of various types, sizes, numbers and locations of proposed threat mitigation features in a single sitting and in relative real time.

FIGS. 6I, 6J, and 6K show screen shots of interactive displays of interactive 3D model representation 600 of the critical asset site 650 including views of the potential vulnerability of selected critical asset 653 at critical asset site 650 after proposed threat mitigation features 672A, 672B, 672C are added to first mitigation feature 601.

As seen in FIGS. 6I and 6J, in this example, proposed threat mitigation features 672A, 672B, 672C can be any of the threat mitigation features discussed herein. As one specific example, threat mitigation features 672A, 672B, 672C can be ballistic shields placed in front of selected critical asset 653.

Referring to FIGS. 6H, 6I and 6J together, a comparison of the illuminated areas in FIG. 6H with the illuminated areas in FIGS. 6I and 6J shows that the addition of proposed threat mitigation features 672A, 672B, 672C provides significant additional protection for selected critical asset 653 from hillside environmental feature 603; highway environmental feature 614; and the surrounding area.

Similarly, referring to FIGS. 6E and 6K together, a comparison of the illuminated areas in FIGS. 6E and 6K shows that the addition of proposed threat mitigation features 672A, 672B, 672C provides significant additional protection for selected critical asset 653 from hillside environmental feature 603; highway environmental feature 614; and the surrounding area.

FIGS. 6L and 6M are screen shots of perspective view visual displays of interactive 3D model representation 600 of critical asset site 650 after a second virtual light/illumination source has been placed on, or near, a selected location 663. Again, in this example, any area or feature illuminated by the virtual light/illumination source is a location where a person or other threat would have line-of-sight access to those illuminated portions, including selected location 663.

As seen in FIGS. 6L and 6M, after a virtual light/illumination source has been placed on, or near, selected location 663, line-of-sight vulnerability of portions of critical asset site 650 and the surrounding area are then indicated by illuminated areas. As discussed above, this line-of-sight vulnerability of portions of critical asset site 650 and the surrounding area is indicated by illuminated areas showing line-of-sight visibility extending both ways, i.e., looking into critical asset site 650 and selected location 663 and looking out from critical asset site 650 and selected location 663.

Thus, in this example, any area or feature illuminated the virtual light/illumination source is a location where a person or other threat would have line-of-sight access to those illuminated portions and where a person looking out from critical asset site 650 would have line-of-sight access.

Of note, in FIGS. 6L and 6M, illuminated portions include much of the surrounding areas including parts of hillside environmental feature 603; parts of highway environmental feature 614; parts of path/road environmental features 604A, 604B, portions of field environmental feature 605, and the surrounding areas. Therefore, selected location 663 is significantly vulnerable to attack despite the presence of first mitigation feature 601. Consequently, even with a first mitigation feature 601, selected location 663, and large areas of critical asset site 650, are quite vulnerable.

As discussed above, in various embodiments, the mitigation features can include, but are not limited to, one or more of: physical wall portions of various types, shapes, materials, widths, lengths and heights; full screening perimeter walls of various types, shapes materials, widths, lengths and heights; firewalls of various types, shapes, materials, widths, lengths and heights; ballistic plating of various types, shapes, materials, widths, lengths and heights; Kevlar or other bullet proof curtains of various types, shapes, widths, lengths and heights; landscape environmental screening features of various types, shapes, materials, widths, lengths and heights; visual detection systems of various types such as cameras; radar detection systems of various types; infrared detection systems of various types; equipment placement/relocations; and/or any other mitigation features capable of protecting the identified critical assets from various types of threats as discussed herein; and/or as known/available in the art at the time of filing, and/or as developed/made available after the time of filing.

One particular type of threat mitigation features are landscape environmental screening features of various types, shapes, materials, widths, lengths and heights.

FIGS. 6M, 6N, 6O and 6P show position selection, and potential use of, a proposed threat mitigation feature 674 that is a landscape environmental threat mitigation feature for mitigating the threats illuminated in FIGS. 6L and 6M.

FIGS. 6M and 6N show the proposed location 673 for a proposed threat mitigation feature 674 shown in FIGS. 6O and 6P.

FIGS. 6O and 6P show the effects of proposed threat mitigation feature 674 when implemented at proposed location 673. Comparing FIGS. 6L, 6M, and 6N with FIGS. 6O and 6P, it can be seen that the proposed threat mitigation feature 674 when implemented at proposed location 673 provides significant protection for selected location 663 from threats in the area of water environmental feature 602C, the left portion of field 605, and neighborhood environmental feature 606.

As noted above, in various embodiments, the mitigation features can include, but are not limited to, visual detection systems of various types such as cameras.

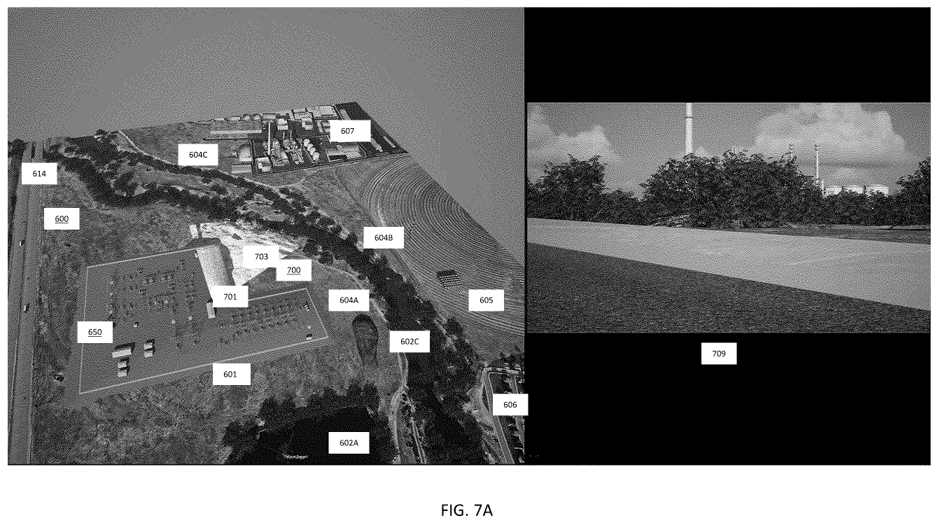

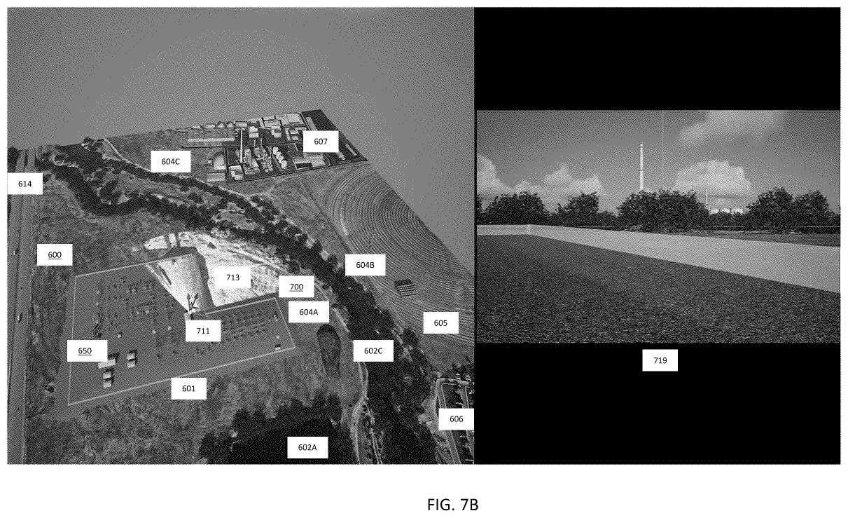

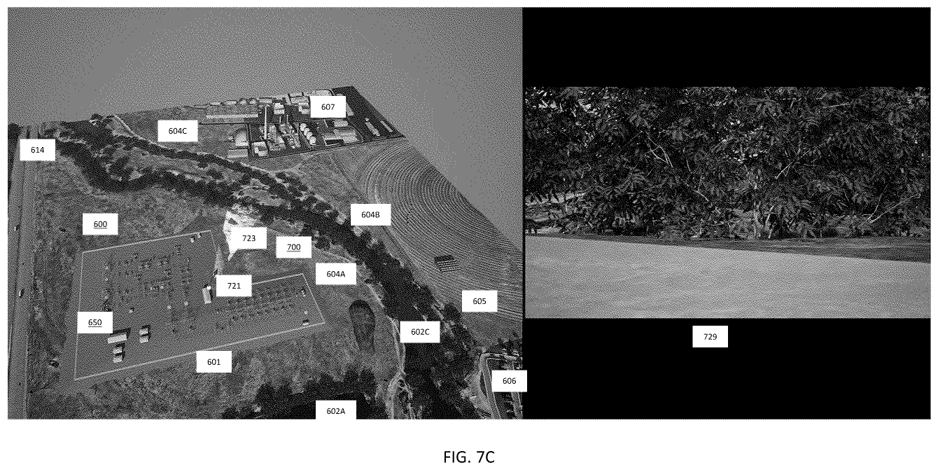

FIGS. 7A through 7C are screenshots of perspective view visual displays of interactive 3D model representation 600 of critical asset site 650 showing the effects of implementing one or more visual monitoring and/or detection systems such as cameras.

FIG. 7A shows a virtual camera 701 placed in a first location and having a first field of view for monitoring and/or detecting motion in a portion 700 of interactive 3D model representation 600 of critical asset site 650 as would be generated using one embodiment of the disclosed processes and systems.

In FIG. 7A, illuminated area 703 shows the first field of view of virtual camera 701 as placed and screen 709 shows a virtual representation of the first field of view as would be generated using one embodiment of the disclosed processes and systems.

FIG. 7B shows a virtual camera 711 placed in a first location and having a second field of view for monitoring and/or detecting motion in the portion 700 of interactive 3D model representation 600 of critical asset site 650 as would be generated using one embodiment of the disclosed processes and systems.

In FIG. 7B, illuminated area 713 shows the second field of view of virtual camera 711 as placed and screen 719 shows a virtual representation of the second field of view as would be generated using one embodiment of the disclosed processes and systems.

FIG. 7C shows a virtual camera 721 placed in the first location and having a third field of view for monitoring and/or detecting motion in the portion 700 of interactive 3D model representation 600 of critical asset site 650 as would be generated using one embodiment of the disclosed processes and systems.

In FIG. 7C, illuminated area 723 shows the third view of virtual camera 721 as placed and screen 729 shows a virtual representation of the third field of view as would be generated using one embodiment of the disclosed processes and systems.

Of note, virtual cameras 701, 711, and 721 can all be the same camera with variable focus and zoom capability.

Using the disclosed embodiments, any number and type of virtual cameras can be generated and positioned anywhere in interactive 3D model representation 600. In this way, the use and effectiveness of detection type threat mitigation features can be evaluated along with the blocking type threat mitigation features discussed above. As a result, a holistic analysis of any entire threat mitigation system can be dynamically evaluated using the disclosed methods and systems. This then provides a dynamic visualization of numerous threat mitigation options simultaneously and how they interact.

As noted above, in various embodiments, the mitigation features can include, but are not limited to, infrared detection systems of various types and/or radar detection systems of various types.

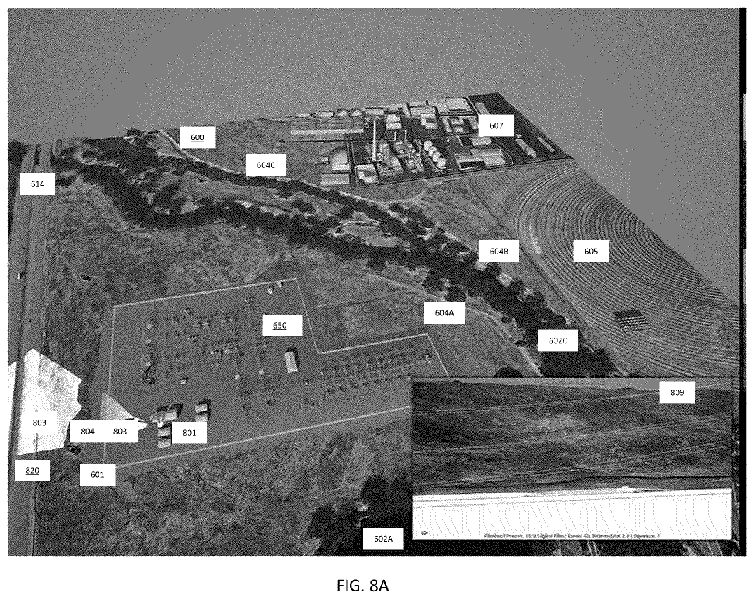

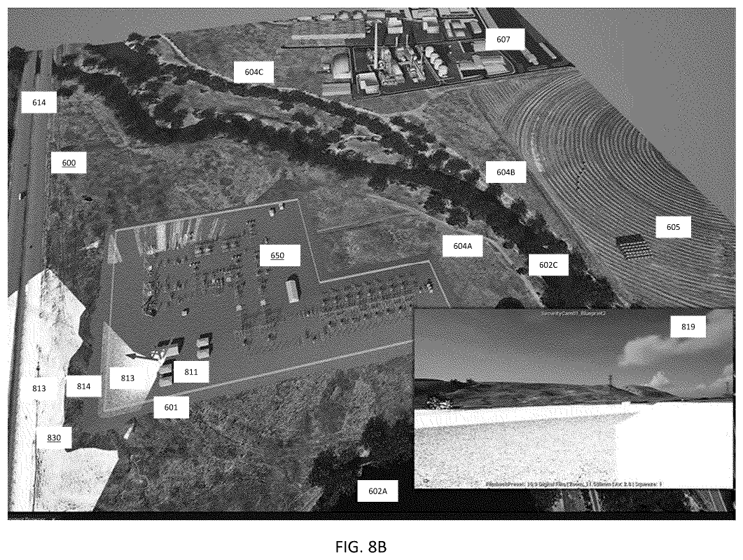

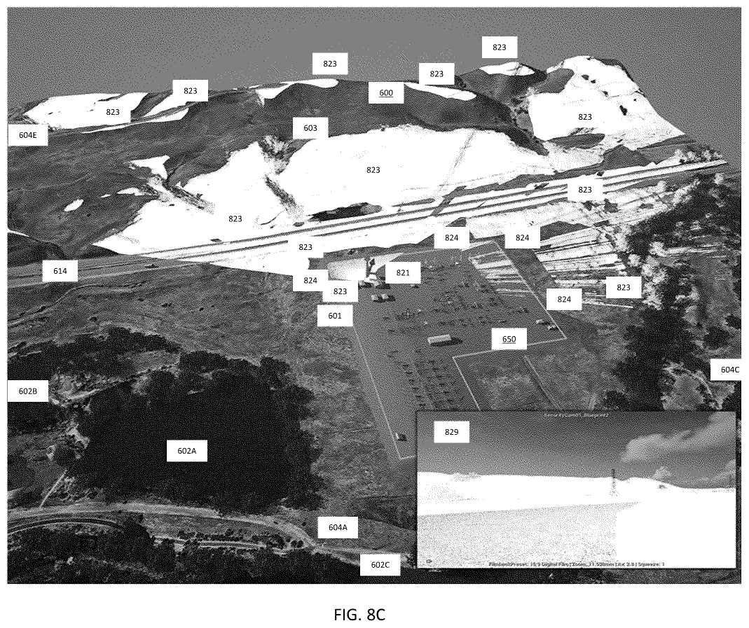

FIGS. 8A and 8B are screenshots of perspective view visual displays of interactive 3D model representation 600 of critical asset site 650 showing the effects of using one or more infrared monitoring and/or detection systems.

FIG. 8A shows a virtual infrared detection system 801 placed in a first location and having a first detection range for monitoring and/or detecting motion in a portion 820 of interactive 3D model representation 600 of critical asset site 650 as would be generated using one embodiment of the disclosed processes and systems.

In FIG. 8A, illuminated areas 803 show the first coverage area of virtual infrared detection system 801 as placed. Of note it is projected a dead gap 804 in which there is no detection provided at that location. Screen 809 in FIG. 8A shows a virtual representation of the first coverage area as illuminated portions, as would be generated using one embodiment of the disclosed processes and systems.

FIG. 8B shows a virtual infrared detection system 811 placed in a first location and having a second detection range for monitoring and/or detecting motion in a portion 830 of interactive 3D model representation 600 of critical asset site 650 as would be generated using one embodiment of the disclosed processes and systems.

In FIG. 8B, illuminated areas 813 show the second coverage area of virtual infrared detection system 811 as placed. Of note is projected dead gap 814 where there is no detection provided. Screen 819 in FIG. 8A shows a virtual representation of the first coverage area as illuminated portions, as would be generated using one embodiment of the disclosed processes and systems.

FIG. 8C shows a virtual radar system 821 placed in a first location and having a radar detection range for monitoring and/or detecting motion in the illuminated areas 823 of interactive 3D model representation 600 of critical asset site 650 as would be generated using one embodiment of the disclosed processes and systems.

In FIG. 8C, illuminated areas 823 show the radar coverage area of virtual radar system 821 as placed. Of note are projected dead spots 824 where there is no detection. Screen 829 in FIG. 8A shows a virtual representation of the radar coverage area as illuminated portions, as would be generated using one embodiment of the disclosed processes and systems.

As discussed above with the visual detection systems of FIG. 7A through 7C, using the disclosed embodiments, any number and type of virtual visual, infrared, and/or radar systems can be generated and positioned anywhere in interactive 3D model representation 600. In this way, the use and effectiveness of detection type threat mitigation features can be evaluated along with blocking type threat mitigation features. As a result, a holistic analysis of any entire threat mitigation system can be dynamically evaluated using the disclosed methods and systems. This then provides a visualization of numerous threat mitigation options and how they interact.

As discussed in more detail above, in various embodiments, the user can interact with the interactive 3D model representation 600 to view all aspects of interactive 3D model representation 600 and critical asset site 650 representations from any perspective, angle, and/or distance desired.

For instance, in one example the user may wish to view the interactive 3D model representation 600 and/or critical asset site 650 from the perspective of a person/threat looking into the critical asset site. Using the disclosed embodiments this can be achieved by simply using an interface device to change the perspective view and/or viewpoint.

To this end, in one embodiment, avatars representing human threats can be generated to provide inward looking views with respect to the critical assets and critical asset site.

FIGS. 9A through 9H are screen shots of some of the analysis capabilities provided by the disclosed processes and systems using an “in looking” threat view feature in accordance with various embodiments.

FIG. 9A shows an avatar 901 of a human threat positioned at a first selected position on hillside environmental feature 603 of 3D model representation 600 of critical asset site 650 as could be generated using one embodiment of the disclosed processes and systems.

As seen in FIG. 9A, from this first position on hillside environmental feature 603, avatar 901 has a clear line-of-sight inward looking view of large portions of critical asset site 650, first mitigation feature 601, water environmental feature 602B and various trees and tree lines, and industrial park environmental feature 607.

FIG. 9B shows just the view of FIG. 9A, i.e., without avatar 901, as could be generated using one embodiment of the disclosed processes and systems.

FIG. 9C shows the view of FIG. 9B with line-of-sight visual features highlighted by a virtual light/illumination source placed at eye level of avatar 901 as could be generated using one embodiment of the disclosed processes and systems.

FIG. 9D shows avatar 901 positioned on a virtual vehicle 903 positioned at a first selected location on hillside environmental feature 603 of 3D model representation 600 of critical asset site 650 as could be generated using one embodiment of the disclosed processes and systems.

FIG. 9D shows line-of-sight visual features highlighted by a virtual light/illumination source placed at eye level of avatar 901 standing in virtual vehicle 903 as could be generated using one embodiment of the disclosed processes and systems.

FIG. 9E shows just the view of FIG. 9D, i.e., without avatar 901 and virtual vehicle 903, and with line-of-sight visual features highlighted by a virtual light/illumination source placed at eye level of avatar 901 as could be generated using one embodiment of the disclosed processes and systems.

FIG. 9F and FIG. 9G show avatar 901 positioned on the roof of a house 950 located in neighborhood environmental feature 606 of 3D model representation 600 of critical asset site 650 and with line-of-sight visual features highlighted by a virtual light/illumination source placed at eye level of avatar 901 as could be generated using one embodiment of the disclosed processes and systems.

FIGS. 9G and 9H show the line-of-sight view a threat, such as avatar 901, would have from the roof of the house 950 located in neighborhood environmental feature 606 with line-of-sight visual features highlighted by a virtual light/illumination source placed at eye level of avatar 901.

Using the disclosed embodiments, any number of avatars, such as avatar 901, can be placed at any locations, distances, and height of any of the features of 3D model representation 600 of critical asset site 650. Then line-of-sight visual features can be viewed from the perspective of the avatars and/or be highlighted by a virtual light/illumination source placed at eye level of the avatars.

Therefore, using the features of the disclosed processes and systems shown in FIGS. 9A through 9H, analysis can be made of the effectiveness of various threat mitigation features against inward looking threats. Consequently, the use and effectiveness of detection type threat mitigation features, blocking type threat mitigation features, and inward looing threats of various types can be evaluated. As a result, a holistic analysis of any entire threat mitigation system and various types of threats can be dynamically evaluated using the disclosed methods and systems.

The above discussion of FIGS. 6A through 6P, 7A through 7C, 8A through 8C, and 9A through 9H illustrate but a subset of specific examples of just a few of the capabilities provided using the disclosed methods and systems. Those of skill in the art will recognize that by leveraging interactive 3D modeling systems, such as gaming engines, to generate customized interactive 3D critical asset site models, the disclosed processes and systems provide interactive visual displays of multiple potential threats, multiple potential mitigation measures, and the effectiveness of the each of the potential threat mitigation features with respect to protecting future critical assets and/or critical asset sites.

Consequently, using the disclosed processes and systems, detailed analysis of numerous threats, vulnerabilities, and threat mitigation features can be interactively and dynamically visualized and analyzed from multiple perspectives for virtually any critical asset and/or location at a critical asset site; all in relative real time and all being dynamically adjusted according to the users' input.

As shown above, the disclosed methods and systems for determining and mitigating threats to critical assets leverages gaming engine features for creating highly detailed 3D modeling of both existing and proposed critical assets, their sites, and the surrounding areas. These 3D models are fully interactive with threat analysis and mitigation parameters that can be varied in relative real time to provide numerous options and configurations in a single sitting.

In addition, the disclosed methods and systems for determining and mitigating threats to critical assets provide for analysis of numerous kinds of threats and numerous weapons so that the resultant plan can be modified to adapt to evolving threats.

In addition, in one embodiment the disclosed methods and systems for determining and mitigating threats to critical assets provide rough cost calculations so that the owner/operator/builder of the critical assets can do rough cost comparisons of mitigation features while, at the same time, seeing the effectiveness of those features from virtually any position.

Consequently, the disclosed methods and systems for determining and mitigating threats to critical assets provide a solution to the long standing technical problem of providing critical asset threat and mitigation analysis that is efficient, effective, and holistic and that provides for interactive and relative real time analysis of potential threats and mitigation measures with respect to existing and future critical assets to generate cost effective and efficient threat mitigation solutions for the existing and future critical assets.

In one embodiment, a process for determining and mitigating threats to critical assets includes identifying existing and/or proposed environmental features and existing and/or proposed critical assets at a critical asset site.

In one embodiment, the process includes obtaining critical asset site data representing existing and/or proposed environmental features and existing and/or proposed critical assets at the critical asset site.

In one embodiment, the process includes processing the critical asset site data to convert the critical asset site data into 3D model data representing the critical asset site including the existing and/or proposed environmental features and the existing and/or proposed critical assets.

In one embodiment, the process includes providing the 3D model data to an interactive 3D modeling system. In one embodiment, the interactive 3D modeling system transforms the 3D model data into an interactive 3D model representation of the critical asset site including the existing and/or proposed environmental features and the existing and/or proposed critical assets.

In one embodiment, the process includes identifying potential vulnerabilities associated with the existing and/or proposed critical assets at the critical asset site and generating potential vulnerability data representing the identified potential vulnerabilities associated with the existing and/or proposed critical assets at the critical asset site.

In one embodiment, the process includes identifying potential threat mitigation features capable of mitigating the determined potential vulnerability of the existing and/or proposed critical assets at the critical asset site and generating potential threat mitigation feature data representing the identified potential threat mitigation features.

In one embodiment, the process includes processing the potential vulnerability data and the potential threat mitigation feature data to generate an interactive visualization of the effectiveness of each of the potential threat mitigation features for protecting the existing and/or proposed critical assets at the critical asset site.

In one embodiment, the process includes displaying the interactive visualization of the effectiveness of the potential threat mitigation features for protecting the existing and/or proposed critical assets at the critical asset site.

In one embodiment, the process includes selecting one or more threat mitigation features based, at least in part, on the visualization of the effectiveness of the potential threat mitigation features for protecting the existing and/or proposed critical assets at the critical asset site.

In one embodiment, the process includes generating selected threat mitigation feature data representing the structural parameters and location of the selected threat mitigation features for the existing and/or proposed critical assets at the critical asset site.

In one embodiment, the process includes using the selected threat mitigation feature data to generate a threat mitigation plan for the critical asset site.

In various embodiments, the critical asset sites can be, but are not limited to, electrical generation facilities; electrical generation substations; communication stations; water production facilities; reservoirs; pumping stations; airports; sewage treatment facilities; government facilities; law enforcement facilities; and military facilities.

In various embodiments, the critical assets can be, but are not limited to, electrical transformers; electrical generators; signal transmission towers; power lines; dams; aqueducts; control towers; communication antennas; and buildings.

In various embodiments, the critical asset site data includes data collected using one or more of aerial LiDAR; terrestrial LiDAR; radar; infrared systems; photogrammetry; and CAD.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, identifying potential vulnerability data includes the use of virtual light/illumination sources.

In one embodiment, the process includes obtaining potential threat data identifying potential threats, the potential threat data being provided by one or more of local intelligence, known available weapons systems; potentially available weapons systems; and worst-case scenario analysis.

In various embodiments, the one or more mitigation features can be, but are not limited to, physical walls; ballistic curtains; landscape features; Kevlar structures; radar detection systems; infrared detection systems; and visual detection systems.

In one embodiment, the disclosed processes and systems for determining and mitigating threats to critical assets includes a process for determining and mitigating threats to existing critical assets. This embodiment is also referred to herein as “existing facilities/structures” process for determining and mitigating threats to existing critical assets.

In one embodiment, the process includes performing a critical asset site inventory, the critical asset site inventory including identifying environmental features and existing critical assets at the critical asset site.

In one embodiment, the process includes obtaining existing critical asset site data representing environmental features and existing critical assets at the critical asset site.

In one embodiment, the process includes processing the existing critical asset site data to convert the existing critical asset site data into 3D model data representing the critical asset site including the environmental features and the existing critical assets.

In one embodiment, the process includes providing the 3D model data to an interactive 3D modeling system. In one embodiment, the interactive 3D modeling system transforms the 3D model data into an interactive 3D model representation of the critical asset site including the environmental features and the existing critical assets.

In one embodiment, the process includes identifying potential vulnerabilities associated with the existing critical assets at the critical asset site and generating potential vulnerability data representing the identified potential vulnerabilities associated with the existing critical assets at the critical asset site.

In one embodiment, the process includes identifying potential threat mitigation features capable of mitigating the determined potential vulnerability of the existing critical assets at the critical asset site. In one embodiment, potential threat mitigation feature data representing the identified potential threat mitigation features is then generated.

In one embodiment, the process includes processing the potential vulnerability data and the potential threat mitigation feature data to generate an interactive visualization of the effectiveness of each of the potential threat mitigation features for protecting the existing critical assets at the critical asset site.

In one embodiment, the process includes displaying the interactive visualization of the effectiveness of the potential threat mitigation features for protecting the existing critical assets at the critical asset site.

In one embodiment, the process includes selecting one or more threat mitigation features based, at least in part, on the visualization of the effectiveness of the potential threat mitigation features for protecting the existing critical assets at the critical asset site.

In one embodiment, the process includes generating selected threat mitigation feature data representing structural parameters and the location of selected threat mitigation features for the existing critical assets at the critical asset site.

In one embodiment, the process includes using the selected threat mitigation feature data to generate a threat mitigation plan for the critical asset site.

In various embodiments, the critical asset sites can be, but are not limited to, electrical generation facilities; electrical generation substations; communication stations; water production facilities; reservoirs; pumping stations; airports; sewage treatment facilities; government facilities; law enforcement facilities; and military facilities.

In various embodiments, the critical assets can be, but are not limited to, electrical transformers; electrical generators; signal transmission towers; power lines; dams; aqueducts; control towers; communication antennas; and buildings.

In various embodiments, the critical asset site data includes one or more of aerial LiDAR data; terrestrial LiDAR data; radar data; infrared data; photogrammetry data; and CAD drawing data.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, identifying the potential vulnerabilities includes the use of virtual light/illumination sources.

In one embodiment, the process includes obtaining potential threat data identifying potential threats, the potential threat data being provided by one or more of local intelligence, known available weapons systems; potentially available weapons systems; and worst-case scenario analysis.

In various embodiments, the one or more mitigation features can be, but are not limited to, physical walls; ballistic curtains; landscape features; Kevlar structures; radar detection systems; infrared detection systems; and visual detection systems.

In one embodiment, the disclosed processes and systems for determining and mitigating threats to critical assets includes a process for determining and mitigating threats to future, or proposed, critical assets.

In one embodiment, the process includes obtaining proposed critical assets data representing proposed critical assets to be located at a critical asset site.

In one embodiment, the process includes obtaining environmental feature data representing existing and/or proposed environmental features at the critical asset site.

In one embodiment, the process includes processing the proposed critical assets data and the environmental feature data to convert the proposed critical assets data and the environmental feature data into 3D model data representing the critical asset site including the proposed and/or existing environmental features and the proposed critical assets.

In one embodiment, the process includes providing the 3D model data to an interactive 3D modeling system. In one embodiment, the interactive 3D modeling system transforms the 3D model data into an interactive 3D model representation of the critical asset site including the existing and/or proposed environmental features and the proposed critical assets.

In one embodiment, the process includes identifying potential vulnerabilities associated with the proposed critical assets at the critical asset site and generating potential vulnerability data representing the identified potential vulnerabilities associated with the proposed critical assets at the critical asset site.

In one embodiment, the process includes identifying potential threat mitigation features capable of mitigating the potential vulnerability of the proposed critical assets at the critical asset site and generating potential threat mitigation feature data representing the identified potential threat mitigation features.

In one embodiment, the process includes processing the potential vulnerability data and the potential threat mitigation feature data to generate an interactive visualization of the effectiveness of the potential threat mitigation features for protecting the proposed critical assets at the critical asset site.

In one embodiment, the process includes displaying the interactive visualization of the effectiveness of the potential threat mitigation features for protecting the proposed critical assets at the critical asset site.

In one embodiment, the process includes selecting one or more mitigation features based, at least in part, on the visualization of the effectiveness of the potential threat mitigation features for protecting the proposed critical assets at the critical asset site.

In one embodiment, the process includes generating selected threat mitigation feature data representing structural parameters and the location of selected threat mitigation features for the proposed critical assets at the critical asset site.

In one embodiment, the process includes using the selected threat mitigation feature data to generate a threat mitigation plan for the critical asset site.

In various embodiments, the critical asset sites can be, but are not limited to, electrical generation facilities; electrical generation substations; communication stations; water production facilities; reservoirs; pumping stations; airports; sewage treatment facilities; government facilities; law enforcement facilities; and military facilities.

In various embodiments, the critical assets can be, but are not limited to, electrical transformers; electrical generators; signal transmission towers; power lines; dams; aqueducts; control towers; communication antennas; and buildings.

In various embodiments, the critical asset site data includes one or more of aerial LiDAR data; terrestrial LiDAR data; radar data; infrared data; photogrammetry data; and CAD drawing data.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, identifying the potential vulnerabilities includes the use of virtual light/illumination sources and range setting.

In one embodiment, the process includes obtaining potential threat data identifying potential threats, the potential threat data being provided by one or more of local intelligence, known available weapons systems; potentially available weapons systems; and worst-case scenario analysis.

In various embodiments, the one or more mitigation features can be, but are not limited to, physical walls; ballistic curtains; landscape features; Kevlar structures; radar detection systems; infrared detection systems; and visual detection systems.

Disclosed herein is a system for determining and mitigating threats to critical assets, in one embodiment, the system includes a critical asset site.

In one embodiment, the system includes critical asset site data representing existing and/or proposed environmental features and existing and/or proposed critical assets at the critical asset site.

In one embodiment, the system includes a 3D modeling system for processing the critical asset site data to convert the critical asset site data into 3D model data representing the critical asset site including the existing and/or proposed environmental features and the existing and/or proposed critical assets.

In one embodiment, the system includes potential threat mitigation feature data including data representing potential threat mitigation features capable of mitigating potential vulnerabilities of the existing and/or proposed critical assets at the critical asset site.

In one embodiment, the system includes an interactive 3D modeling system. In one embodiment, the interactive 3D modeling system receives the 3D model data and the interactive 3D modeling system transforms the 3D model data into an interactive 3D model representation of the critical asset site including the existing and/or proposed environmental features and the existing and/or proposed critical assets.

In one embodiment, the interactive 3D modeling system generates potential vulnerability data representing the determined potential vulnerability of the existing and/or proposed critical assets at the critical asset site.

In one embodiment, the interactive 3D modeling system processes the potential vulnerability data and the potential threat mitigation feature data to generate an interactive visualization of the effectiveness of various potential threat mitigation features for protecting the existing and/or proposed critical assets at the critical asset site.

In one embodiment, the system includes a display device, the display device displaying the interactive visualization of the effectiveness of the potential threat mitigation features for protecting the existing and/or proposed critical assets at the critical asset site.

In one embodiment, the system includes a user interface device, the user interface device dynamically interacting with the interactive 3D model representation of the critical asset site. In one embodiment, the user interface device is capable of selecting one or more threat mitigation features based, at least in part, on the visualization of the effectiveness of the potential threat mitigation features for protecting the existing and/or proposed critical assets at the critical asset site.

In one embodiment, the system includes selected threat mitigation feature data representing the parameters and location of the selected threat mitigation features for the existing and/or proposed critical assets at the critical asset site.

In various embodiments, the critical asset site can be, but is not limited to, electrical generation facilities; electrical generation substations; communication stations; water production facilities; reservoirs; pumping stations; airports; sewage treatment facilities; government facilities; law enforcement facilities; and military facilities.

In various embodiments, the existing and/or proposed critical assets can be, but are not limited to, electrical transformers; electrical generators; signal transmission towers; power lines; dams; aqueducts; control towers; communication antennas; and buildings.

In various embodiments, the critical asset site data includes one or more of aerial LiDAR data; terrestrial LiDAR data; radar data; infrared data; photogrammetry data; and CAD drawing data.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, generating the potential vulnerability data includes the use of virtual light/illumination sources.

In one embodiment, the system includes potential threat data identifying potential threats, the potential threat data being provided by one or more of local intelligence, known available weapons systems; potentially available weapons systems; and worst-case scenario analysis.

In various embodiments, the one or more mitigation features can be, but are not limited to, physical walls; ballistic curtains; landscape features; Kevlar structures; radar detection systems; infrared detection systems; and visual detection systems.

Disclosed herein is a system for determining and mitigating threats to existing critical assets, in one embodiment, the system includes a critical asset site.

In one embodiment, the system includes critical asset site data representing existing and/or proposed environmental features and existing critical assets at the critical asset site.

In one embodiment, the system includes a 3D modeling system for processing the critical asset site data to convert the critical asset site data into 3D model data representing the critical asset site including the existing and/or proposed environmental features and the existing critical assets.

In one embodiment, the system includes potential threat mitigation feature data including data representing potential threat mitigation features capable of mitigating potential vulnerabilities of the existing critical assets at the critical asset site.

In one embodiment, the system includes an interactive 3D modeling system. In one embodiment, the interactive 3D modeling system receives the 3D model data and the interactive 3D modeling system transforms the 3D model data into an interactive 3D model representation of the critical asset site including the existing and/or proposed environmental features and the existing critical assets.

In one embodiment, the interactive 3D modeling system generates potential vulnerability data representing the determined potential vulnerability of the existing critical assets at the critical asset site.

In one embodiment, the interactive 3D modeling system processes the potential vulnerability data and the potential threat mitigation feature data to generate an interactive visualization of the effectiveness of various potential threat mitigation features for protecting the existing critical assets at the critical asset site.

In one embodiment, the system includes a display device, the display device displaying the interactive visualization of the effectiveness of the potential threat mitigation features for protecting the existing critical assets at the critical asset site.

In one embodiment, the system includes a user interface device, the user interface device dynamically interacting with the interactive 3D model representation of the critical asset site. In one embodiment the user interface device is capable of selecting one or more threat mitigation features based, at least in part, on the visualization of the effectiveness of the potential threat mitigation features for protecting the existing critical assets at the critical asset site.

In one embodiment, the system includes selected threat mitigation feature data representing structural parameters and location of the selected threat mitigation features for the existing critical assets at the critical asset site.

In various embodiments, the critical asset site can be, but is not limited to, electrical generation facilities; electrical generation substations; communication stations; water production facilities; reservoirs; pumping stations; airports; sewage treatment facilities; government facilities; law enforcement facilities; and military facilities.

In various embodiments, the existing critical assets can be, but are not limited to, electrical transformers; electrical generators; signal transmission towers; power lines; dams; aqueducts; control towers; communication antennas; and buildings.

In various embodiments, the critical asset site data includes one or more of aerial LiDAR data; terrestrial LiDAR data; radar data; infrared data; photogrammetry data; and CAD drawing data.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, generating the potential vulnerability data includes the use of virtual light/illumination sources.

In one embodiment, the system includes potential threat data identifying potential threats, the potential threat data being provided by one or more of local intelligence, known available weapons systems; potentially available weapons systems; and worst-case analysis.

In various embodiments, the one or more mitigation features can be, but are not limited to, physical walls; ballistic curtains; landscape features; Kevlar structures; radar detection systems; infrared detection systems; and visual detection systems.

Disclosed herein is a system for determining and mitigating threats to proposed critical assets, in one embodiment, the system includes a critical asset site.

In one embodiment, the system includes critical asset site data representing existing and/or proposed environmental features and proposed critical assets at the critical asset site.

In one embodiment, the system includes a 3D modeling system for processing the critical asset site data to convert the critical asset site data into 3D model data representing the critical asset site including the existing and/or proposed environmental features and the proposed critical assets.

In one embodiment, the system includes potential threat mitigation feature data including data representing potential threat mitigation features capable of mitigating potential vulnerabilities of the proposed critical assets at the critical asset site.

In one embodiment, the system includes an interactive 3D modeling system. In one embodiment, the interactive 3D modeling system receives the 3D model data and the interactive 3D modeling system transforms the 3D model data into an interactive 3D model representation of the critical asset site including the existing and/or proposed environmental features and the proposed critical assets.

In one embodiment, the interactive 3D modeling system generates potential vulnerability data representing the determined potential vulnerability of the proposed critical assets at the critical asset site.

In one embodiment, the interactive 3D modeling system processes the potential vulnerability data and the potential threat mitigation feature data to generate an interactive visualization of the effectiveness of various potential threat mitigation features for protecting the proposed critical assets at the critical asset site.

In one embodiment, the system includes a display device, the display device displaying the interactive visualization of the effectiveness of the potential threat mitigation features for protecting the proposed critical assets at the critical asset site.

In one embodiment, the system includes a user interface device, the user interface device dynamically interacting with the interactive 3D model representation of the critical asset site. In one embodiment the user interface device is capable of selecting one or more threat mitigation features based, at least in part, on the visualization of the effectiveness of the potential threat mitigation features for protecting the proposed critical assets at the critical asset site.

In one embodiment, the system includes selected threat mitigation feature data representing parameters and location of the selected threat mitigation features for the proposed critical assets at the critical asset site.

In various embodiments, the critical asset site can be, but is not limited to, electrical generation facilities; electrical generation substations; communication stations; water production facilities; reservoirs; pumping stations; airports; sewage treatment facilities; government facilities; law enforcement facilities; and military facilities.

In various embodiments, the proposed critical assets can be, but are not limited to, electrical transformers; electrical generators; signal transmission towers; power lines; dams; aqueducts; control towers; communication antennas; and buildings.

In various embodiments, the critical asset site data includes one or more of aerial LiDAR data; terrestrial LiDAR data; radar data; infrared data; photogrammetry data; and CAD drawing data.

In various embodiments, the critical asset site data is collected using one or more of aircraft; air drones; land-based drones; cameras; radar systems; satellites; and public information systems.

In one embodiment, processing the critical asset site data to convert the critical asset site data into 3D model data is performed using a 3D mesh generation system.

In one embodiment, the interactive 3D modeling system is a gaming engine.

In one embodiment, generating the potential vulnerability data includes the use of virtual light/illumination sources.

In one embodiment, the system includes potential threat data identifying potential threats, the potential threat data being provided by one or more of local intelligence, known available weapons systems; potentially available weapons systems; and worst-case scenario analysis.

In various embodiments, the one or more mitigation features can be, but are not limited to, physical walls; ballistic curtains; landscape features; Kevlar structures; radar detection systems; infrared detection systems; and visual detection systems.

It should be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In the discussion above, certain aspects of one embodiment include process steps and/or operations described herein for illustrative purposes in a particular order and/or grouping. However, the particular order and/or grouping shown and discussed herein are illustrative only and not limiting. Those of skill in the art will recognize that other orders and/or grouping of the process steps and/or operations are possible and, in some embodiments, one or more of the process steps and/or operations discussed above can be combined and/or deleted. In addition, sections of one or more of the process steps and/or operations can be re-grouped as sections of one or more other of the process steps and/or operations discussed herein. Consequently, the particular order and/or grouping of the process steps and/or operations discussed herein do not limit the scope of the invention as claimed below.

In addition, the features shown in the figures are identified using a particular nomenclature for ease of description and understanding, but other nomenclature is often used in the art to identify equivalent features.

Therefore, numerous variations, whether explicitly provided for by the specification or implied by the specification or not, may be implemented by one of skill in the art in view of this disclosure.

What is claimed is:

1. A process for identifying and mitigating threats to existing critical assets comprising:
identifying environmental features and existing critical assets at a critical asset site;
obtaining existing critical asset site data representing the environmental features and the existing critical assets at the critical asset site;
processing the existing critical asset site data to convert the existing critical asset site data into 3D model data representing the critical asset site including the environmental features and the existing critical assets;
providing the 3D existing critical asset site data to an interactive 3D modeling system, the interactive 3D modeling system transforming the 3D existing critical asset site data into an interactive 3D model representation of the critical asset site including the environmental features and the existing critical assets;
identifying potential vulnerabilities associated with the existing critical assets at the critical asset site and generating potential vulnerability data representing the identified potential vulnerabilities associated with the existing critical assets at the critical asset site;
identifying potential threat mitigation features capable of mitigating the determined potential vulnerability of the existing critical assets at the critical asset site and generating potential threat mitigation feature data representing the identified potential threat mitigation features;
processing the potential vulnerability data and the potential threat mitigation feature data to generate an interactive visualization of the effectiveness of the potential threat mitigation features for protecting the existing critical assets at the critical asset site;
displaying the interactive visualization of the effectiveness of the potential threat mitigation features for protecting the existing critical assets at the critical asset site;
selecting one or more threat mitigation features based, at least in part, on the visualization of the effectiveness of the potential threat mitigation features for protecting the existing critical assets at the critical asset site;
generating selected threat mitigation feature data representing structural parameters and the location of the selected threat mitigation features for the existing critical assets at the critical asset site; and
using the selected threat mitigation feature data to generate critical asset site threat mitigation implementation plan data for the critical asset site.

2. The process of claim 1 wherein the existing critical asset site is selected from the group of critical asset sites consisting of:
electrical generation facilities;
electrical generation substations;
communication stations;
water production facilities;
reservoirs;
pumping stations;
airports;
sewage treatment facilities;
government facilities;
law enforcement facilities;
military facilities;
nuclear facilities; and
oil and gas production facilities.

3. The process of claim 1 wherein the existing critical assets are selected from the group of critical assets consisting of:
electrical transformers;
electrical generators;
signal transmission towers;
power lines;
dams;
aqueducts;
control towers;
communication antennas; and
buildings.

4. The process of claim 1 wherein the existing critical asset site data includes one or more of:
aerial LiDAR data;
terrestrial LiDAR data;
radar data;
infrared data;
photogrammetry data; and
CAD drawing data.

5. The process of claim 1 wherein the existing critical asset site data is collected using one or more of:
aircraft;
air drones;
land-based drones;
cameras;
radar systems;
satellites; and
public information systems.

6. The process of claim 1 wherein processing the existing critical asset site data to convert the critical asset site data into 3D model data is performed using a 3D mesh generation system.

7. The process of claim 1 wherein the interactive 3D modeling system is a gaming engine.

8. The process of claim 1 wherein identifying potential vulnerabilities includes the use of virtual light/illumination sources.

9. The process of claim 1 further comprising:
obtaining potential threat data representing potential threats to critical assets, the potential threat data being provided by one or more of:
local intelligence;
known available weapons systems;
potentially available weapons systems; and
worst-case scenario analysis.

10. The process of claim 1 wherein the one or more mitigation features are selected from the group of mitigation features including:
physical walls;
ballistic curtains;
landscape features;
Kevlar structures;
radar detection systems;
infrared detection systems; and
visual detection systems.

11. A system for identifying and mitigating threats to existing critical assets comprising:
a critical asset site;
critical asset site data representing existing and/or proposed environmental features and existing critical assets at the critical asset site;
a 3D modeling system for processing the critical asset site data to convert the critical asset site data into 3D model data representing the critical asset site including existing and/or proposed environmental features and the existing critical assets;
threat mitigation feature data representing potential threat mitigation features capable of mitigating potential vulnerabilities of the existing critical assets at the critical asset site;
an interactive 3D modeling system, the interactive 3D modeling system receiving the 3D model data, the interactive 3D modeling system transforming the 3D model data into an interactive 3D model representation of the critical asset site including the existing and/or proposed environmental features and the existing critical assets,
wherein the interactive 3D modeling system generates potential vulnerability data representing the vulnerability of the existing critical assets at the critical asset site,
further wherein the interactive 3D modeling system processes the potential vulnerability data and the potential threat mitigation feature data to generate an interactive visualization of the effectiveness of various potential threat mitigation features for protecting the existing critical assets at the critical asset site;
a display device, the display device displaying the interactive visualization of the effectiveness of the potential threat mitigation features for protecting the existing critical assets at the critical asset site;
a user interface device, the user interface device dynamically interacting with the interactive 3D model representation of the critical asset site and capable of selecting one or more mitigation features based, at least in part, on the visualization of the effectiveness of the potential threat mitigation features for protecting the existing critical assets at the critical asset site; and
selected threat mitigation feature data representing parameters and location of the selected threat mitigation features for the existing critical assets at the critical asset site.

12. The system of claim 11 wherein the critical asset site is selected from the group of critical asset sites consisting of:
electrical generation facilities;
electrical generation substations;
communication stations;
water production facilities;
reservoirs;
pumping stations;
airports;
sewage treatment facilities;
government facilities;
law enforcement facilities;
military facilities;
nuclear facilities; and
oil and gas production facilities.

13. The system of claim 11 wherein the existing critical assets are selected from the group of critical assets consisting of:
electrical transformers;
electrical generators;
signal transmission towers;
power lines;
dams;
aqueducts;
control towers;
communication antennas; and
buildings.

14. The system of claim 11 wherein the critical asset site data includes one or more of:
aerial LiDAR data;
terrestrial LiDAR data;
radar data;
infrared data;
photogrammetry data; and
CAD drawing data.

15. The system of claim 11 wherein the critical asset site data is collected using one or more of:
aircraft;
air drones;
land-based drones;
cameras;
radar systems;
satellites; and
public information systems.

16. The system of claim 11 wherein processing the critical asset site data to convert the critical asset site data into 3D model data is performed using a 3D mesh generation system.

17. The system of claim 11 wherein the interactive 3D modeling system is a gaming engine.

18. The system of claim 11 wherein generating the potential vulnerability data includes the use of virtual light/illumination sources.

19. The system of claim 11 further comprising potential threat data representing potential threats to critical assets, the potential threat data being provided by one or more of:
local intelligence;
known available weapons systems;
potentially available weapons systems; and
worst-case scenario analysis.

20. The system of claim 11 wherein the one or more mitigation features are selected from the group of mitigation features including:
physical walls;
ballistic curtains;
landscape features;
Kevlar structures;
radar detection systems;
infrared detection systems; and
visual detection systems.

21. A process for identifying and mitigating threats to existing critical assets comprising:
identifying environmental features and existing critical assets at a critical asset site;
obtaining existing critical asset site data representing the environmental features and the existing critical assets at the critical asset site;
using a 3D mesh generation system to process the existing critical asset site data to convert the existing critical asset site data into 3D model data representing the critical asset site including the environmental features and the existing critical assets;
providing the 3D existing critical asset site data to a gaming engine, the gaming engine transforming the 3D existing critical asset site data into an interactive 3D model representation of the critical asset site including the environmental features and the existing critical assets;
generating one or more virtual light/illumination sources and using the one or more virtual light/illumination sources to identify potential vulnerabilities associated with the existing critical assets at the critical asset site and generating potential vulnerability data representing the identified potential vulnerabilities associated with the existing critical assets at the critical asset site;
identifying potential threat mitigation features capable of mitigating the determined potential vulnerability of the existing critical assets at the critical asset site and generating potential threat mitigation feature data representing the identified potential threat mitigation features;
processing the potential vulnerability data and the potential threat mitigation feature data to generate an interactive visualization of the effectiveness of the potential threat mitigation features for protecting the existing critical assets at the critical asset site;
displaying the interactive visualization of the effectiveness of the potential threat mitigation features for protecting the existing critical assets at the critical asset site;
selecting one or more threat mitigation features based, at least in part, on the visualization of the effectiveness of the potential threat mitigation features for protecting the existing critical assets at the critical asset site;
generating selected threat mitigation feature data representing structural parameters and the location of the selected threat mitigation features for the existing critical assets at the critical asset site; and
using the selected threat mitigation feature data to generate critical asset site threat mitigation implementation plan data for the critical asset site.
